(19) United States
(12) Patent Application Publication
(10) Pub. No.: US 2015/0066379 A1
(43) Pub. Date: Mar. 5, 2015

(54) COMPUTER SYSTEM AND APPARATUS FOR DETERMINING SENSITIVITY TO BREAST CANCER NEOADJUVANT CHEMOTHERAPY

(71) Applicants: SYSMEX CORPORATION, Kobe-shi (JP); OSAKA UNIVERSITY, Osaka (JP)

(72) Inventors: Shinzaburou NOGUCHI, Osaka (JP); Yasuto NAOI, Osaka (JP); Yoshiaki SOTA, Osaka (JP); Kazuki KISHI, Kobe-shi (JP)

(73) Assignees: SYSMEX CORPORATION, Kobe-shi (JP); OSAKA UNIVERSITY, Osaka (JP)

(21) Appl. No.: 14/471,684

(22) Filed: Aug. 28, 2014

(30) Foreign Application Priority Data
Aug. 30, 2013 (JP) 2013-179877

(51) Int. Cl. G06F 19/00

(52) U.S. Cl. CPC G06F 19/3481; G06F 19/3431
USPC 702/19

(57) ABSTRACT

Sensitivity to breast cancer neoadjuvant chemotherapy is determined on the basis of a result of analysis of the expression level, by amplifying RNA extracted from a specimen collected from a subject, thereby preparing a measurement sample, and measuring an expression level of each specified gene with a use of using the measurement sample.

### TECHNICAL FIELD

The present invention relates to a computer system adapted to determine sensitivity to breast cancer neoadjuvant chemotherapy and an apparatus for determining sensitivity to breast cancer neoadjuvant chemotherapy. More specifically, the present invention relates to a computer system adapted to determine sensitivity to breast cancer neoadjuvant chemotherapy and an apparatus for determining sensitivity to breast cancer neoadjuvant chemotherapy, which are useful for providing information assisting diagnosis of sensitivity to breast cancer neoadjuvant chemotherapy.

### BACKGROUND

Recently, an increased number of patients undergo breast cancer neoadjuvant chemotherapy not only for improving the adaptability to a surgery of local advanced breast cancer, but also for improving the adaptability to a breast-conserving surgery for a patient who has relatively large tumor. It is also known that a patient who has had a pathological complete response (hereinafter, also referred to as “pCR”) by a breast cancer neoadjuvant chemotherapy has a good prognosis.

At present, a sequential chemotherapy using taxane and anthracycline is commonly performed in clinical practice. However, the pCR rate (the number of cases achieving pCR/the total number of cases having undergone a chemotherapy) of the sequential chemotherapy is 10 to 30%, which is not necessarily high. Also it is reported that the pCR rate is higher in estrogen receptor (hereinafter, referred to as “ER”)-negative cases, when ER-positive cases and ER-negative cases are compared. However, in ER-negative cases, pCR is not necessarily achieved in every case by a breast cancer neoadjuvant chemotherapy, whereas in ER-positive cases, pCR is occasionally achieved by a breast cancer neoadjuvant chemotherapy. Therefore, there is a demand for a method capable of accurately determining sensitivity to breast cancer neoadjuvant chemotherapy irrespectively of, e.g., classification based on ER positivity and ER negativity.

As a method for predicting sensitivity to breast cancer neoadjuvant chemotherapy, for example, a method of determining sensitivity to breast cancer neoadjuvant chemotherapy by measuring and analyzing expression levels of a specified gene group using RNA extracted from a specimen collected from a subject is proposed (see, for example, WO 2011/065533 A). However, in the method described in WO 2011/065533 A, a gene group including ER gene is used as a gene group to be measured.

On the other hand, Iwamoto T et al. (Gene pathways associated with prognosis and chemotherapy sensitivity in molecular subtypes of breast cancer, Journal of the National Cancer Institute, 2011, Vol. 103, p. 264-272) discloses that a gene group involved in signal transduction of chemokine receptor-3, a gene group involved in signal transduction of chemokine receptor-5, a gene group involved in signal transduction of interleukin-8 and the like are related to chemotherapy responsibility in ER-positive breast cancer, from the gene expression profile obtained by a comprehensive gene expression analysis using a DNA microarray. However, predictive determination of sensitivity using a concretely specified gene group is not conducted.

Also, Schmidt M et al. (The humoral immune system has a key prognostic impact in node-negative breast cancer, Cancer research, 2008, Vol. 68, p. 5405-5413) discloses that B-cell metagene consisting of a gene group associated with a B cell responsible for humoral immune system is a prognostic factor for lymph node metastasis negative and highly proliferative breast cancer. Schmidt M et al. (A comprehensive analysis of human gene expression profiles identifies stromal immunoglobulin kappa C as a compatible prognostic marker in human solid tumors, Clinical Cancer Research, 2012, Vol. 18, p. 2695-2703) discloses that an expression level of immunoglobulin κC gene is correlated with B-cell metagene, and is useful for predicting sensitivity to chemotherapy using anthracycline in ER-negative breast cancer.

Further, Teschendorff A E et al. (An immune response gene expression module identifies a good prognosis subtype in estrogen receptor negative breast cancer, Genome Biology, 2007, Vol. 8, R157) discloses a gene group consisting of seven genes (respective genes of C1QA, XCL2, SPP1, TNFRSF17, LY9, IGLC2 and HLA-F) related with the immune responsiveness as a prognostic marker in ER-negative breast cancer cases.

### SUMMARY OF INVENTION

The scope of the present invention is not affected to any degree by the matters described in this summary.

One aspect includes a computer system adapted to determine sensitivity to breast cancer neoadjuvant chemotherapy comprising:

a processor, and

a memory, under control of said processor, including software instructions adapted to enable the computer system to perform operations comprising:

(1) acquiring an information of an expression level of each gene of (A1) to (A19) below in a measurement sample comprising RNA from a specimen collected from a subject,

(2) analyzing the expression level of the each gene acquired in the step (1), and

(3) determining sensitivity to breast cancer neoadjuvant chemotherapy on the basis of an analysis result obtained in the step (2):

(A1) human caspase recruitment domain family, member 9 (CARD9) gene,

(A2) human indoleamine-2,3-dioxygenase 1 (IDO1) gene,

(A3) human chemokine (C-X-C motif) ligand 9 (CXCL9) gene,

(A4) human purine nucleoside phosphorylase (PNP) gene,

(A5) human chemokine (C-X-C motif) ligand 11 (CXCL11) gene,

(A6) human CCAAT/enhancer binding protein (CEBPB) gene,

(A7) human CD83 gene,

(A8) human interleukin 6 signal transducer (IL6ST) gene,

(A9) human chemokine (C-X3-C) receptor 1 (CX3CR1) gene,

(A10) human CD1D gene,

(A11) human cathepsin C (CTSC) gene,

(A12) human chemokine (C-X-C motif) ligand 10 (CXCL10) gene,

(A13) human immunoglobulin heavy chain genetic locus G1 isotype (IGHG1) gene,

(A14) human zinc finger E-box-binding homeobox 1 (ZEB1) gene,

(A15) human vascular endothelial growth factor A (VEGFA) gene,

(A16) human semaphorin-3C precursor (SEMA3C) gene,

(A17) human complement receptor (CR2) gene,

(A18) human HFE gene, and

(A19) human EDA gene.

Another aspect includes an apparatus for determining sensitivity to breast cancer neoadjuvant chemotherapy, comprising:

an acquiring section for acquiring information of an expression level of each gene of (A1) to (A19) below in a measurement sample comprising RNA prepared from a specimen collected from a subject;

a determination section for determining sensitivity to breast cancer neoadjuvant chemotherapy based on information of an expression level of each gene, the information being acquired by the acquiring section; and an output section for outputting a determination result generated by the determination section:

(A1) human caspase recruitment domain family, member 9 (CARDS) gene,

(A2) human indoleamine-2,3-dioxygenase 1 (IDO1) gene,

(A3) human chemokine (C-X-C motif) ligand 9 (CXCL9) gene,

(A4) human purine nucleoside phosphorylase (PNP) gene,

(A5) human chemokine (C-X-C motif) ligand 11 (CXCL11) gene,

(A6) human CCAAT/enhancer binding protein (CEBPB) gene,

(A7) human CD83 gene,

(A8) human interleukin 6 signal transducer (IL6ST) gene,

(A9) human chemokine (C-X3-C) receptor 1 (CX3CR1) gene,

(A10) human CD1D gene,

(A11) human cathepsin C (CTSC) gene,

(A12) human chemokine (C-X-C motif) ligand 10 (CXCL10) gene,

(A13) human immunoglobulin heavy chain genetic locus G1 isotype (IGHG1) gene,

(A14) human zinc finger E-box-binding homeobox 1 (ZEB1) gene,

(A15) human vascular endothelial growth factor A (VEGFA) gene,

(A16) human semaphorin-3C precursor (SEMA3C) gene,

(A17) human complement receptor (CR2) gene,

(A18) human HFE gene, and

(A19) human EDA gene.

Still another aspect includes an apparatus for determining sensitivity to breast cancer neoadjuvant chemotherapy, comprising:

an acquiring section for acquiring information of an expression level of each nucleic acid detected by probes of (B1) to (B23) below in a measurement sample comprising RNA prepared from a specimen collected from a subject;

a determination section for determining sensitivity to breast cancer neoadjuvant chemotherapy on the basis of information of an expression level of each nucleic acid acquired by the acquiring section; and

an output section for outputting a determination result generated by the determination section:

(B1) a probe for targeting a polynucleotide having a nucleotide sequence of SEQ ID NO: 1,

(B2) a probe for targeting a polynucleotide having a nucleotide sequence of SEQ ID NO: 2,

(B3) a probe for targeting a polynucleotide having a nucleotide sequence of SEQ ID NO: 3,

(B4) a probe for targeting a polynucleotide having a nucleotide sequence of SEQ ID NO: 4,

(B5) a probe for targeting a polynucleotide having a nucleotide sequence of SEQ ID NO: 5,

(B6) a probe for targeting a polynucleotide having a nucleotide sequence of SEQ ID NO: 6,

(B7) a probe for targeting a polynucleotide having a nucleotide sequence of SEQ ID NO: 7,

(B8) a probe for targeting a polynucleotide having a nucleotide sequence of SEQ ID NO: 8,

(B9) a probe for targeting a polynucleotide having a nucleotide sequence of SEQ ID NO: 9,

(B10) a probe for targeting a polynucleotide having a nucleotide sequence of SEQ ID NO: 10,

(B11) a probe for targeting a polynucleotide having a nucleotide sequence of SEQ ID NO: 11,

(B12) a probe for targeting a polynucleotide having a nucleotide sequence of SEQ ID NO: 12,

(B13) a probe for targeting a polynucleotide having a nucleotide sequence of SEQ ID NO: 13,

(B14) a probe for targeting a polynucleotide having a nucleotide sequence of SEQ ID NO: 14,

(B15) a probe for targeting a polynucleotide having a nucleotide sequence of SEQ ID NO: 15,

(B16) a probe for targeting a polynucleotide having a nucleotide sequence of SEQ ID NO: 16,

(B17) a probe for targeting a polynucleotide having a nucleotide sequence of SEQ ID NO: 17,

(B18) a probe for targeting a polynucleotide having a nucleotide sequence of SEQ ID NO: 18,

(B19) a probe for targeting a polynucleotide having a nucleotide sequence of SEQ ID NO: 19,

(B20) a probe for targeting a polynucleotide having a nucleotide sequence of SEQ ID NO: 20,

(B21) a probe for targeting a polynucleotide having a nucleotide sequence of SEQ ID NO: 21,

(B22) a probe for targeting a polynucleotide having a nucleotide sequence of SEQ ID NO: 22, and

(B23) a probe for targeting a polynucleotide having a nucleotide sequence of SEQ ID NO: 23.

### BRIEF DESCRIPTION OF DRAWINGS

FIG. 1 is a schematic explanatory view of an apparatus for determining sensitivity to breast cancer neoadjuvant chemotherapy according to one embodiment.

FIG. 2 is a block diagram illustrating a functional configuration of the determining apparatus shown in FIG. 1.

FIG. 3 is a block diagram illustrating a hardware configuration of the determining apparatus shown in FIG. 1.

FIG. 4 is a flowchart of determination of sensitivity to breast cancer neoadjuvant chemotherapy using the determining apparatus shown in FIG.

FIG. 5 illustrates the result of examination for the relation between the number of probe sets and accuracy in Example 1.

FIG. 6 illustrates the result of comparison between the determination result by the discriminant represented by formula (I) and the pathological diagnosis result for a training set in Example 1.

FIG. 7 illustrates the result of comparison between the determination result by the discriminant represented by formula (I) and the pathological diagnosis result for a validation set in Example 1.

FIG. 8 illustrates the result of comparison between the determination result by the discriminant represented by formula (I) and the pathological diagnosis result acquired from a database in Example 2.

FIG. 9 illustrates the result of comparison between the determination result by the discriminant represented by formula (I) and the pathological diagnosis result acquired from the database in Example 3.

FIG. 10 illustrates the result of comparison between the determination result by the discriminant represented by formula (I) and the pathological diagnosis result acquired from the database in Example 4.

FIG. 11 illustrates the result of comparison between the determination result obtained by using the expression level of gene corresponding to 70 probe sets shown in Tables 1 and 2 of WO 2011/065533 A, and the pathological diagnosis result acquired from the database for subject groups 1-1 to 1-6 in Comparative Example 1.

FIG. 12 illustrates the result of comparison between the determination result obtained by using the expression level of gene corresponding to 70 probe sets shown in Tables 1 and 2 of WO 2011/065533 A, and the pathological diagnosis result acquired from the database for subject groups 2-1 to 2-3 in Comparative Example 1.

FIG. 13 illustrates the result of comparison between the determination result obtained by using an expression level of gene corresponding to 70 probe sets shown in Tables 1 and 2 of WO 2011/065533 A, and the pathological diagnosis result acquired from the database for subject groups 3-1 to 3-5 in Comparative Example 1.

FIG. 14 illustrates the result of comparison between the determination result obtained according to the method described in Schmidt M et al. (Cancer research, 2008, Vol. 68, p. 5405-5413), and the pathological diagnosis result acquired from the database for subject groups 1-1 to 1-6 in Comparative Example 2.

FIG. 15 illustrates the result of comparison between the determination result obtained according to the method described in Schmidt M et al. (Cancer research, 2008, Vol. 68, p. 5405-5413), and the pathological diagnosis result acquired from the database for subject groups 2-1 to 2-3 in Comparative Example 2.

FIG. 16 illustrates the result of comparison between the determination result obtained according to the method described in Schmidt M et al. (Cancer research, 2008, Vol. 68, p. 5405-5413), and the pathological diagnosis result acquired from the database for subject groups 3-1 to 3-5 in Comparative Example 2.

FIG. 17 illustrates the result of comparison between the determination result obtained according to the method described in Schmidt M et al. (Clinical Cancer Research, 2012, Vol. 18, p. 2695-2703), and the pathological diagnosis result acquired from the database for subject groups 1-1 to 1-6 in Comparative Example 3.

FIG. 18 illustrates the result of comparison between the determination result obtained according to the method described in Schmidt M et al. (Clinical Cancer Research, 2012, Vol. 18, p. 2695-2703), and the pathological diagnosis result acquired from the database for subject groups 2-1 to 2-3 in Comparative Example 3.

FIG. 19 illustrates the result of comparison between the determination result obtained according to the method described in Schmidt M et al. (Clinical Cancer Research, 2012, Vol. 18, p. 2695-2703), and the pathological diagnosis result acquired from the database for subject groups 3-1 to 3-5 in Comparative Example 3.

FIG. 20 illustrates the result of comparison between the determination result obtained according to the method described in Teschendorff A E et al. (Genome Biology, 2007, Vol. 8, R157), and the pathological diagnosis result acquired from the database for subject groups 1-1 to 1-6 in Comparative Example 4.

FIG. 21 illustrates the result of comparison between the determination result obtained according to the method described in Teschendorff A E et al. (Genome Biology, 2007, Vol. 8, R157), and the pathological diagnosis result acquired from the database for subject groups 2-1 to 2-3 in Comparative Example 4.

FIG. 22 illustrates the result of comparison between the determination result obtained according to the method described in Teschendorff A E et al. (Genome Biology, 2007, Vol. 8, R157), and the pathological diagnosis result acquired from the database for subject groups 3-1 to 3-5 in Comparative Example 4.

### DESCRIPTION OF EMBODIMENTS

In one aspect, the method for determining sensitivity to breast cancer neoadjuvant chemotherapy according to the present embodiment is a method for determining sensitivity to breast cancer neoadjuvant chemotherapy comprising the steps of:

(1) preparing a measurement sample comprising RNA from a specimen collected from a subject,

(2) measuring an expression level of each gene of (A1) to (A19) below or an expression level of each nucleic acid detected by a probe of (B1) to (B23) below with a use of a measurement sample obtained in the step (1),

(3) analyzing an expression level of the each gene or an expression level of the each nucleic acid measured in the step (2), and

(4) determining sensitivity to breast cancer neoadjuvant chemotherapy on the basis of an analysis result obtained in the step (3):

(A1) human caspase recruitment domain family, member 9 (CARD9) gene,

(A2) human indoleamine-2,3-dioxygenase 1 (IDO1) gene,

(A3) human chemokine (C-X-C motif) ligand 9 (CXCL9) gene,

(A4) human purine nucleoside phosphorylase (PNP) gene,

(A5) human chemokine (C-X-C motif) ligand 11 (CXCL11) gene,

(A6) human CCAAT/enhancer binding protein (CEBPB) gene,

(A7) human CD83 gene,

(A8) human interleukin 6 signal transducer (IL6ST) gene,

(A9) human chemokine (C-X3-C) receptor 1 (CX3CR1) gene,

(A10) human CD1D gene,

(A11) human cathepsin C (CTSC) gene,

(A12) human chemokine (C-X-C motif) ligand 10 (CXCL10) gene,

(A13) human immunoglobulin heavy chain genetic locus G1 isotype (IGHG1) gene,

(A14) human zinc finger E-box-binding homeobox 1 (ZEB1) gene,

(A15) human vascular endothelial growth factor A (VEGFA) gene,

(A16) human semaphorin-3C precursor (SEMA3C) gene,

(A17) human complement receptor (CR2) gene,

(A18) human HFE gene,

(A19) human EDA gene,

(B1) a probe for targeting a polynucleotide having a nucleotide sequence of SEQ ID NO: 1,

(B2) a probe for targeting a polynucleotide having a nucleotide sequence of SEQ ID NO: 2,

(B3) a probe for targeting a polynucleotide having a nucleotide sequence of SEQ ID NO: 3,

(B4) a probe for targeting a polynucleotide having a nucleotide sequence of SEQ ID NO: 4,

(B5) a probe for targeting a polynucleotide having a nucleotide sequence of SEQ ID NO: 5,

(B6) a probe for targeting a polynucleotide having a nucleotide sequence of SEQ ID NO: 6,

(B7) a probe for targeting a polynucleotide having a nucleotide sequence of SEQ ID NO: 7,

(B8) a probe for targeting a polynucleotide having a nucleotide sequence of SEQ ID NO: 8,

(B9) a probe for targeting a polynucleotide having a nucleotide sequence of SEQ ID NO: 9,

(B10) a probe for targeting a polynucleotide having a nucleotide sequence of SEQ ID NO: 10,

(B11) a probe for targeting a polynucleotide having a nucleotide sequence of SEQ ID NO: 11,

(B12) a probe for targeting a polynucleotide having a nucleotide sequence of SEQ ID NO: 12,

(B13) a probe for targeting a polynucleotide having a nucleotide sequence of SEQ ID NO: 13,

(B14) a probe for targeting a polynucleotide having a nucleotide sequence of SEQ ID NO: 14,

(B15) a probe for targeting a polynucleotide having a nucleotide sequence of SEQ ID NO: 15,

(B16) a probe for targeting a polynucleotide having a nucleotide sequence of SEQ ID NO: 16,

(B17) a probe for targeting a polynucleotide having a nucleotide sequence of SEQ ID NO: 17,

(B18) a probe for targeting a polynucleotide having a nucleotide sequence of SEQ ID NO: 18,

(B19) a probe for targeting a polynucleotide having a nucleotide sequence of SEQ ID NO: 19,

(B20) a probe for targeting a polynucleotide having a nucleotide sequence of SEQ ID NO: 20,

(B21) a probe for targeting a polynucleotide having a nucleotide sequence of SEQ ID NO: 21,

(B22) a probe for targeting a polynucleotide having a nucleotide sequence of SEQ ID NO: 22, and

(B23) a probe for targeting a polynucleotide having a nucleotide sequence of SEQ ID NO: 23.

In a particular embodiment, the method for determining sensitivity to breast cancer neoadjuvant chemotherapy according to the present embodiment is a method including the steps of:

(I-1) preparing a measurement sample including RNA from a specimen collected from a subject;

(I-2) measuring an expression level of each gene of (A1) to (A19) with a use of the measurement sample obtained in the step (I-1);

(I-3) analyzing the expression level of the each gene measured in the step (I-2), and

(I-4) determining sensitivity to breast cancer neoadjuvant chemotherapy on the basis of the analysis result obtained in the step (I-3) (hereinafter, also referred to as “Method 1”). The step (I-2) corresponds to the step (1). The step (I-3) corresponds to the step (2). The step (I-4) corresponds to the step (3).

In another particular embodiment, the method for determining sensitivity to breast cancer neoadjuvant chemotherapy according to the present embodiment is a method including the steps of:

(II-1) preparing a measurement sample including RNA from a specimen collected from a subject;

(II-2) measuring an expression level of each nucleic acid detected by probes of (B1) to (B23) with a use of the measurement sample obtained in the step (II-1);

(II-3) analyzing the expression level of the each nucleic acid measured in the step (II-2), and

(II-4) determining sensitivity to breast cancer neoadjuvant chemotherapy on the basis of the analysis result obtained in the step (II-3) (hereinafter, also referred to as “Method 2”). The step (II-2) corresponds to the step (1). The step (II-3) corresponds to the step (2). The step (II-4) corresponds to the step (3).

Hereinafter, “specified nucleic acid” encompasses each nucleic acid detected by the genes of (A1) to (A19) and the probes of (B1) to (B23). Hereinafter, “an expression level of a specified nucleic acid” encompasses an expression level of each of the gene of (A1) to (A19) and an expression level of each nucleic acids detected by the probes of (B1) to (B23).

According to the method according to the present embodiment, both the presence or absence of sensitivity to breast cancer neoadjuvant chemotherapy in ER-positive cases, and the presence or absence of sensitivity to breast cancer neoadjuvant chemotherapy in ER-negative cases can be accurately determined, since in the method, the operation of measuring and analyzing an expression level of a specified nucleic acid is employed. Therefore, according to the method of the present embodiment, it is possible to assist diagnosis of sensitivity to breast cancer neoadjuvant chemotherapy by providing a person who makes diagnosis (e.g., physician) with the obtained determination result as diagnosis assisting information.

The present inventors found that it is possible to accurately determine the presence or absence of sensitivity to breast cancer neoadjuvant chemotherapy irrespectively of the classification based on ER positivity and ER negativity, the classification based on the regimen of the breast cancer neoadjuvant chemotherapy or the like, when sensitivity to breast cancer neoadjuvant chemotherapy is evaluated on the basis of a result that is obtained by using a probe set shown in Table 1, each probe for targeting a respective one of SEQ ID NOs: 1 to 23, and measuring an expression level of each nucleic acid detected by the probe set, and comprehensively analyzing the expression levels. The present invention was accomplished on the basis of this finding.

The “probe for targeting a polynucleotide” used herein refers to a probe designed for the purpose of detecting the polynucleotide. Typically, “probe for targeting a polynucleotide” has a partial sequence of the polynucleotide, or a sequence of the partial sequence in which one or several nucleotides are different from those in the nucleotide sequence of the polynucleotide. The “stringent condition” used herein refers to the condition that is commonly used by a person skilled in the art in conducting hybridization of polynucleotide. The “stringent condition” is not particularly limited as far as it allows hybridization between a probe and a nucleic acid which is to be detected. It is known that the stringency of the condition in conducting hybridization is a function of the temperature, the salt concentration of the hybridization buffer, the chain length of the probe, the GC content of the nucleotide sequence of the probe, and the concentration of the chaotropic agent in the hybridization buffer, and can be appropriately set by a person skilled in the art in consideration of these conditions. As the stringent condition, for example, the condition described in Molecular Cloning: A Laboratory Manual (2nd ed.) (Sambrook, J. et al., 1998, published by Cold Spring Harbor Laboratory Press) can be used.

The “neoadjuvant chemotherapy” used herein refers to an anticancer drug treatment performed on a patient suffering from breast cancer for the purpose of reducing the size of tumor tissues and the like prior to a surgery. The agent used for neoadjuvant chemotherapy is not particularly limited as far as it has an anticancer action. The agent includes, for example, paclitaxel, docetaxel, epirubicin, cyclophosphamide, 5-fluorouracil, adriamycin, ixabepilone, anthracycline and the like. In neoadjuvant chemotherapy, one or a combination of two or more of these agents is administered to a patient according to a prescribed medication schedule.

In the method according to the present embodiment, first, a measurement sample including RNA is prepared from a specimen collected from a subject (step (I-1) of Method 1 and step (II-2) of Method 2).

The specimen is preferably a specimen including breast cancer cells collected from a subject by a preoperative biopsy. Concrete examples of the specimen include a tissue collected from a subject by a preoperative biopsy and the like. Examples of biopsy include fine-needle aspiration biopsy, core-needle biopsy, and a biopsy using a vacuum-assisted core-biopsy instrument (for example, product of Johnson & Johnson K.K., trade name: Mammotome (registered trade name)) (called “Mammotome biopsy”). Among them, Mammotome biopsy is preferred, since a specimen can be obtained readily with low burden.

RNA from a specimen can be extracted by a known method. Extraction of RNA from a specimen can be conducted by using a commercially available kit for extraction of RNA. Examples of the commercially available kit include kit of which trade name is Trizol (registered trade name) manufactured by Invitrogen, kit of which trade name is Qiagen RNeasy kit (registered trade name) manufactured by Qiagen, and the like.

Next, a measurement sample suited for measurement of an expression level of a gene, namely a production amount of a transcript (mRNA) corresponding to the gene or the like is prepared. For example, when an expression level of a specified nucleic acid is quantified by RT-PCR, mRNA that is purified from RNA extracted as described above, or RNA itself extracted as described above can be used as a measurement sample. The mRNA can be purified by a known purification method. For purification of mRNA, a commercially available purification kit can be used. On the other hand, when an expression level of a specified nucleic acid is quantified by a microarray, a measurement sample can be acquired by preparing corresponding cDNA or cRNA with a use of the extracted RNA.

The “cDNA” used herein includes not only DNA generated by reverse transcription from mRNA, but also a complementary strand of the DNA, and double-stranded DNA of cDNA and a complementary strand of the cDNA. Amplification of cDNA can be conducted by a known method. For amplification of cDNA, a commercially available kit for amplifying cDNA and a nucleic acid amplification device can be used. Here, examples of the commercially available kit include kit of which trade name is WT-Ovation™ FFPE System V2 manufactured by NuGEN Technologies.

cRNA can be synthesized from cDNA that is reversed transcribed from mRNA, by in vitro transcription reaction (IVT) using DNA-dependent RNA polymerase. DNA-dependent RNA polymerase includes, for example, T7 RNA polymerase and the like, but the present invention is not limited to such exemplification. Prior to application to a microarray, synthesized cRNA can be purified as is needed. For purification of cRNA, a method known in the art such as ethanol precipitation, or a commercially available nucleic acid purification kit can be used. Further, for facilitating hybridization between cRNA and a probe on a microarray, cRNA can be fragmented. Fragmentation of cRNA can be conducted by a method known in the art. Such a method includes, for example, a method of heating in the presence of metal ion, a method of using enzyme such as ribonuclease, and the like, but the present invention is not limited to this exemplification.

In the method described below for detecting nucleic acid by a microarray, when formation of a hybrid between cDNA or cRNA in the measurement sample and a probe is measured by detecting fluorescence, color, radiation or the like, it is preferred to label the cDNA or cRNA with a labelling substance such as a substance that generates a detectable signal, or a substance capable of binding with a substance generating a detectable signal. The labelling substance can be any substances that are commonly used in the art, and includes, for example, fluorescent substances such as Cy3, Cy5, Alexa Fluor (registered trade name), and fluorescein isothiocyanate (FITC); haptens such as biotin; radioactive substances, and the like, but the present invention is not limited to this exemplification. The method for labelling cDNA or cRNA with the labelling substance is known in the art. For example, by mixing biotinylated ribonucleotide or biotinylated deoxyribonucleotide as a substrate in the reaction liquid in the step of synthesizing cDNA or cRNA, it is possible to synthesize cDNA labelled with biotin or cRNA labelled with biotin.

Next, an expression level of a specified nucleic acid is measured by using the resulting measurement sample (step (I-2) of Method 1 and step (II-2) of Method 2).

In step (I-2) of Method 1 and step (II-2) of Method 2, an expression level of a specified nucleic acid can be measured, for example, by a microarray, quantitative RT-PCR, quantitative PCR, Northern blot analysis or the like. Among them, it is preferred to measure by using a microarray, since it enables rapid and simple measurement of an expression level of a specified nucleic acid. Here, the “expression level of a specified nucleic acid” includes the copy number of the specified nucleic acid contained in the measurement sample, concentration of the specified nucleic acid in the measurement sample, or a value indicating the copy number of the specified nucleic acid or concentration of the specified nucleic acid. The value indicating the copy number of the specified nucleic acid or concentration of the specified nucleic acid includes, for example, intensity of fluorescence that is measured after applying the measurement sample on the microarray and then allowing the specified nucleic acid and the probe on the microarray to hybridize them, and the like, but the present invention is not limited to this exemplification.

Measurement of the expression level of the specified nucleic acid by a microarray can be conducted by using a known method. Concretely, by using, for example, Human Genome U133 Plus 2.0 Array (trade name) manufactured by Affymetrix, Inc. which is a microarray capable of analyzing expression of human genome, it is possible to measure the expression level of the specified nucleic acid at once. Concretely, the specified nucleic acid can be detected by bringing the measurement sample into contact with the microarray, and hybridizing cDNA or cRNA in the measurement sample with the probe on the microarray.

The microarray used in the method according to the present embodiment is not particularly limited as far as the probes of (B1) to (B23) described below are arranged on a base material. The microarray is preferably a DNA microarray (DNA chip). As such a microarray, microarrays prepared by a method known in the art, and commercially available microarrays are exemplified.

Contact between the measurement sample and the microarray can be achieved by adding the measurement sample to the microarray. In this case, the measurement sample can be used as a dilution obtained by quantifying the concentration of nucleic acid in the measurement sample, and diluting the measurement sample so that the concentration of nucleic acid is a concentration suited for detection by the microarray. Contact between the measurement sample and the microarray can be performed usually at about 10 to 70° C. for 2 to 20 hours depending on the kind of microarray being used. For contact between the measurement sample and the microarray, Hybridization Oven 640 (trade name) manufactured by Affymetrix, Inc. or the like can be used.

Further, after contact with the measurement sample, staining of cDNA or cRNA that is immobilized on the base material of the microarray via the probe, and washing of the microarray can be conducted. For example, when the cDNA or cRNA corresponding to the specified nucleic acid in the measurement sample is labelled with biotin, it is possible to stain the cDNA or cRNA hybridized with the probe of the microarray by binding a fluorescent substance or the like labelled with avidin or streptavidin to the biotin. The fluorescent substance includes, for example, FITC, Alexa Fluor (trademark), green-fluorescent protein (GFP), luciferin, phycoerythrin, and the like, but the present invention is not limited to this exemplification. In the present embodiment, after binding avidin or streptavidin with biotin, an antibody capable of binding with the avidin or streptavidin, which is labelled with a fluorescent substance or the like is brought into contact with the microarray, and thus the nucleic acid hybridized with the probe, which is to be measured, can be stained. Staining and washing of the microarray can be conducted by using a microarray washing and staining apparatus, trade name: Fluidic Station 450, manufactured by Affymetrix, Inc. or the like.

The human caspase recruitment domain family, member 9 (CARD9) gene of (A1) has a sequence corresponding to GenBank accession number: NM_{—}022352.

The human indoleamine-2,3-dioxygenase 1 (IDO1) gene of (A2) has a sequence corresponding to GenBank accession number: M34455.

The human chemokine (C-X-C motif) ligand 9 (CXCL9) gene of (A3) has a sequence corresponding to GenBank accession number: NM_{—}002416.

The human purine nucleoside phosphorylase (PNP) gene of (A4) has a sequence corresponding to GenBank accession number: NM_{—}000270.

The human chemokine (C-X-C motif) ligand 11 (CXCL11) gene of (A5) has a sequence corresponding to GenBank accession number: AF002985 or AF030514.

The human CCAAT/enhancer binding protein (CEBPB) gene of (A6) has a sequence corresponding to GenBank accession number: AL564683.

The human CD83 gene of (A7) has a sequence corresponding to GenBank accession number: NM_{—}004233.

The human interleukin 6 signal transducer (IL6ST) gene of (A8) has a sequence corresponding to GenBank accession number: NM_{—}002184, AB015706 or BE856546.

The human chemokine (C-X3-C) receptor 1 (CX3CR1) gene of (A9) has a sequence corresponding to GenBank accession number: U20350.

The human CD1D gene of (A10) has a sequence corresponding to GenBank accession number: NM_{—}001766.

The human cathepsin C (CTSC) gene of (A11) has a sequence corresponding to GenBank accession number: NM_{—}001814.

The human chemokine (C-X-C motif) ligand 10 (CXCL10) gene of (A12) has a sequence corresponding to GenBank accession number: NM_{—}001565.

The human immunoglobulin heavy chain genetic locus G1 isotype (IGHG1) gene of (A13) has a sequence corresponding to GenBank accession number: AJ275397.

The human zinc finger E-box-binding homeobox 1 (ZEB1) gene of (A14) has a sequence corresponding to GenBank accession number: AI373166 or U12170.

The human vascular endothelial growth factor A (VEGFA) gene of (A15) has a sequence corresponding to GenBank accession number: AF022375.

The human semaphorin-3C precursor (SEMA3C) gene of (A16) has a sequence corresponding to GenBank accession number: AI962897.

The human complement receptor (CR2) gene of (A17) has a sequence corresponding to human complement receptor (CR2) gene (GenBank accession number: NM_{—}001877).

The human HFE gene of (A18) has a sequence corresponding to GenBank accession number: AF144243.

The human EDA gene of (A19) has a sequence corresponding to GenBank accession number: NM_{—}001399.

The gene of (A1) includes a nucleic acid detected by a probe for targeting a polynucleotide having a nucleotide sequence of SEQ ID NO: 1.

The gene of (A2) includes a nucleic acid detected by a probe for targeting a polynucleotide having a nucleotide sequence of SEQ ID NO: 2.

The gene of (A3) includes a nucleic acid detected by a probe for targeting a polynucleotide having a nucleotide sequence of SEQ ID NO: 3.

The gene of (A4) includes a nucleic acid detected by a probe for targeting a polynucleotide having a nucleotide sequence of SEQ ID NO: 4.

The gene of (A5) includes a nucleic acid detected by a probe for targeting a polynucleotide having a nucleotide sequence of SEQ ID NO: 5 or SEQ ID NO: 23.

The gene of (A6) includes a nucleic acid detected by a probe for targeting a polynucleotide having a nucleotide sequence of SEQ ID NO: 6.

The gene of (A7) includes a nucleic acid detected by a probe for targeting a polynucleotide having a nucleotide sequence of SEQ ID NO: 7.

The gene of (A8) includes a nucleic acid detected by a probe for targeting a polynucleotide having a nucleotide sequence of SEQ ID NO: 8, SEQ ID NO: 14 or SEQ ID NO: 19.

The gene of (A9) includes a nucleic acid detected by a probe for targeting a polynucleotide having a nucleotide sequence of SEQ ID NO: 9.

The gene of (A10) includes a nucleic acid detected by a probe for targeting a polynucleotide having a nucleotide sequence of SEQ ID NO: 10.

The gene of (A11) includes a nucleic acid detected by a probe for targeting a polynucleotide having a nucleotide sequence of SEQ ID NO: 11.

The gene of (A12) includes a nucleic acid detected by a probe for targeting a polynucleotide having a nucleotide sequence of SEQ ID NO: 12.

The gene of (A13) includes a nucleic acid detected by a probe for targeting a polynucleotide having a nucleotide sequence of SEQ ID NO: 13.

The gene of (A14) includes a nucleic acid detected by a probe for targeting a polynucleotide having a nucleotide sequence of SEQ ID NO: 15 or SEQ ID NO: 22.

The gene of (A15) includes a nucleic acid detected by a probe for targeting a polynucleotide having a nucleotide sequence of SEQ ID NO: 16.

The gene of (A16) includes a nucleic acid detected by a probe for targeting a polynucleotide having a nucleotide sequence of SEQ ID NO: 17.

The gene of (A17) includes a nucleic acid detected by a probe for targeting a polynucleotide having a nucleotide sequence of SEQ ID NO: 18.

The gene of (A18) includes a nucleic acid detected by a probe for targeting a polynucleotide having a nucleotide sequence of SEQ ID NO: 20.

The gene of (A19) includes a nucleic acid detected by a probe for targeting a polynucleotide having a nucleotide sequence of SEQ ID NO: 21.

The probe of (B1) is a probe that targets a polynucleotide having a nucleotide sequence of SEQ ID NO: 1. The probe has a partial sequence of a nucleotide sequence of SEQ ID NO: 1 or a complementary sequence thereof.

The probe of (B2) is a probe that targets a polynucleotide having a nucleotide sequence of SEQ ID NO: 2. The probe has a partial sequence of a nucleotide sequence of SEQ ID NO: 2 or a complementary sequence thereof.

The probe of (B3) is a probe that targets a polynucleotide having a nucleotide sequence of SEQ ID NO: 3. The probe has a partial sequence of a nucleotide sequence of SEQ ID NO: 3 or a complementary sequence thereof.

The probe of (B4) is a probe that targets a polynucleotide having a nucleotide sequence of SEQ ID NO: 4. The probe has a partial sequence of a nucleotide sequence of SEQ ID NO: 4 or a complementary sequence thereof.

The probe of (B5) is a probe that targets a polynucleotide having a nucleotide sequence of SEQ ID NO: 5. The probe has a partial sequence of a nucleotide sequence of SEQ ID NO: 5 or a complementary sequence thereof.

The probe of (B6) is a probe that targets a polynucleotide having a nucleotide sequence of SEQ ID NO: 6. The probe has a partial sequence of a nucleotide sequence of SEQ ID NO: 6 or a complementary sequence thereof.

The probe of (B7) is a probe that targets a polynucleotide having a nucleotide sequence of SEQ ID NO: 7. The probe has a partial sequence of a nucleotide sequence of SEQ ID NO: 7 or a complementary sequence thereof.

The probe of (B8) is a probe that targets a polynucleotide having a nucleotide sequence of SEQ ID NO: 8. The probe has a partial sequence of a nucleotide sequence of SEQ ID NO: 8 or a complementary sequence thereof.

The probe of (B9) is a probe that targets a polynucleotide having a nucleotide sequence of SEQ ID NO: 9. The probe has a partial sequence of a nucleotide sequence of SEQ ID NO: 9 or a complementary sequence thereof.

The probe of (B10) is a probe that targets a polynucleotide having a nucleotide sequence of SEQ ID NO: 10. The probe has a partial sequence of a nucleotide sequence of SEQ ID NO: 10 or a complementary sequence thereof.

The probe of (B11) is a probe that targets a polynucleotide having a nucleotide sequence of SEQ ID NO: 11. The probe has a partial sequence of a nucleotide sequence of SEQ ID NO: 11 or a complementary sequence thereof.

The probe of (B12) is a probe that targets a polynucleotide having a nucleotide sequence of SEQ ID NO: 12. The probe has a partial sequence of a nucleotide sequence of SEQ ID NO 12 or a complementary sequence thereof.

The probe of (B13) is a probe that targets a polynucleotide having a nucleotide sequence of SEQ ID NO: 13. The probe has a partial sequence of a nucleotide sequence of SEQ ID NO: 13 or a complementary sequence thereof.

The probe of (B14) is a probe that targets a polynucleotide having a nucleotide sequence of SEQ ID NO: 14. The probe has a partial sequence of a nucleotide sequence of SEQ ID NO: 14 or a complementary sequence thereof.

The probe of (B15) is a probe that targets a polynucleotide having a nucleotide sequence of SEQ ID NO: 15. The probe has a partial sequence of a nucleotide sequence of SEQ ID NO: 15 or a complementary sequence thereof.

The probe of (B16) is a probe that targets a polynucleotide having a nucleotide sequence of SEQ ID NO: 16. The probe has a partial sequence of a nucleotide sequence of SEQ ID NO: 16 or a complementary sequence thereof.

The probe of (B17) is a probe that targets a polynucleotide having a nucleotide sequence of SEQ ID NO: 17. The probe has a partial sequence of a nucleotide sequence of SEQ ID NO: 17 or a complementary sequence thereof.

The probe of (B18) is a probe that targets a polynucleotide having a nucleotide sequence of SEQ ID NO: 18. The probe has a partial sequence of a nucleotide sequence of SEQ ID NO: 18 or a complementary sequence thereof.

The probe of (B19) is a probe that targets a polynucleotide having a nucleotide sequence of SEQ ID NO: 19. The probe has a partial sequence of a nucleotide sequence of SEQ ID NO: 19 or a complementary sequence thereof.

The probe of (B20) is a probe that targets a polynucleotide having a nucleotide sequence of SEQ ID NO: 20. The probe has a partial sequence of a nucleotide sequence of SEQ ID NO: 20 or a complementary sequence thereof.

The probe of (B21) is a probe that targets a polynucleotide having a nucleotide sequence of SEQ ID NO: 21. The probe has a partial sequence of a nucleotide sequence of SEQ ID NO: 21 or a complementary sequence thereof.

The probe of (B22) is a probe that targets a polynucleotide having a nucleotide sequence of SEQ ID NO: 22. The probe has a partial sequence of a nucleotide sequence of SEQ ID NO: 22 or a complementary sequence thereof.

The probe of (B23) is a probe that targets a polynucleotide having a nucleotide sequence of SEQ ID NO: 23. The probe has a partial sequence of a nucleotide sequence of SEQ ID NO: 23 or a complementary sequence thereof.

The length of the probes of (B1) to (B23) has typically 10 to 60 nucleotide length, and has 15 to 50 nucleotide length, from the view point of determining the presence or absence of insensitivity to breast cancer neoadjuvant chemotherapy more accurately.

In the present invention, it is preferred to measure an expression level of the specified nucleic acid using a probe set shown in Table 1 from the view point of determining the presence or absence of sensitivity to breast cancer neoadjuvant chemotherapy accurately.

TABLE 1

| Number of | | Nucleotide sequence | |
|---|---|---|---|
| nucleic acid | | of polynucleotide | Nucleotide |
| to be measured | Probe set ID | targeted by probe | sequence of probe |
| 1 | 220162_s_at | SEQ ID NO: 1 | SEQ ID NO: 24~34 |
| 2 | 210029_at | SEQ ID NO: 2 | SEQ ID NO: 35~45 |
| 3 | 203915_at | SEQ ID NO: 3 | SEQ ID NO: 46~56 |
| 4 | 201695_s_at | SEQ ID NO: 4 | SEQ ID NO: 57~67 |
| 5 | 211122_s_at | SEQ ID NO: 5 | SEQ ID NO: 68~78 |
| 6 | 212501_at | SEQ ID NO: 6 | SEQ ID NO: 79~89 |
| 7 | 204440_at | SEQ ID NO: 7 | SEQ ID NO: 90~100 |
| 8 | 204864_s_at | SEQ ID NO: 8 | SEQ ID NO: 101~111 |
| 9 | 205898_at | SEQ ID NO: 9 | SEQ ID NO: 112~122 |
| 10 | 205789_at | SEQ ID NO: 10 | SEQ ID NO: 123~133 |
| 11 | 201487_at | SEQ ID NO: 11 | SEQ ID NO: 134~144 |
| 12 | 204533_at | SEQ ID NO: 12 | SEQ ID NO: 145~155 |
| 13 | 216541_x_at | SEQ ID NO: 13 | SEQ ID NO: 156~166 |
| 14 | 211000_s_at | SEQ ID NO: 14 | SEQ ID NO: 167~177 |
| 15 | 212758_s_at | SEQ ID NO: 15 | SEQ ID NO: 178~188 |
| 16 | 210512_s_at | SEQ ID NO: 16 | SEQ ID NO: 189~199 |
| 17 | 203788_s_at | SEQ ID NO: 17 | SEQ ID NO: 200~210 |
| 18 | 205544_s_at | SEQ ID NO: 18 | SEQ ID NO: 211~221 |
| 19 | 204863_s_at | SEQ ID NO: 19 | SEQ ID NO: 222~232 |
| 20 | 211331_x_at | SEQ ID NO: 20 | SEQ ID NO: 233~243 |
| 21 | 206217_at | SEQ ID NO: 21 | SEQ ID NO: 244~254 |
| 22 | 210875_s_at | SEQ ID NO: 22 | SEQ ID NO: 255~265 |
| 23 | 210163_at | SEQ ID NO: 23 | SEQ ID NO: 266~276 |

In Table 1, “Probe set ID” represents an ID number assigned to each probe set composed of 11 to 20 probes immobilized on the base material in a human genome expression analyzing array (trade name: Human Genome U133 Plus 2.0 Array) manufactured by Affymetrix, Inc. Each probe set includes probes having nucleotide sequences of the SEQ ID NOs shown in Table 1.

Next, an expression level of the specified nucleic acid is analyzed (step (I-3) of Method 1 and step (II-3) of Method 2). Then, based on the obtained analysis result, sensitivity to breast cancer neoadjuvant chemotherapy is determined (step (I-3) of Method 1 and step (II-3) of Method 2).

In step (I-3) of Method 1 and step (II-3) of Method 2, an expression level of the specified nucleic acid can be analyzed, for example, by a classification technique, a scoring technique, a cluster analyzing technique and the like.

As the classification technique, a known method can be used. Examples of such a classification technique include Diagonal Linear Discriminant Analysis (DLDA), Between-group analysis (BGA), Support Vector Machine (SVM), k nearest neighbor classification (kNN), decision tree, Random Forest, neural network and the like. Among them, from the view point of the ability to determine the presence or absence of sensitivity to breast cancer neoadjuvant chemotherapy with a simple operation, DLDA is preferred. When an expression level is analyzed by such a classification technique, specimens are classified into specimens that are sensitive to breast cancer neoadjuvant chemotherapy, and specimens that are insensitive on the basis of the expression level. Therefore, in this case, in step (I-3) of Method 1 and step (II-3) of Method 2, sensitivity to breast cancer neoadjuvant chemotherapy can be determined according to the result of the classification.

When analysis of an expression level of the specified nucleic acid is conducted by DLDA which is a classification technique in step (I-3) of Method 1 and step (II-3) of Method 2, a discriminant constructed by using DLDA can be used.

As the discriminant, a discriminant represented by formula (I):

D=Σᵢ(wᵢ×yᵢ)−3.327217 (I)

(wherein, i represents a number assigned to each nucleic acid shown in Table 2, wᵢ represents a weighting factor of nucleic acid of number i shown in Table 2, yᵢ represents a standardized expression level of nucleic acid, the standardized expression level being obtained by standardizing an expression level of nucleic acid according to the formula represented by formula (II):

yᵢ=xᵢ−mᵢ (II)

(wherein, xᵢ represents an expression level of nucleic acid of number i shown in Table 2, and mᵢ represents a mean value of expression level of nucleic acid of number i shown in Table 2 over the specimens), and Σᵢ represents the sum total over the respective nucleic acids) can be recited.

TABLE 2

| Number of | |
|---|---|
| nucleic acid | Weighting |
| to be measured | factor |
| 1 | 2.36157982 |
| 2 | 0.52753582 |
| 3 | 0.53572137 |
| 4 | 1.29673603 |
| 5 | 0.43776638 |
| 6 | 1.09614395 |
| 7 | 1.15413279 |
| 8 | −0.9979555 |
| 9 | −0.8464557 |
| 10 | 0.70349967 |
| 11 | 1.26206632 |
| 12 | 0.48170925 |
| 13 | 0.78467717 |
| 14 | −1.0561303 |
| 15 | −0.9015298 |
| 16 | 0.9410118 |
| 17 | −0.5801453 |
| 18 | 0.79719845 |
| 19 | −0.9638602 |
| 20 | −1.352304 |
| 21 | −1.2313651 |
| 22 | −0.6378182 |
| 23 | 0.44921773 |

In analyzing an expression level of each nucleic acid with a use of the discriminant represented by formula (I), a value of expression level of the nucleic acid in a specimen is sequentially substituted for xᵢ (i=1, 2, . . . , 23) in the discriminant represented by formula (I), to thereby find solution D. In this case, in step (D), a determination of being sensitive to breast cancer neoadjuvant chemotherapy can be made when solution D is a positive value, and a determination of being insensitive to breast cancer neoadjuvant chemotherapy can be made when solution D is zero or a negative value.

As described above, according to the method of the present embodiment, since the operation of measuring and analyzing an expression level of the specified nucleic acid is employed, it is possible to determine both the presence or absence of sensitivity to breast cancer neoadjuvant chemotherapy in ER-positive cases, and the presence or absence of sensitivity to breast cancer neoadjuvant chemotherapy in ER-negative cases accurately. Therefore, the method according to the present embodiment is able to determine the presence or absence of sensitivity to breast cancer neoadjuvant chemotherapy irrespectively of the classification of the subject, and thus is suited for providing information for assisting decision of whether execution of breast cancer neoadjuvant chemotherapy is adaptable, and more appropriate information for optimization of the therapy.

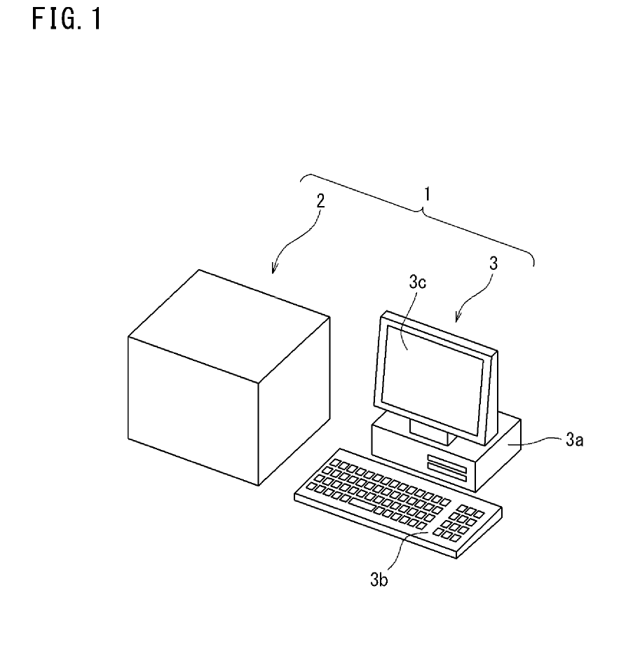

Determination of sensitivity to breast cancer neoadjuvant chemotherapy as described above can be performed, for example, by a determining apparatus 1 shown in FIG. 1. Hereinafter, a determining apparatus that can be used for determining sensitivity to breast cancer neoadjuvant chemotherapy will be described in more detail with reference to the attached drawings, however, it is to be noted that the present invention is not limited to such an embodiment. FIG. 1 is a schematic diagram of a determining apparatus for sensitivity to breast cancer neoadjuvant chemotherapy according to one form of the present embodiment. The determining apparatus 1 illustrated in FIG. 1 includes a measurement device 2, and a computer system 3 connected with the measurement device 2.

In the present embodiment, the measurement device 2 is a microarray scanner that detects a signal based on the specified nucleic acid bound to a probe on a microarray. In the present embodiment, the signal is optical information. The optical information includes, for example, a fluorescent signal, and the like, but the present invention is not limited to the exemplification. In this case, as the microarray after contact with the measurement sample is set in the measurement device 2, the measurement device 2 acquires optical information based on the specified nucleic acid bound to the probe on the microarray, and transmits the resulting optical information to the computer system 3.

The microarray scanner is only required to be able to detect a signal based on the specified nucleic acid. Since the signal based on the specified nucleic acid differs depending on the labelling substance used for labelling cDNA or cRNA in the measurement sample, as the microarray scanner, the one appropriate for detecting a signal arising from a certain labelling substance can be appropriately selected depending on the kind of the labelling substance. For example, when the labelling substance is a radioactive substance, a microarray scanner capable of detecting the radiation arising from the radioactive substance can be used as the measurement device 2.

When an expression level of gene is detected by a nucleic acid amplification method, the measurement device 2 can be a nucleic acid amplification detection device. In this case, a reaction liquid including a measurement sample, enzyme for nucleic acid amplification, primers and the like is set in the measurement device 2. Thereafter, nucleic acid in the reaction liquid is amplified by the nucleic acid amplification method. The measurement device 2 acquires optical information such as fluorescence arising from the reaction liquid by amplification reaction, and turbidity of the reaction liquid, and transmits the optical information to the computer system 3.

The computer system 3 includes a computer main unit 3a, an input device 3b, and a display section 3c for displaying specimen information, determination result and the like. The computer system 3 receives optical information from the measurement device 2. Then a processor of the computer system 3 executes a program for determining sensitivity to breast cancer neoadjuvant chemotherapy on the basis of the optical information.

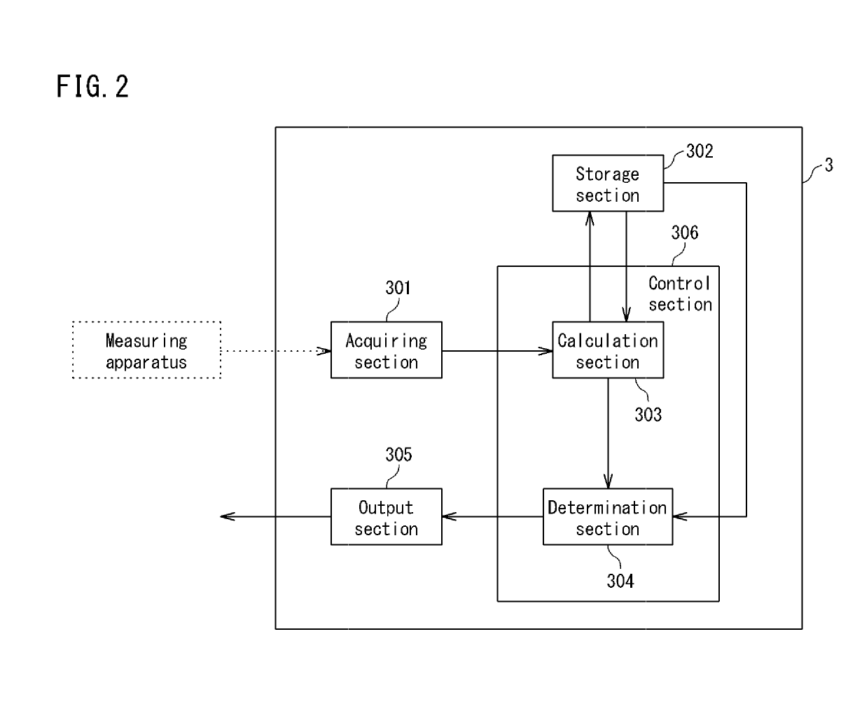

FIG. 2 is a block diagram showing a functional configuration of the determining apparatus shown in FIG. 1.

As shown in FIG. 2, the computer system 3 includes an acquiring section 301, a storage section 302, a calculation section 303, a determination section 304, and an output section 305. The acquiring section 301 is communicatably connected with the measurement device 2 via a network. The calculation section 303 and the determination section 304 form a control section 306.

The acquiring section 301 acquires information transmitted from the measurement device 2. The storage section 302 stores the discriminant represented by formula (I) and a determination criterion. The calculation section 303 calculates solution D of the discriminant according to the discriminant stored in the storage section 302 using the information acquired in the acquiring section 301. The determination section 304 determines the presence or absence of sensitivity to breast cancer neoadjuvant chemotherapy on the basis of solution D calculated by the calculation section 303 and the determination criterion stored in the storage section 302. The output section 305 outputs a determination result by the determination section 304.

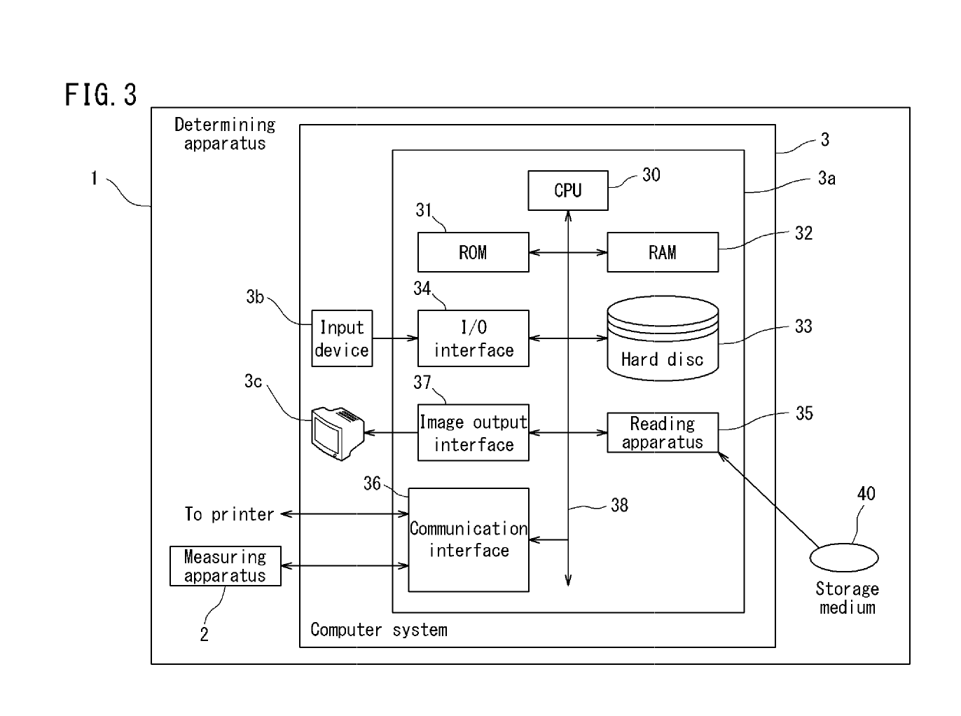

FIG. 3 is a block diagram illustrating a hardware configuration of the determining apparatus shown in FIG. 1.

As shown in FIG. 3, the computer main unit 3a includes a CPU (Central Processing Unit) 30, a ROM (Read Only Memory) 121, a RAM (Random Access Memory) 32, a hard disc 33, an I/O interface 34, a reading device 35, a communication interface 36, and an image output interface 37. The CPU 30, the ROM 31, the RAM 32, the hard disc 33, the I/O interface 34, the reading device 35, the communication interface 36 and the image output interface 37 are connected by a bus 38 in data communicatable manner.

The CPU 30 is able to execute a computer program stored in the ROM 31 and a computer program loaded to the RAM 32. The CPU 30 executes an application program to realize each functional block as described above. As a result, the computer system functions as a terminal of the device for determining the presence or absence of sensitivity to breast cancer neoadjuvant chemotherapy.

The ROM 31 is formed of a mask ROM, a PROM, an EPROM, an EEPROM or the like. The ROM 31 stores a computer program to be executed by the CPU 30 and data used therefor.

The RAM 32 is formed of a SRAM, a DRAM or the like. The RAM 32 is used for reading out a computer program stored in the ROM 31 and the hard disc 33. The RAM 32 is also used as a working space for the CPU 30 in executing these computer programs.

In the hard disc 33, an operation system to be executed by the CPU 30, computer programs such as an application program (computer program for determining the presence or absence of sensitivity to breast cancer neoadjuvant chemotherapy), and data used for execution of the computer programs are installed.

The reading device 35 is formed of a flexible disc drive, a CD-ROM drive, a DVD-ROM drive or the like. The reading device 35 is able to read out a computer program or data stored in a portable recording medium 40.

The I/O interface 34 is made up of, for example, serial interfaces such as USB, IEEE1394, and RS-232C, parallel interfaces such as SCSI, IDE, and IEEE1284, and analogue interfaces formed of a D/A converter, an A/D converter or the like. To the I/O interface 34, the input device 3b such as a keyboard or mouse is connected. An operator is able to input data to the computer main unit 3a by using the input device 3b.

The communication interface 36 is, for example, an Ethernet (registered trade name) interface. The communication interface 36 enables the computer system 3 to transmit printing data to a printer.

The image output interface 37 is connected to the display section 3c formed of a LCD, a CRT or the like. As a result, the display section 3c is able to output a video signal corresponding to image data given from the CPU 30. The display section 3c displays an image (screen) according to the input video signal.

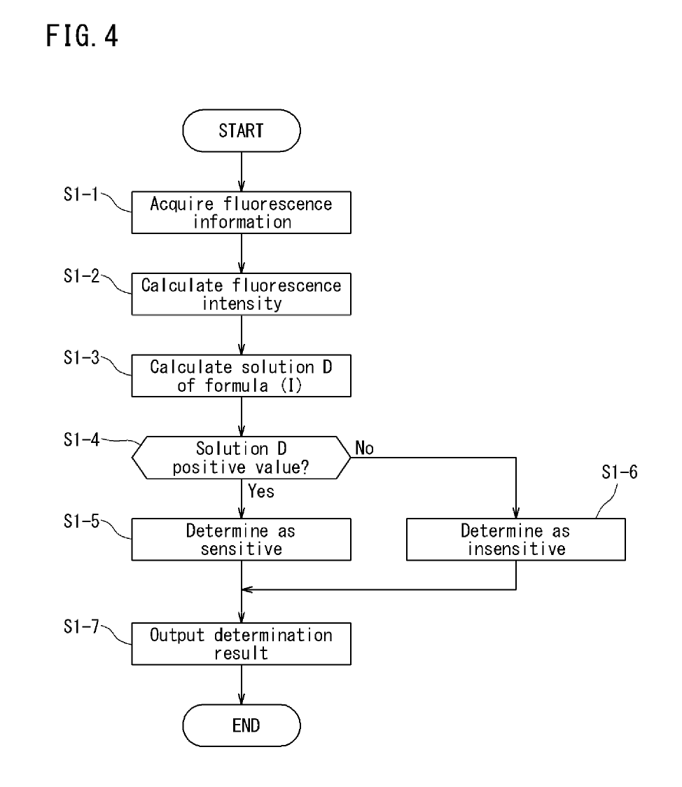

Next, a processing procedure of determining the presence or absence of sensitivity to breast cancer neoadjuvant chemotherapy by the determining apparatus 1 will be described. FIG. 4 is a flowchart of determining sensitivity to breast cancer neoadjuvant chemotherapy using the determining apparatus shown in FIG. 1. Here, description will be made while taking the case of conducting determination using fluorescence information based on a nucleic acid to be measured bound to a probe on a microarray that is brought into contact with a measurement sample as an example, but the present invention is not limited only to this embodiment.

First, in step S1-1, the acquiring section 301 of the determining apparatus 1 acquires fluorescence information from the measurement device 2. Then, in step S1-2, the calculation section 303 calculates fluorescence intensity from the fluorescence information acquired by the acquiring section 301, and transmits it to the storage section 302.

Next, in step S1-3, the calculation section 303 calculates solution D of formula (I) on the basis of the fluorescence intensity stored in the storage section 302 according to the discriminant (I) represented by the formula (I) stored in the storage section 302.

Thereafter, in step S1-4, the determination section 304 determines the presence or absence of sensitivity to breast cancer neoadjuvant chemotherapy (namely, sensitivity and insensitivity) by using the value of solution D calculated in the calculation section 303 and the determination criterion stored in the storage section 302.

Here, when solution D is a positive number, the process advances to step S1-4, and the determination section 304 transmits a determination result indicative of sensitivity to breast cancer neoadjuvant chemotherapy to the output section 305. On the other hand, when solution D is 0 or a negative number, it transmits a determination result indicative of insensitivity to breast cancer neoadjuvant chemotherapy to the output section 305.

Then, in step S1-7, the output section 305 outputs a determination result to make the display section 3c display the result or to make a printer print out the result. As a result, it is possible to provide information that assists a physician in deciding whether the subject is sensitive or insensitive to breast cancer neoadjuvant chemotherapy.

### EXAMPLES

Hereinafter, the present invention will be described in detail by way of examples that will not limit the present invention. In the following examples and the like, a preprocessing (normalization) of data of a CEL file was conducted by using a RMA statistical algorithm of analysis software (trade name: Affymetrix Expression Console software, manufactured by Affymetrix, Inc.) unless otherwise specified. Any other analyses were conducted by using statistical analysis software R (http://www.r-project.org/) and statistical analysis software Bioconductor (http://www.bioconductor.org/).

### Example 1

### (1) Collection of Specimens from Subjects

From each of 117 patients suffering from breast cancer who underwent neoadjuvant chemotherapy at Osaka University Hospital, in the period of 2002 to 2010, a specimen including a breast cancer cell was collected by using a vacuum-assisted core-biopsy instrument attached with a collection needle (size 8 G) (manufactured by Johnson & Johnson K.K., trade name: Mammotome (registered trade name)). Immediately after collection of a specimen, the specimen was put into liquid nitrogen, and stored at −80° C. until use.

### (2) Classification of Subjects

After collection of the specimens in the above (1), the 117 patients underwent, as breast cancer neoadjuvant chemotherapy, administration of 80 mg/m² of paclitaxel once a week for 12 weeks, followed by a total of four times of administrations of 75 mg/m² of epirubicin, 500 mg/m² of cyclophosphamide and 500 mg/m² of 5-fluorouracil (5-FU) every three weeks.

Thereafter, pathologic diagnosis and determination of effect of the anticancer agents were conducted by a histopathological examination, and the 117 patients were classified into a pathological complete response group (pCR group) and a non complete response group (npCR group). The “pCR” refers to the state that a tumor completely disappears, or a tumor remains only in a breast duct accompanied by no infiltration site, and no lymph node metastasis. The “npCR” refers to other states than the pCR.

### (3) Extraction of RNA from Specimen and Preparation of cDNA

From a specimen obtained in the above (1) (about 20 mg), RNA was extracted by using a RNA extracting reagent (trade name: TRIzol (registered trade name) manufactured by Invitrogen, or trade name: RNeasy mini kit manufactured by QIAGEN Sciences), thereby giving a RNA sample.

Using the RNA sample (equivalent to 50 ng of RNA), and a random primer attached to a transcript amplification kit (trade name: WT-Ovation FFPE System V2, manufactured by NuGEN Technologies), first-strand cDNA and second-strand cDNA were synthesized, and thereafter cDNA was amplified by the Ribo-SPIA™ amplification technique. In this way, 117 kinds of cDNA corresponding to the specimens of 117 cases were obtained.

### (4) Analysis of Gene Expression

Using a reagent for fragmentation and labelling (trade name: FL-Ovation™ cDNA Biotin Module V2, manufactured by NuGEN Technologies), the cDNA obtained in the above (3) was labelled with biotin and fragmented.

The resulting fragmented biotin-labelled cDNA was allowed to hybridize with nucleic acid (probe set) on an array for analysis of human genome expression (trade name: Human Genome U133 Plus 2.0 Array, manufactured by Affymetrix, Inc.) overnight. Hybridization between the fragmented biotin-labelled cDNA and nucleic acid (probe set) on the array was conducted according to the conditions recommended by the manufacture (Affymetrix, Inc.).

Next, the array after the hybridization was subjected to a machine specialized for a washing and staining treatment of microarray (trade name: GeneChip (registered trade name) Fluidics Station 450, manufactured by Affymetrix, Inc.) to fluorescently stain the cDNA hybridized with nucleic acid (probe set) on the array and wash the same.

Thereafter, the array was subjected to a microarray scanner (trade name: GeneChip (registered trade name) Scanner 3000, manufactured by Affymetrix, Inc.) to read a signal based on a fluorescent labelling substance of the cDNA hybridized with nucleic acid (probe set) on the array to quantify the fluorescence intensity. The resulting data of fluorescence intensity was processed by software (trade name: GeneChip (registered trade name) Operating Software, manufactured by Affymetrix, Inc.), thereby giving a CEL file. The CEL file was used for gene expression analysis. In this way, CEL files were obtained for the data of fluorescence intensity based on the nucleic acids corresponding to the probes of the probe set in each of the specimens of 117 cases.

### (5) Selection of Probe Set, and Construction of Discriminant for Determination of Sensitivity to Breast Cancer Neoadjuvant Chemotherapy

Among the data corresponding to a total of 54675 probe sets mounted on the trade name: Human Genome U133 Plus 2.0 Array manufactured by Affymetrix, Inc., those of 22283 probe sets that are common to the trade name: Human Genome U133A Array manufactured by Affymetrix, Inc. were used in the following analysis.

Further, among the 22283 probe sets, 934 probe sets that are classified as “Immune response” on the gene ontology biological process were selected by referring information of each probe set published from Affymetrix, Inc. (version na32, http://www.Affymetrix.com/).

In data of respective CEL files of the acquired 117 cases, for each of the 934 probe sets, from an expression level of the nucleic acid detected by the probe set, a mean value of expression level of the nucleic acid in 117 cases was subtracted to thereby standardize the expression level (mean-centering).

Next, respective fluorescence intensity data of the specimens of 117 cases was randomly grouped into 58 cases of a training set and 59 cases of a validation set. At this time, the grouping was conducted so that the number of pCR cases in the training set is about twice the number of pCR cases in the validation set so as to increase the detectability of gene corresponding to the probe set whose expression level differs between pCR and npCR cases. Every subsequent analysis other than those described separately was applied to the data of the training set.

The fact that the expression level of the gene corresponding to the probe set differs between pCR and npCR was evaluated by a Welch's t-test, and thereafter a probe set in which p value is less than 0.01 was selected.

Then, discriminants were constructed by increasing the number of selected probe sets one by one in increasing order of p value in the Welch's t-test using a Diagonal Linear Discriminant Analysis (DLDA) as an algorithm of the discriminant.

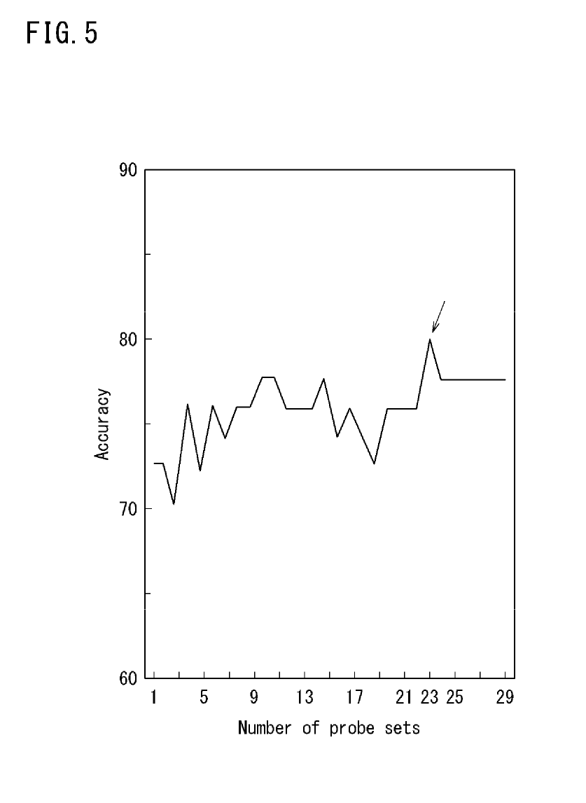

Then, the number of probe sets with which the accuracy is maximized was determined by using a Leave-One-Out Cross-Validation method. In the Leave-One-Out Cross-Validation method, using a discriminant constructed of data of the training set excluding one case, a result of the excluded one case was predicted, and this operation was repeated 58 times while varying data of one case that is excluded, and the pathologic diagnosis results of 58 cases and the results of 58 cases predicted by discriminants were aggregated. The accuracy was determined by dividing a sum of “the number of specimens exhibiting pCR as a pathologic diagnosis result and predicted as being p CR”, and “the number of specimens exhibiting npCR as a pathologic diagnosis result and predicted as being npCR” by the total specimen number. FIG. 5 illustrates the result of examining the relation between the probe set number and the accuracy in Example 1.

The result shown in FIG. 5 reveals that accuracy is maximum when 23 probe sets including the top 23rd probe sets in increasing order of p value in the Welch's t-test (see Table 3) are used. These 23 probe sets respectively target the polynucleotides represented SEQ ID NO: 1 to 23. For these 23 probe sets, a final discriminant was constructed by using all training set data.

TABLE 3

| | | Nucleotide | | | | | | |
|---|---|---|---|---|---|---|---|---|
| Number of | | sequence of | | Nucleotide | | | | |
| nucleic acid | | polynucleotide | Gene | sequence | Weighting | Welch's | | High |
| to be measured | Probe set ID | targeted by probe | symbol | of probe | factor | t-test | p value | expression |
| 1 | 220162_s_at | SEQ ID NO: 1 | CARD9 | SEQ ID NO: 24~34 | 2.36157982 | 4.323 | 0.0001 | pCR |
| 2 | 210029_at | SEQ ID NO: 2 | ID01 | SEQ ID NO: 35~45 | 0.52753582 | 3.835 | 0.0004 | pCR |
| 3 | 203915_at | SEQ ID NO: 3 | CXCL9 | SEQ ID NO: 46~56 | 0.53572137 | 3.760 | 0.0005 | pCR |
| 4 | 201695_s_at | SEQ ID NO: 4 | PNP | SEQ ID NO: 57~67 | 1.29673603 | 3.804 | 0.0006 | pCR |
| 5 | 211122_s_at | SEQ ID NO: 5 | CXCL11 | SEQ ID NO: 68~78 | 0.43776638 | 3.686 | 0.0007 | pCR |
| 6 | 212501_at | SEQ ID NO: 6 | CEBPB | SEQ ID NO: 79~89 | 1.09614395 | 3.631 | 0.0009 | pCR |
| 7 | 204440_at | SEQ ID NO: 7 | CD83 | SEQ ID NO: 90~100 | 1.15413279 | 3.397 | 0.0013 | pCR |
| 8 | 204864_s_at | SEQ ID NO: 8 | IL6ST | SEQ ID NO: 101~111 | −0.9979555 | −3.444 | 0.0015 | npCR |
| 9 | 205898_at | SEQ ID NO: 9 | CX3CR1 | SEQ ID NO: 112~122 | −0.8464557 | −3.327 | 0.0020 | npCR |
| 10 | 205789_at | SEQ ID NO: 10 | CD1D | SEQ ID NO: 123~133 | 0.70349967 | 3.263 | 0.0021 | pCR |
| 11 | 201487_at | SEQ ID NO: 11 | CTSC | SEQ ID NO: 134~144 | 1.26206632 | 3.314 | 0.0022 | pCR |
| 12 | 204533_at | SEQ ID NO: 12 | CXCL10 | SEQ ID NO: 145~155 | 0.48170925 | 3.165 | 0.0030 | pCR |
| 13 | 216541_x_at | SEQ ID NO: 13 | IGHG1 | SEQ ID NO: 156~166 | 0.78467717 | 3.158 | 0.0031 | pCR |
| 14 | 211000_s_at | SEQ ID NO: 14 | IL6ST | SEQ ID NO: 167~177 | −1.0561303 | −3.189 | 0.0031 | npCR |
| 15 | 212758_s_at | SEQ ID NO: 15 | ZEB1 | SEQ ID NO: 178~188 | -0.9015298 | −3.130 | 0.0034 | npCR |
| 16 | 210512_s_at | SEQ ID NO: 16 | VEGFA | SEQ ID NO: 189~199 | 0.9410118 | 3.102 | 0.0036 | pCR |
| 17 | 203788_s_at | SEQ ID NO: 17 | SEMA3C | SEQ ID NO: 200~210 | −0.5801453 | −3.133 | 0.0040 | npCR |
| 18 | 205544_s_at | SEQ ID NO: 18 | CR2 | SEQ ID NO: 211-221 | 0.79719845 | 3.149 | 0.0040 | pCR |
| 19 | 204863_s_at | SEQ ID NO: 19 | IL6ST | SEQ ID NO: 222~232 | −0.9638602 | −3.083 | 0.0043 | npCR |
| 20 | 211331_x_at | SEQ ID NO: 20 | HFE | SEQ ID NO: 233~243 | −1.352304 | −2.993 | 0.0047 | npCR |
| 21 | 206217_at | SEQ ID NO: 21 | EDA | SEQ ID NO: 244~254 | −1.2313651 | −3.001 | 0.0049 | npCR |
| 22 | 210875_s_at | SEQ ID NO: 22 | ZEB1 | SEQ ID NO: 255~265 | −0.6378182 | −2.930 | 0.0054 | npCR |
| 23 | 210163_at | SEQ ID NO: 23 | CXCL11 | SEQ ID NO: 266~276 | 0.44921773 | 2.919 | 0.0061 | pCR |

The resulting discriminant is a discriminant represented by formula (I):

D=Σᵢ(wᵢ×yᵢ)−3.327217 (I)

(wherein, i represents a number assigned to each nucleic acid shown in Table 2, wᵢ represents a weighting factor of nucleic acid of number i shown in Table 2, yᵢ represents a standardized expression level of nucleic acid, the standardized expression level being obtained by standardizing an expression level of nucleic acid according to the formula represented by formula (II):

yᵢ=xᵢ−mᵢ (II)

(wherein, xᵢ represents an expression level of nucleic acid of number i shown in Table 2, and mᵢ represents a mean value of expression level of nucleic acid of number i shown in Table 2 over the specimens), and Σi represents the sum total over the respective nucleic acids). When solution D of the discriminant represented by formula (I) is a positive value, it can be determined that the specimen is sensitive to breast cancer neoadjuvant chemotherapy, and when solution D is 0 or a negative value, it can be determined that the specimen is insensitive to breast cancer neoadjuvant chemotherapy.

### (6) Comparison Between Determination Result by Discriminant and Pathologic Diagnosis Result

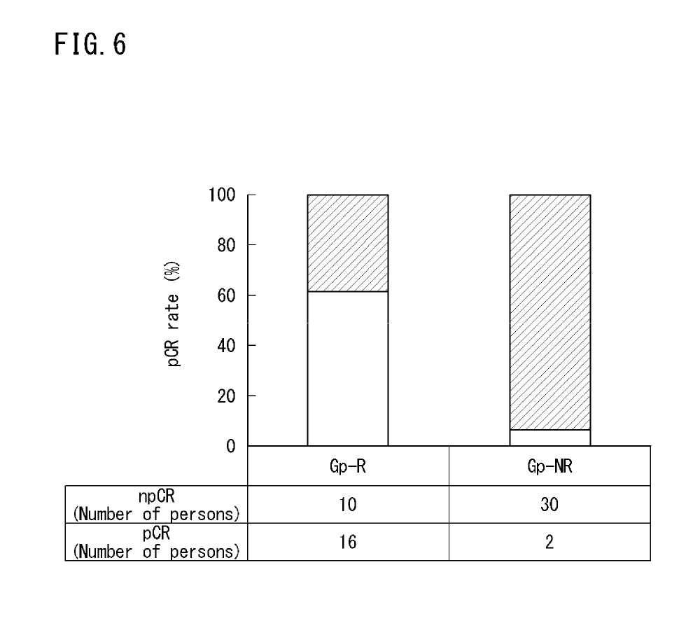

Using the data of expression level measured for the specimens of 58 cases grouped in the training set (data of fluorescence intensity), and the discriminant represented by formula (I), to which one of the pCR group and the npCR group of breast cancer patient specimens each specimen of the 58 cases corresponds was determined. The performance of the discriminant was evaluated by comparing the determination result by the discriminant represented by formula (I) and the result of the pathologic diagnosis with a use of the result of the pathologic diagnosis as a true value. FIG. 6 illustrates the result of comparison between the determination result by the discriminant represented by formula (I) and the pathologic diagnosis result for the training set in Example 1. In the figure, “Gp-R” denotes a specimen determined as “a specimen of a subject sensitive to breast cancer neoadjuvant chemotherapy” by the discriminant, and the “Gp-NR” denotes a specimen determined as “a specimen of a subject insensitive to breast cancer neoadjuvant chemotherapy” by the discriminant.

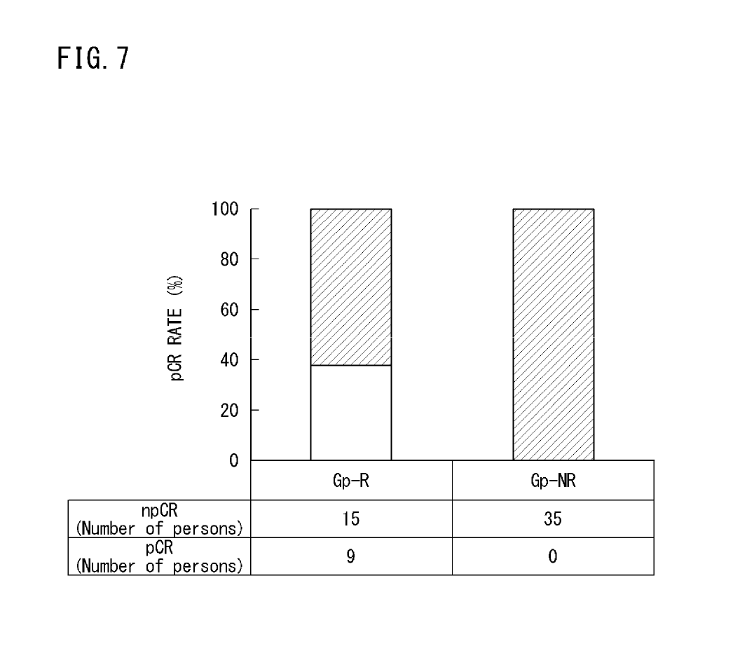

Next, using the data of expression levels measured for the specimens of 59 cases grouped in the validation set (data of fluorescence intensity), and the discriminant, sensitivity to breast cancer neoadjuvant chemotherapy was determined by determining to which one of the pCR group and the npCR group of breast cancer patient specimens each specimen of the 59 cases is allocated was determined. By comparing the pathologic diagnosis result and the determination result by the discriminant using the pathologic diagnosis result as a true value, the performance of the discriminant was evaluated. FIG. 7 illustrates the result of comparison between the determination result by the discriminant represented by formula (I) and the pathologic diagnosis result for the validation set in Example 1. In the figure, “Gp-R” denotes a specimen determined as “a specimen of a subject sensitive to breast cancer neoadjuvant chemotherapy” by the discriminant, and the “Gp-NR” denotes a specimen determined as “a specimen of a subject insensitive to breast cancer neoadjuvant chemotherapy” by the discriminant.

The result shown in FIG. 6 reveals that among the specimens of 58 cases grouped in the training set, 26 cases are determined as Gp-R and 32 cases are determined as Gp-NR by the discriminant represented by formula (I). Also, the result shown in FIG. 6 reveals that among the specimens determined as Gp-R, 16 cases are specimens of breast cancer patients of the pCR group, and among the specimens determined as Gp-NR, 30 cases are specimens of breast cancer patients of the npCR group. Therefore, these results demonstrate that the specimens sensitive to breast cancer neoadjuvant chemotherapy and the specimens insensitive to breast cancer neoadjuvant chemotherapy can be discriminated in the training set according to the discriminant represented by formula (I).

Further, the result shown in FIG. 7 reveals that among the specimens of 59 cases grouped in the validation set, 24 cases are determined as Gp-R and 35 cases are determined as Gp-NR by the discriminant represented by formula (I). Also, the result shown in FIG. 7 reveals that among the specimens determined as Gp-R, 9 cases are specimens of breast cancer patients of the pCR group, and all of the specimens determined as Gp-NR are specimens of breast cancer patients of the npCR group. Therefore, these results demonstrate that the specimens sensitive to breast cancer neoadjuvant chemotherapy and the specimens insensitive to breast cancer neoadjuvant chemotherapy can be discriminated in the validation set according to the discriminant represented by formula (I).

These results suggest that the presence or absence of sensitivity to breast cancer neoadjuvant chemotherapy can be determined accurately by using the expression level of each nucleic acid detected by the probes of (1) to (23) in a specimen collected from a subject.

### Example 2

From data sets of six subject groups of accession numbers: GSE16446 (subject groups 1-1), GSE20194 (subject groups 1-2), GSE20271 (subject groups 1-3), GSE22093 (subject groups 1-4), GSE23988 (subject groups 1-5) and GSE41998 (subject groups 1-6) in gene expression information database of microarray experiments (NCBI Gene Expression Omnibus (http://www.ncbi.nlm.nih.gov/geo/)), data of 901 cases of breast cancer cases having undergone neoadjuvant chemotherapy was extracted. For the extracted data, RMA normalization and mean-centering were conducted for each data set. Using the expression level of each nucleic acid detected by the probes of (1) to (23) in the resulting data, and the discriminant represented by formula (I), the presence or absence of sensitivity to breast cancer neoadjuvant chemotherapy was determined.

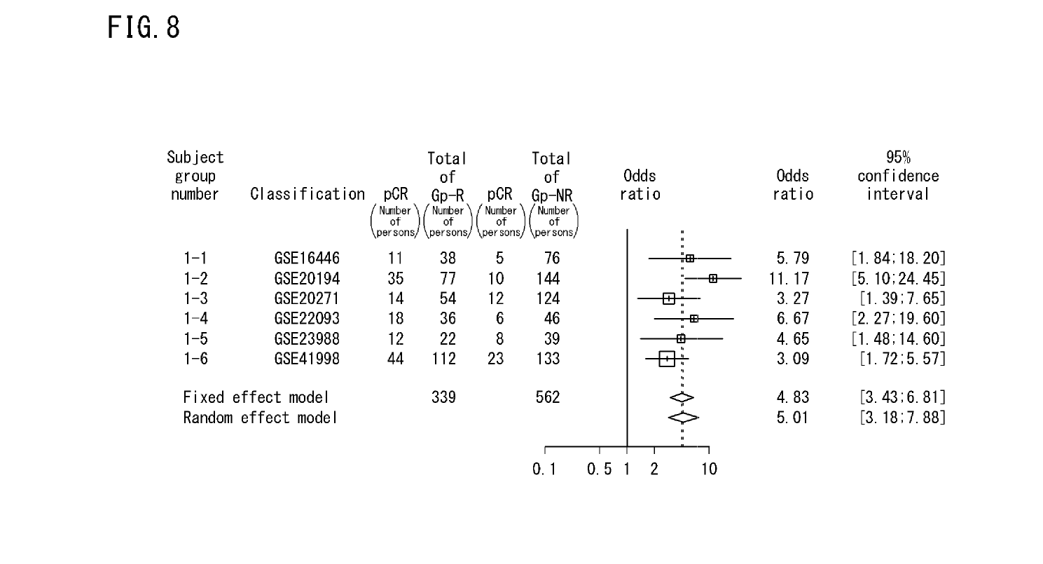

Next, for each data set, the determination result by the discriminant represented by formula (I) was compared with the pathologic diagnosis result acquired from the database, to thereby evaluate the performance of the discriminant. FIG. 8 illustrates the result of comparison between the determination result by the discriminant represented by formula (I) and the pathologic diagnosis result acquired from the database in Example 2.

Since the odds ratio exceeds 1 (greater than or equal to 3.09) and the minimum value in the 95% confidence interval exceeds 1 for all of the subject groups 1-1 to 1-6 as can be seen from the result shown in FIG. 8, it can be recognized that the determination by the discriminant represented by formula (I) is not an accidental result, but is a significant result in any cases. Therefore, these results suggest that sensitivity to breast cancer neoadjuvant chemotherapy can be determined accurately by using the expression level of each nucleic acid detected by the probes of (1) to (23).

### Example 3

The data of 901 cases extracted in Example 2 was classified into the following three data sets, subject groups 2-1 to 2-3, based on the presence or absence of each of ER and HER2:

subject group 2-1: group consisting of subjects showing ER positivity and HER2 negativity (ER⁺, HER⁻),

subject group 2-2: group consisting of subjects showing ER positivity or ER negativity and HER2 positivity (ER⁺^{^{−}}, HER2⁺), and

subject group 2-3: group consisting of subjects showing ER negativity and HER2 negativity (ER⁻, HER2⁻). Since the “group consisting of subjects showing ER positivity and HER2 positivity (ER⁺, HER2⁺)” and the “group consisting of subjects showing ER negativity and HER2 positivity (ER⁻, HER2⁺)” are common in that they are sensitive to Herceptin, they are collected in subject group 2-2.

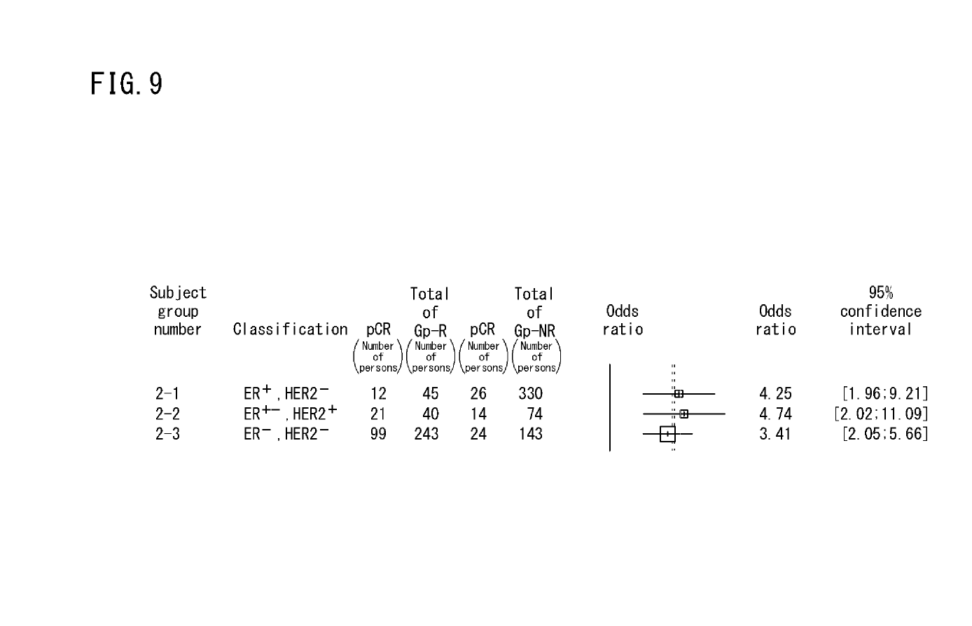

Next, for each data set, the determination result by the discriminant represented by formula (I) was compared with the pathologic diagnosis result acquired from the database, to thereby evaluate the performance of the discriminant. FIG. 9 illustrates the result of comparison between the determination result by the discriminant represented by formula (I) and the pathologic diagnosis result acquired from the database in Example 3.

Since the odds ratio exceeds 1 (greater than or equal to 3.41) and the minimum value in the 95% confidence interval exceeds 1 for all of the subject groups 2-1 to 2-3 as can be seen from the result shown in FIG. 9, it can be recognized that the determination by the discriminant represented by formula (I) is not an accidental result, but is a significant result in any cases. Therefore, these results suggest that sensitivity to breast cancer neoadjuvant chemotherapy can be determined accurately by using the expression level of each nucleic acid detected by the probes of (1) to (23) also in the data sets classified according to the presence or absence of each of ER and HER2. Also, these results suggest that the presence or absence of sensitivity to breast cancer neoadjuvant chemotherapy can be accurately determined irrespectively of the classification based on ER positivity and ER negativity by using the expression level of each nucleic acid detected by the probes of (1) to (23).

### Example 4

The data of 901 cases extracted in Example 2 was classified into five data sets based on the kind of regimen of breast cancer neoadjuvant chemotherapy.

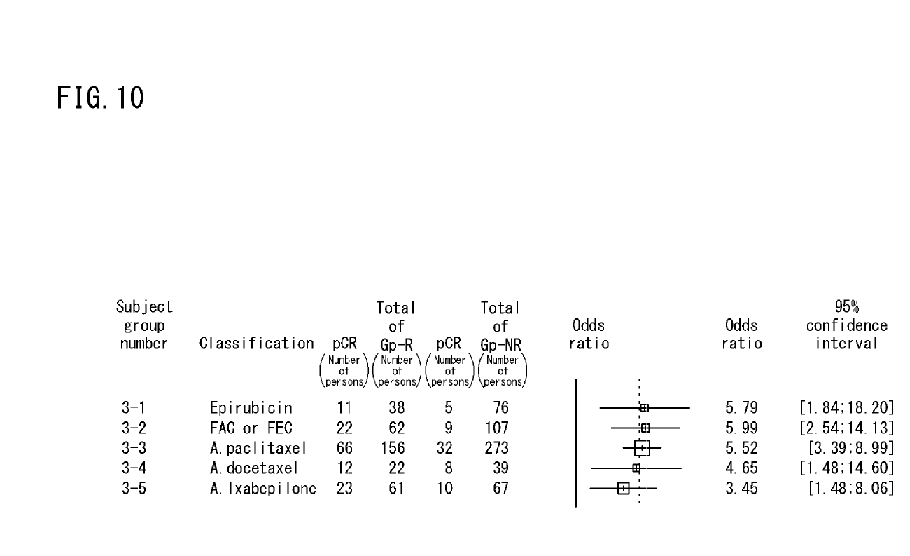

Then, for each data set, the determination result by the discriminant represented by formula (I) was compared with the pathologic diagnosis result acquired from the database, to thereby evaluate the performance of the discriminant. FIG. 10 illustrates the result of comparison between the determination result by the discriminant represented by formula (I) and the pathologic diagnosis result acquired from the database in Example 4. In the figure, “Epirubicin” denotes a group consisting of subjects administered with epirubicin (subject group 3-1), “FAC or FEC” denotes a group consisting of subjects administered with a combination of 5-fluorouracil, Adriamycin and cyclophosphamide, or a combination of 5-fluorouracil, epirubicin and cyclophosphamide (subject group 3-2), “A. paclitaxel” denotes a group consisting of subjects administered with anthracycline and paclitaxel (subject group 3-3), “A. docetaxel” denotes a group consisting of subjects administered with anthracycline and docetaxel (subject group 3-4), and “A. Ixabepilone” denotes a group consisting of subjects administered with anthracycline and ixabepilone (subject group 3-5).

Since the odds ratio exceeds 1 (greater than or equal to 3.45) and the minimum value in the 95% confidence interval exceeds 1 for all of the subject groups 3-1 to 3-5 as can be seen from the result shown in FIG. 10, it can be recognized that the determination by the discriminant represented by formula (I) is not an accidental result, but is a significant result in any cases. Therefore, these results suggest that sensitivity to breast cancer neoadjuvant chemotherapy can be determined accurately by using the expression level of each nucleic acid detected by the probes of (1) to (23) also in the data sets classified according to the used regimen of breast cancer neoadjuvant chemotherapy. Also, these results suggest that the presence or absence of sensitivity to breast cancer neoadjuvant chemotherapy can be accurately determined irrespectively of the classification based on the regimen of breast cancer neoadjuvant chemotherapy by using the expression level of each nucleic acid detected by the probes of (1) to (23).

### Comparative Example 1

Using the expression levels of genes corresponding to 70 probe sets listed in Tables 1 and 2 of WO 2011/065533 A in the data of 901 cases extracted in Example 2, the presence or absence of sensitivity to breast cancer neoadjuvant chemotherapy was determined according to the method described in WO 2011/065533 A.

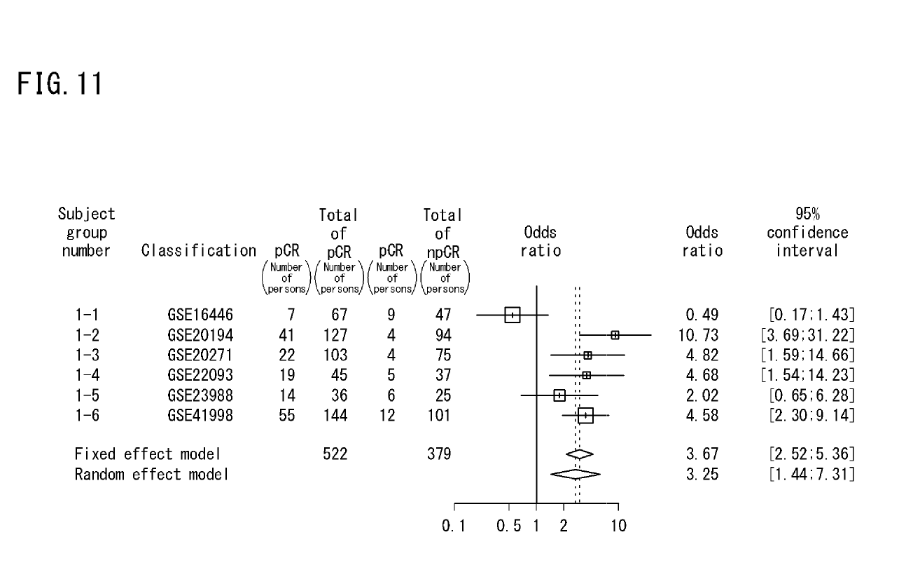

Next, for each data set of the subject groups 1-1 to 1-6, the determination result obtained by using the expression levels of genes corresponding to 70 probe sets listed in Tables 1 and 2 of WO 2011/065533 A was compared with the pathologic diagnosis result acquired from the database, to thereby evaluate the performance of the discriminant. FIG. 11 illustrates the result of comparison between the determination result obtained by using the expression levels of genes corresponding to 70 probe sets listed in Tables 1 and 2 of WO 2011/065533 A and the pathologic diagnosis result acquired from the database for the subject groups 1-1 to 1-6 in Comparative Example 1.

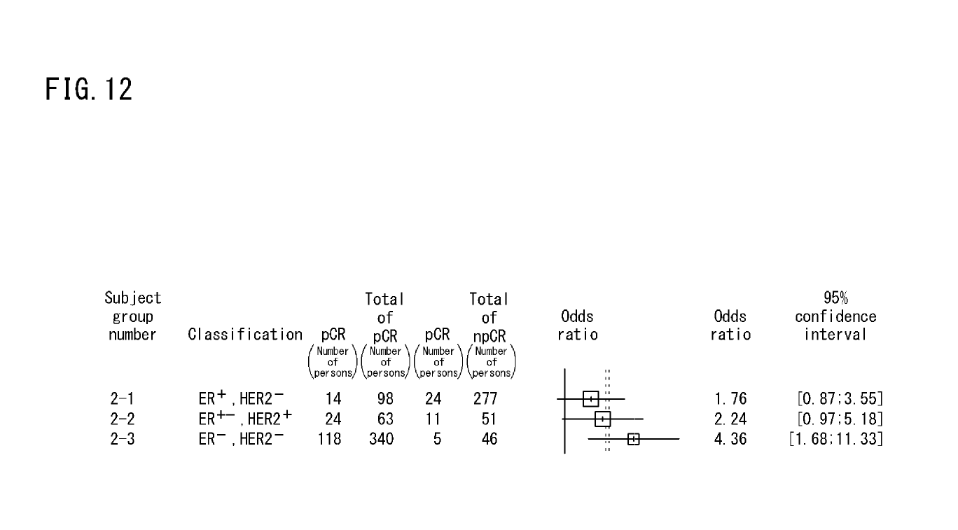

Also for each data set of the subject groups 2-1 to 2-3, the determination result obtained by using the expression levels of genes corresponding to 70 probe sets listed in Tables 1 and 2 of WO 2011/065533 A was compared with the pathologic diagnosis result acquired from the database, to thereby evaluate the performance of the discriminant. FIG. 12 illustrates the result of comparison between the determination result obtained by using the expression levels of genes corresponding to 70 probe sets listed in Tables 1 and 2 of WO 2011/065533 A and the pathologic diagnosis result acquired from the database for the subject groups 2-1 to 2-3 in Comparative Example 1.

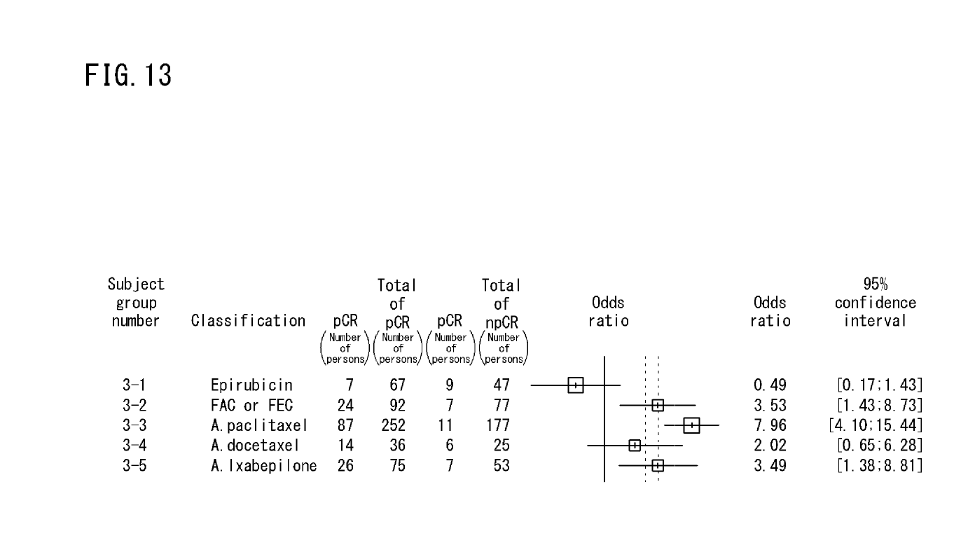

Further, for each data set of the subject groups 3-1 to 3-5, the determination result obtained by using the expression levels of genes corresponding to 70 probe sets listed in Tables 1 and 2 of WO 2011/065533 A was compared with the pathologic diagnosis result acquired from the database, to thereby evaluate the performance of the discriminant. FIG. 13 illustrates the result of comparison between the determination result obtained by using the expression levels of genes corresponding to 70 probe sets listed in Tables 1 and 2 of WO 2011/065533 A and the pathologic diagnosis result acquired from the database for the subject groups 3-1 to 3-5 in Comparative Example 1. In the figure, “Epirubicin”, “FAC or FEC”, “A. paclitaxel”, “A. docetaxel” and “A. Ixabepilone” are identical to “Epirubicin”, “FAC or FEC”, “A. paclitaxel”, “A. docetaxel” and “A. Ixabepilone” in FIG. 10.

The result shown in FIG. 11 reveals that the reliability of the determination result can be poor depending on the kind of population of the subject group, since there is a case that both the odds ratio regarding the determination result and the minimum value in the 95% confidence interval are less than or equal to 1. Also the result shown in FIG. 12 reveals that the reliability of the determination result in each of the ER-positive cases and the ER-negative cases is poor when the expression levels of genes corresponding to 70 probe sets listed in Tables 1 and 2 of WO 2011/065533 A are used, since there is a case that the minimum value in the 95% confidence interval of odds ratio regarding the determination result is less than or equal to 1, also in the determination result for each data set of the subject groups classified according to the presence or absence of each of ER and HER2. Further, the result shown in FIG. 13 reveals that the reliability of the determination result can be poor depending on the kind of the administered anticancer agent when the expression levels of genes corresponding to 70 probe sets listed in Tables 1 and 2 of WO 2011/065533 A are used, since there is a case that both the odds ratio regarding the determination result and the minimum value in the 95% confidence interval are less than or equal to 1, also in the determination result for each data set of the subject groups classified according to the kind of the used regimen of breast cancer neoadjuvant chemotherapy.

### Comparative Example 2

Using the expression level of B-cell metagene described in Schmidt M et al. (Cancer research, 2008, Vol. 68, p. 5405-5413) in the data of 901 cases extracted in Example 2, the presence or absence of sensitivity to breast cancer neoadjuvant chemotherapy was determined according to the method described in Schmidt M et al. (Cancer research, 2008, Vol. 68, p. 5405-5413).

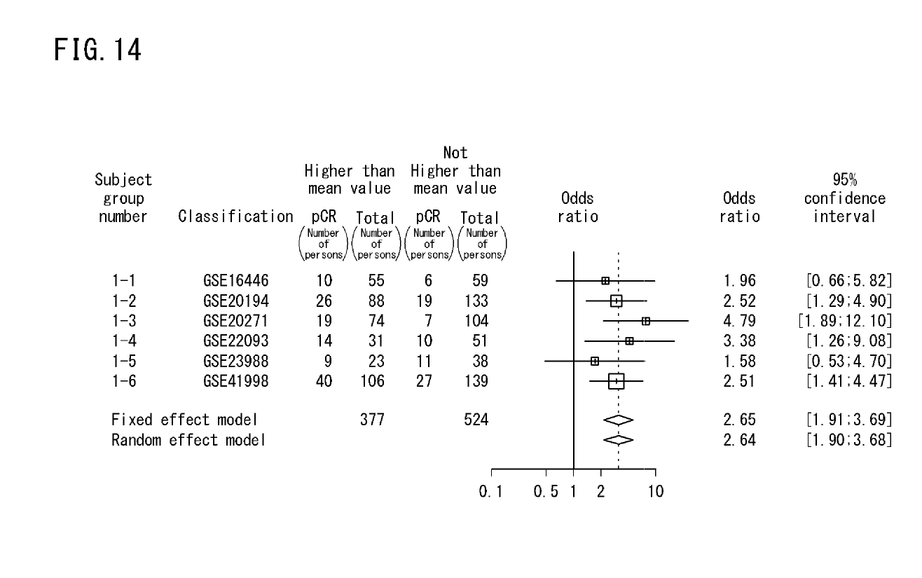

Next, for each data set of the subject groups 1-1 to 1-6, the determination result obtained according to the method described in Schmidt M et al. (Cancer research, 2008, Vol. 68, p. 5405-5413) was compared with the pathologic diagnosis result acquired from the database, to thereby evaluate the performance of the discriminant. FIG. 14 illustrates the result of comparison between the determination result obtained according to the method described in Schmidt M et al. (Cancer research, 2008, Vol. 68, p. 5405-5413) and the pathologic diagnosis result acquired from the database for the subject groups 1-1 to 1-6 in Comparative Example 2.

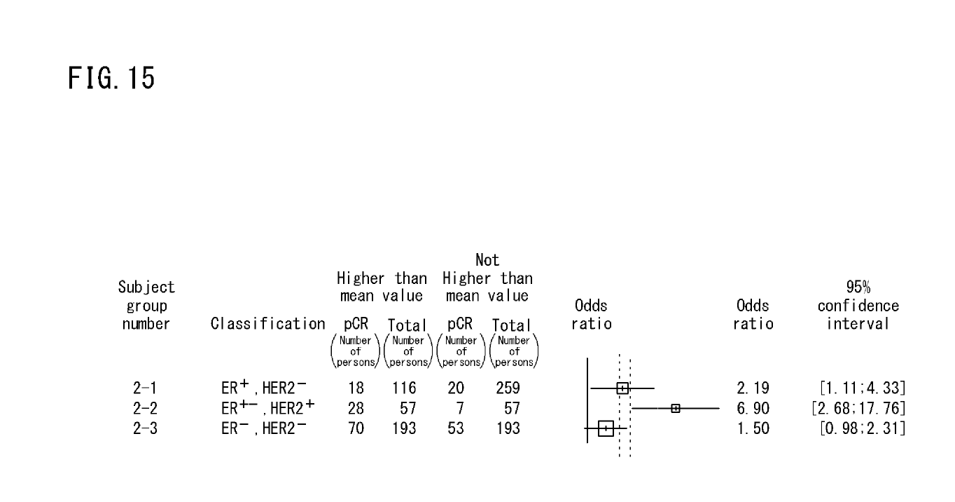

For each data set of the subject groups 2-1 to 2-3, the determination result obtained according to the method described in Schmidt M et al. (Cancer research, 2008, Vol. 68, p. 5405-5413) was compared with the pathologic diagnosis result acquired from the database, to thereby evaluate the performance of the discriminant. FIG. 15 illustrates the result of comparison between the determination result obtained according to the method described in Schmidt M et al. (Cancer research, 2008, Vol. 68, p. 5405-5413) and the pathologic diagnosis result acquired from the database for the subject groups 2-1 to 2-3 in Comparative Example 2.

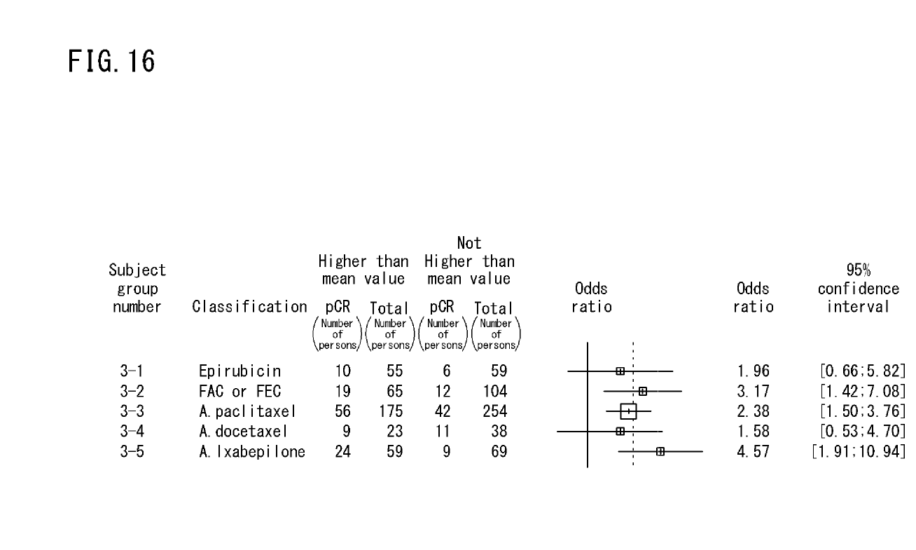

Further, for each data set of the subject groups 3-1 to 3-5, the determination result obtained according to the method described in Schmidt M et al. (Cancer research, 2008, Vol. 68, p. 5405-5413) was compared with the pathologic diagnosis result acquired from the database, to thereby evaluate the performance of the discriminant. FIG. 16 illustrates the result of comparison between the determination result obtained according to the method described in Schmidt M et al. (Cancer research, 2008, Vol. 68, p. 5405-5413) and the pathologic diagnosis result acquired from the database for the subject groups 3-1 to 3-5 in Comparative Example 2. In the figure, “Epirubicin”, “FAC or FEC”, “A. paclitaxel”, “A. docetaxel” and “A. Ixabepilone” are identical to “Epirubicin”, “FAC or FEC”, “A. paclitaxel”, “A. docetaxel” and “A. Ixabepilone” in FIG. 10.

The result shown in FIG. 14 reveals that the reliability of the determination result can be poor depending on the kind of population of the subject group according to the method described in Schmidt M et al. (Cancer research, 2008, Vol. 68, p. 5405-5413), since there is a case that the minimum value in the 95% confidence interval of odds ratio regarding the determination result is less than or equal to 1. Also the result shown in FIG. 15 reveals that the method described in Schmidt M et al. (Cancer research, 2008, Vol. 68, p. 5405-5413) is poor in reliability of the determination result in each of the ER-positive cases and the ER-negative cases, since there is a case that the minimum value in the 95% confidence interval of odds ratio regarding the determination result is less than or equal to 1, also in the determination result for each data set of the subject groups classified according to the presence or absence of each of ER and HER2. Further, the result shown in FIG. 16 reveals that according to the method described in Iwamoto T et al. (Journal of the National Cancer Institute, 2011, Vol. 103, p. 264-272), the reliability of the determination result can be poor depending on the kind of the administered anticancer agent, since there is a case that the minimum value in the 95% confidence interval of odds ratio regarding the determination result is less than or equal to 1, also in the determination result for each data set of the subject groups classified according to the kind of the used regimen of breast cancer neoadjuvant chemotherapy.

### Comparative Example 3

Using the expression level of immunogloblin κC gene described in Schmidt M et al. (Clinical Cancer Research, 2012, Vol. 18, p. 2695-2703) in the data of 901 cases extracted in Example 2, the presence or absence of sensitivity to breast cancer neoadjuvant chemotherapy was determined according to the method described in Schmidt M et al. (Clinical Cancer Research, 2012, Vol. 18, p. 2695-2703).

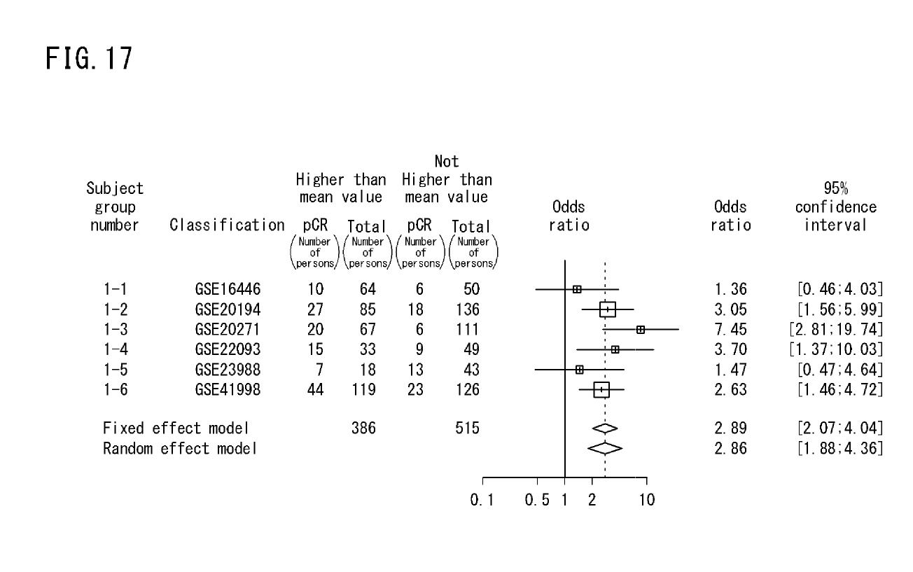

Next, for each data set of the subject groups 1-1 to 1-6, the determination result obtained according to the method described in Schmidt M et al. (Clinical Cancer Research, 2012, Vol. 18, p. 2695-2703) was compared with the pathologic diagnosis result acquired from the database, to thereby evaluate the performance of the discriminant. FIG. 17 illustrates the result of comparison between the determination result obtained according to the method described in Schmidt M et al. (Clinical Cancer Research, 2012, Vol. 18, p. 2695-2703) and the pathologic diagnosis result acquired from the database for the subject groups 1-1 to 1-6 in Comparative Example 3.

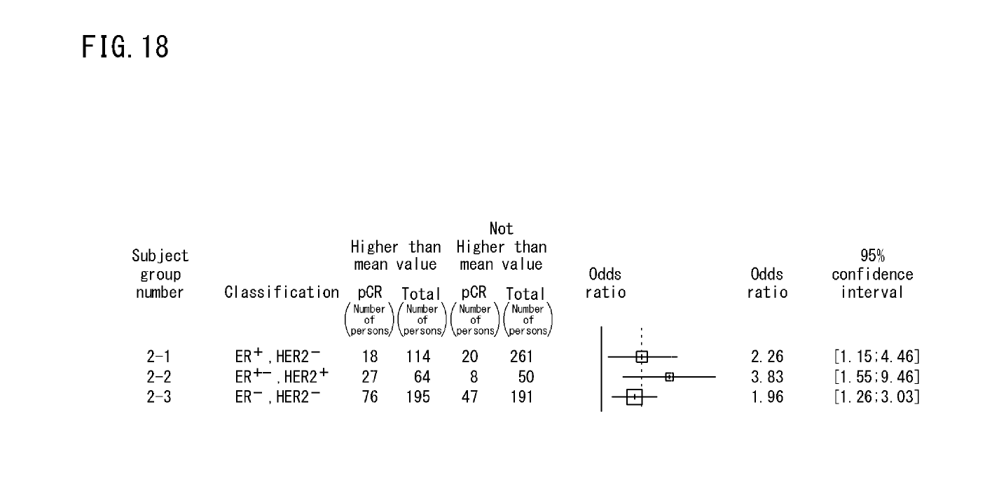

For each data set of the subject groups 2-1 to 2-3, the determination result obtained according to the method described in Schmidt M et al. (Clinical Cancer Research, 2012, Vol. 18, p. 2695-2703) was compared with the pathologic diagnosis result acquired from the database, to thereby evaluate the performance of the discriminant. FIG. 18 illustrates the result of comparison between the determination result obtained according to the method described in Schmidt M et al. (Clinical Cancer Research, 2012, Vol. 18, p. 2695-2703) and the pathologic diagnosis result acquired from the database for the subject groups 2-1 to 2-3 in Comparative Example 3.

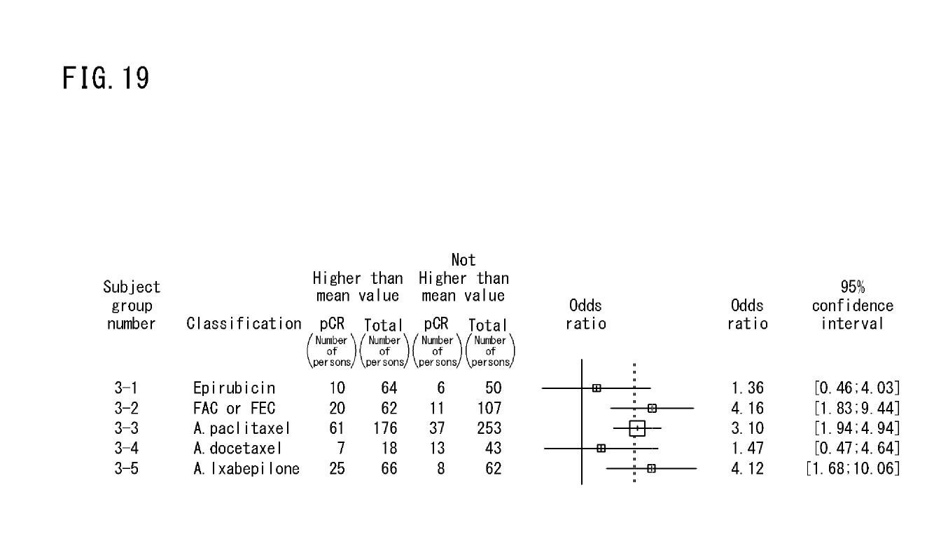

Further, for each data set of the subject groups 3-1 to 3-5, the determination result obtained according to the method described in Schmidt M et al. (Clinical Cancer Research, 2012, Vol. 18, p. 2695-2703) was compared with the pathologic diagnosis result acquired from the database, to thereby evaluate the performance of the discriminant. FIG. 19 illustrates the result of comparison between the determination result obtained according to the method described in Schmidt M et al. (Clinical Cancer Research, 2012, Vol. 18, p. 2695-2703) and the pathologic diagnosis result acquired from the database for the subject groups 3-1 to 3-5 in Comparative Example 3. In the figure, “Epirubicin”, “FAC or FEC”, “A. paclitaxel”, “A. docetaxel” and “A. Ixabepilone” are identical to “Epirubicin”, “FAC or FEC”, “A. paclitaxel”, “A. docetaxel” and “A. Ixabepilone” in FIG. 10.

The result shown in FIG. 17 reveals that the reliability of the determination result can be poor depending on the kind of population of the subject group according to the method described in Schmidt M et al. (Clinical Cancer Research, 2012, Vol. 18, p. 2695-2703), since there is a case that the minimum value in the 95% confidence interval of odds ratio regarding the determination result is less than or equal to 1. The result shown in FIG. 18 reveals that the reliability of the determination result in each of the ER-positive cases and the ER-negative cases is poorer by the method described in Schmidt M et al. (Clinical Cancer Research, 2012, Vol. 18, p. 2695-2703) than by the method according to the present embodiment using the expression level of each nucleic acid detected by the probes of (1) to (23), since the odds ratio regarding the determination result is smaller in comparison with the case where sensitivity to breast cancer neoadjuvant chemotherapy is determined by the method according to the present embodiment using an expression level of each nucleic acid detected by the probes (1) to (23). Further, the result shown in FIG. 19 reveals that the reliability of the determination result can be poor depending on the kind of the administered anticancer agent according to the method described in Schmidt M et al. (Clinical Cancer Research, 2012, Vol. 18, p. 2695-2703), since there is a case that the minimum value in the 95% confidence interval of odds ratio regarding the determination result is less than or equal to 1, also in the determination result for each data set of the subject groups classified according to the kind of the used regimen of breast cancer neoadjuvant chemotherapy.

### Comparative Example 4

Using the expression level of each gene of C1QA, XCL2, SPP1, TNFRSF17, LY9, IGLC2 and HLA-F described in Teschendorff A E et al. (Genome Biology, 2007, Vol. 8, R157) in the data of 901 cases extracted in Example 2, the presence or absence of sensitivity to breast cancer neoadjuvant chemotherapy was determined according to the method described in Teschendorff A E et al. (Genome Biology, 2007, Vol. 8, R157).

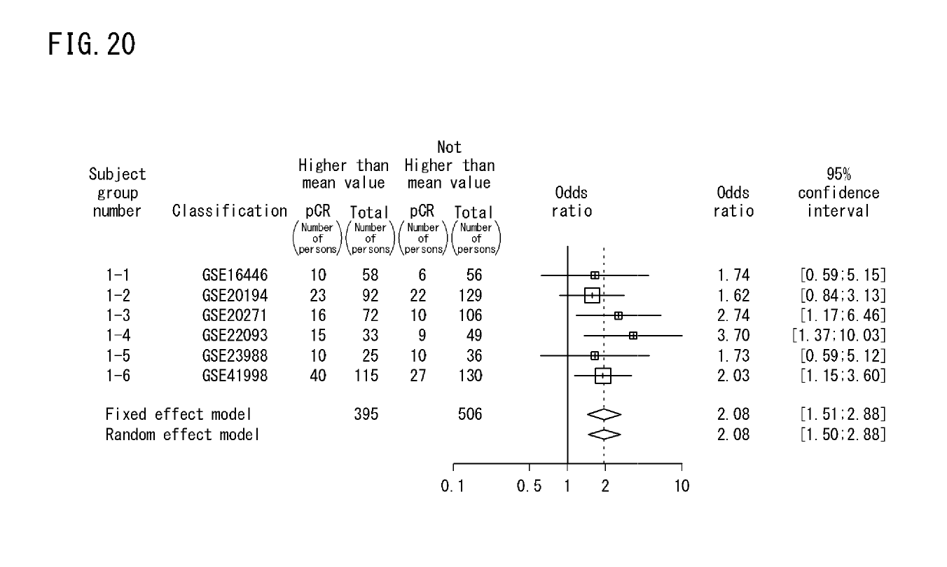

Next, for each data set of the subject groups 1-1 to 1-6, the determination result obtained according to the method described in Teschendorff A E et al. (Genome Biology, 2007, Vol. 8, R157) was compared with the pathologic diagnosis result acquired from the database, to thereby evaluate the performance of the discriminant. FIG. 20 illustrates the result of comparison between the determination result obtained according to the method described in Teschendorff A E et al. (Genome Biology, 2007, Vol. 8, R157) and the pathologic diagnosis result acquired from the database for the subject groups 1-1 to 1-6 in Comparative Example 4.

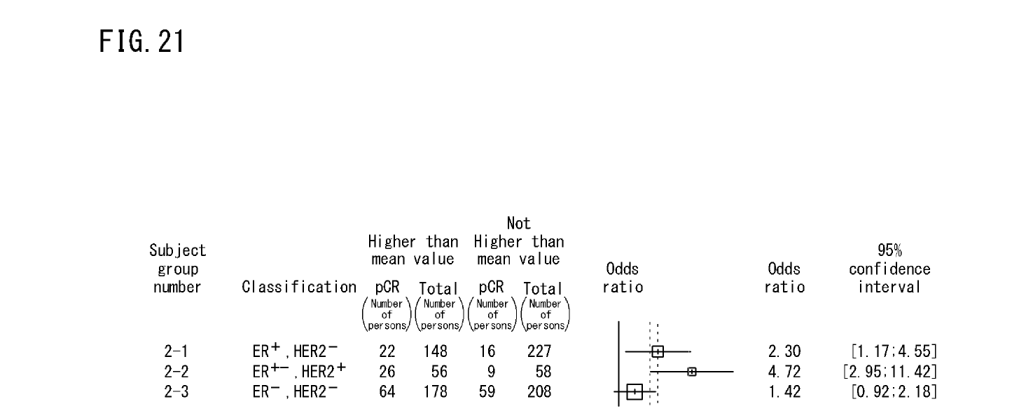

For each data set of the subject groups 2-1 to 2-3, the determination result obtained according to the method described in Teschendorff A E et al. (Genome Biology, 2007, Vol. 8, R157) was compared with the pathologic diagnosis result acquired from the database, to thereby evaluate the performance of the discriminant. FIG. 21 illustrates the result of comparison between the determination result obtained according to the method described in Teschendorff A E et al. (Genome Biology, 2007, Vol. 8, R157) and the pathologic diagnosis result acquired from the database for the subject groups 2-1 to 2-3 in Comparative Example 4.

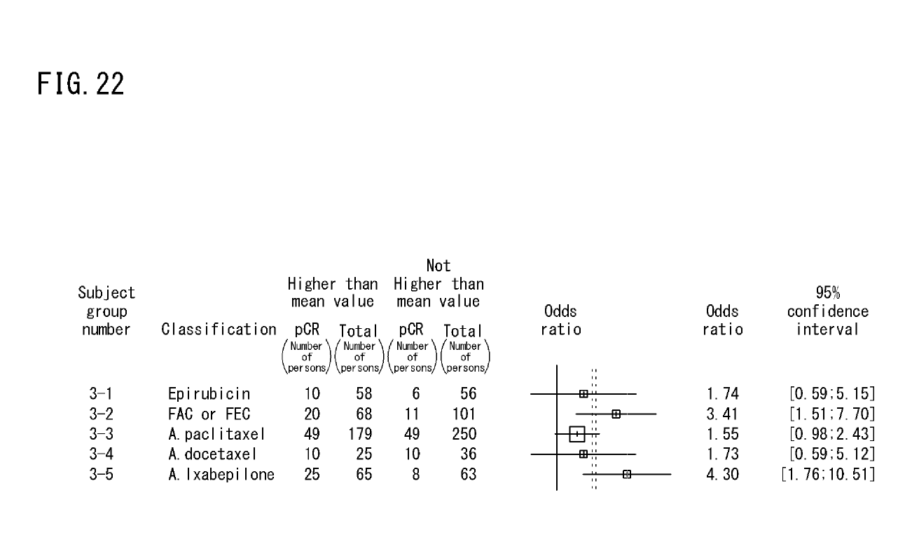

Further, for each data set of the subject groups 3-1 to 3-5, the determination result obtained according to the method described in Teschendorff A E et al. (Genome Biology, 2007, Vol. 8, R157) was compared with the pathologic diagnosis result acquired from the database, to thereby evaluate the performance of the discriminant. FIG. 22 illustrates the result of comparison between the determination result obtained according to the method described in Teschendorff A E et al. (Genome Biology, 2007, Vol. 8, R157) and the pathologic diagnosis result acquired from the database for the subject groups 3-1 to 3-5 in Comparative Example 4. In the figure, “Epirubicin”, “FAC or FEC”, “A. paclitaxel”, “A. docetaxel” and “A. Ixabepilone” are identical to “Epirubicin”, “FAC or FEC”, “A. paclitaxel”, “A. docetaxel” and “A. Ixabepilone” in FIG. 10.

The result shown in FIG. 20 reveals that the reliability of the determination result can be poor depending on the kind of population of the subject group according to the method described in Teschendorff A E et al. (Genome Biology, 2007, Vol. 8, R157), since there is a case that the minimum value in the 95% confidence interval of odds ratio regarding the determination result is less than or equal to 1. Also the result shown in FIG. 21 reveals that the method described in Teschendorff A E et al. (Genome Biology, 2007, Vol. 8, R157) is poor in reliability of the determination result in each of the ER-positive cases and the ER-negative cases, since there is a case that the minimum value in the 95% confidence interval of odds ratio regarding the determination result is less than or equal to 1, also in the determination result for each data set of the subject groups classified according to the presence or absence of each of ER and HER2. Further, the result shown in FIG. 22 reveals that according to the method described in Teschendorff A E et al. (Genome Biology, 2007, Vol. 8, R157), the reliability of the determination result can be poor depending on the kind of the administered anticancer agent, since there is a case that the minimum value in the 95% confidence interval of odds ratio regarding the determination result is less than or equal to 1, also in the determination result for each data set of the subject groups classified according to the kind of the used regimen of breast cancer neoadjuvant chemotherapy.

These results suggest that the presence or absence of sensitivity to breast cancer neoadjuvant chemotherapy can be determined more accurately irrespectively of the classification based on ER positivity and ER negativity, and the classification based on the kind of regimen of breast cancer neoadjuvant chemotherapy by using the expression level of each nucleic acid detected by the probes of (1) to (23). Therefore, the method according to the present embodiment is suited for providing information for assisting decision of adaptability to execution of breast cancer neoadjuvant chemotherapy or more appropriate information for optimizing the therapy.

### SEQUENCE LISTING FREE TEXT

SEQ ID NOs: 24 to 272 are sequences contained in probe sets.

1. A computer system adapted to determine sensitivity to breast cancer neoadjuvant chemotherapy comprising:
a processor, and
a memory, under control of said processor, including software instructions adapted to enable the computer system to perform operations comprising:
(1) acquiring an information of an expression level of each gene of (A1) to (A19) below in a measurement sample comprising RNA from a specimen collected from a subject,
(2) analyzing the expression level of the each gene acquired in the step (1), and
(3) determining sensitivity to breast cancer neoadjuvant chemotherapy on the basis of an analysis result obtained in the step (2):
(A1) human caspase recruitment domain family, member 9 (CARD9) gene,
(A2) human indoleamine-2,3-dioxygenase 1 (IDO1) gene,
(A3) human chemokine (C-X-C motif) ligand 9 (CXCL9) gene,
(A4) human purine nucleoside phosphorylase (PNP) gene,
(A5) human chemokine (C-X-C motif) ligand 11 (CXCL11) gene,
(A6) human CCAAT/enhancer binding protein (CEBPB) gene,
(A7) human CD83 gene,
(A8) human interleukin 6 signal transducer (IL6ST) gene,
(A9) human chemokine (C-X3-C) receptor 1 (CX3CR1) gene,
(A10) human CD1D gene,
(A11) human cathepsin C (CTSC) gene,
(A12) human chemokine (C-X-C motif) ligand 10 (CXCL10) gene,
(A13) human immunoglobulin heavy chain genetic locus G1 isotype (IGHG1) gene,
(A14) human zinc finger E-box-binding homeobox 1 (ZEB1) gene,
(A15) human vascular endothelial growth factor A (VEGFA) gene,
(A16) human semaphorin-3C precursor (SEMA3C) gene,
(A17) human complement receptor (CR2) gene,
(A18) human HFE gene, and
(A19) human EDA gene.

2. The system according to claim 1, wherein
the gene of the (A1) comprises a nucleic acid detected by a probe for targeting a polynucleotide having a nucleotide sequence of SEQ ID NO: 1,
the gene of the (A2) comprises a nucleic acid detected by a probe for targeting a polynucleotide having a nucleotide sequence of SEQ ID NO: 2,
the gene of the (A3) comprises a nucleic acid detected by a probe for targeting a polynucleotide having a nucleotide sequence of SEQ ID NO: 3,
the gene of the (A4) comprises a nucleic acid detected by a probe for targeting a polynucleotide having a nucleotide sequence of SEQ ID NO: 4,
the gene of the (A5) comprises a nucleic acid detected by a probe for targeting a polynucleotide having a nucleotide sequence of SEQ ID NO: 5 or SEQ ID NO: 23,
the gene of the (A6) comprises a nucleic acid detected by a probe for targeting a polynucleotide having a nucleotide sequence of SEQ ID NO: 6,
the gene of the (A7) comprises a nucleic acid detected by a probe for targeting a polynucleotide having a nucleotide sequence of SEQ ID NO: 7,
the gene of the (A8) comprises a nucleic acid detected by a probe for targeting a polynucleotide having a nucleotide sequence of SEQ ID NO: 8, SEQ ID NO: 14 or SEQ ID NO: 19,
the gene of the (A9) comprises a nucleic acid detected by a probe for targeting a polynucleotide having a nucleotide sequence of SEQ ID NO: 9,
the gene of the (A10) comprises a nucleic acid detected by a probe for targeting a polynucleotide having a nucleotide sequence of SEQ ID NO: 10,
the gene of the (A11) comprises a nucleic acid detected by a probe for targeting a polynucleotide having a nucleotide sequence of SEQ ID NO: 11,
the gene of the (A12) comprises a nucleic acid detected by a probe for targeting a polynucleotide having a nucleotide sequence of SEQ ID NO: 12,
the gene of the (A13) comprises a nucleic acid detected by a probe for targeting a polynucleotide having a nucleotide sequence of SEQ ID NO: 13,
the gene of the (A14) comprises a nucleic acid detected by a probe for targeting a polynucleotide having a nucleotide sequence of SEQ ID NO: 15 or SEQ ID NO: 22,
the gene of the (A15) comprises a nucleic acid detected by a probe for targeting a polynucleotide having a nucleotide sequence of SEQ ID NO: 16,
the gene of the (A16) comprises a nucleic acid detected by a probe for targeting a polynucleotide having a nucleotide sequence of SEQ ID NO: 17,
the gene of the (A17) comprises a nucleic acid detected by a probe for targeting a polynucleotide having a nucleotide sequence of SEQ ID NO: 18,
the gene of the (A18) comprises a nucleic acid detected by a probe for targeting a polynucleotide having a nucleotide sequence of SEQ ID NO: 20, and
the gene of the (A19) comprises a nucleic acid detected by a probe for targeting a polynucleotide having a nucleotide sequence of SEQ ID NO: 21.

3. The system according to claim 2, wherein the memory comprises a discriminant and a determination criterion,
the discriminant being a discriminant represented by formula (I):
D=Σᵢ(wᵢ×yᵢ)−3.327217 (I)
(wherein, i represents a number assigned to each nucleic acid shown in Table A so as to correspond to SEQ ID NO of the targeted polynucleotide, wᵢ represents a weighting factor of nucleic acid of number i shown in Table A, yᵢ represents a standardized expression level of nucleic acid, the standardized expression level being obtained by standardizing an expression level of nucleic acid according to the formula represented by formula (II):
yᵢ=xᵢ−mᵢ (II)
(wherein, xᵢ represents an expression level of nucleic acid of number i shown in Table A, and mᵢ represents a mean value of expression level of nucleic acid of number i shown in Table A over the specimens), and Σᵢ represents a sum total over the respective nucleic acids),
the determination criterion being a criterion for determining the presence or absence of sensitivity to breast cancer neoadjuvant chemotherapy according to whether solution D of the discriminant is a positive value or the solution D is 0 or a negative value;
wherein the processor calculates solution D of the discriminant, and determines the presence or absence of sensitivity to breast cancer neoadjuvant chemotherapy on the basis of solution D of the discriminant and the determination criterion.
TABLE A

| Number i of | SEQ ID NO of targeted | Weighting |
|---|---|---|
| nucleic acid | polynucleotide | factor |
| 1 | 1 | 2.361579818 |
| 2 | 2 | 0.527535817 |
| 3 | 3 | 0.53572137 |
| 4 | 4 | 1.296736029 |
| 5 | 5 | 0.437766376 |
| 6 | 6 | 1.09614395 |
| 7 | 7 | 1.154132786 |
| 8 | 8 | −0.997955474 |
| 9 | 9 | −0.84645569 |
| 10 | 10 | 0.703499669 |
| 11 | 11 | 1.262066324 |
| 12 | 12 | 0.481709248 |
| 13 | 13 | 0.784677171 |
| 14 | 14 | −1.056130291 |
| 15 | 15 | −0.90152985 |
| 16 | 16 | 0.941011796 |
| 17 | 17 | −0.580145259 |
| 18 | 18 | 0.797198448 |
| 19 | 19 | −0.963860205 |
| 20 | 20 | −1.352304026 |
| 21 | 21 | −1.231365097 |
| 22 | 22 | −0.637818166 |
| 23 | 23 | 0.449217729 |

4. The system according to claim 3, wherein
the determination criterion is a criterion for making a determination of being sensitive to breast cancer neoadjuvant chemotherapy when solution D of the discriminant is a positive value, and making a determination of being insensitive to breast cancer neoadjuvant chemotherapy when solution D is zero or a negative value, and
the determination section makes a determination of being sensitive to breast cancer neoadjuvant chemotherapy when solution D of the discriminant calculated in the calculation section is a positive value, and makes a determination of being insensitive to breast cancer neoadjuvant chemotherapy when solution D is zero or a negative value, on the basis of solution D of the discriminant calculated by the calculation section, and the determination criterion stored in the storage section.

5. An apparatus for determining sensitivity to breast cancer neoadjuvant chemotherapy, comprising:
an acquiring section for acquiring information of an expression level of each gene of (A1) to (A19) below in a measurement sample comprising RNA prepared from a specimen collected from a subject;
a determination section for determining sensitivity to breast cancer neoadjuvant chemotherapy based on information of an expression level of each gene, the information being acquired by the acquiring section; and
an output section for outputting a determination result generated by the determination section:
(A1) human caspase recruitment domain family, member 9 (CARD9) gene,
(A2) human indoleamine-2,3-dioxygenase 1 (IDO1) gene,
(A3) human chemokine (C-X-C motif) ligand 9 (CXCL9) gene,
(A4) human purine nucleoside phosphorylase (PNP) gene,
(A5) human chemokine (C-X-C motif) ligand 11 (CXCL11) gene,
(A6) human CCAAT/enhancer binding protein (CEBPB) gene,
(A7) human CD83 gene,
(A8) human interleukin 6 signal transducer (IL6ST) gene,
(A9) human chemokine (C-X3-C) receptor 1 (CX3CR1) gene,
(A10) human CD1D gene,
(A11) human cathepsin C (CTSC) gene,
(A12) human chemokine (C-X-C motif) ligand 10 (CXCL10) gene,
(A13) human immunoglobulin heavy chain genetic locus G1 isotype (IGHG1) gene,
(A14) human zinc finger E-box-binding homeobox 1 (ZEB1) gene,
(A15) human vascular endothelial growth factor A (VEGFA) gene,
(A16) human semaphorin-3C precursor (SEMA3C) gene,
(A17) human complement receptor (CR2) gene,
(A18) human HFE gene, and
(A19) human EDA gene.

6. The apparatus according to claim 5, further comprising:
a measurement part for measuring an expression level of each gene of the (A1) to (A19) in a measurement sample comprising RNA prepared from a specimen collected from a subject, thereby giving information of the expression level,
wherein the acquiring section acquires the information of the expression level obtained in the measurement part.

7. The apparatus according to claim 6, wherein the measurement part includes a microarray scanner.

8. The apparatus according to claim 6, wherein the measurement part includes a nucleic acid amplification detecting part.

9. The apparatus according to claim 5, further comprising:
a calculation section for analyzing information of the expression level acquired in the acquiring section by a classification technique,
the determination section determining the sensitivity on the basis of a calculation result obtained in the calculation section.

10. The apparatus according to claim 5, wherein
the gene of the (A1) comprises a nucleic acid detected by a probe for targeting a polynucleotide having a nucleotide sequence of SEQ ID NO: 1,
the gene of the (A2) comprises a nucleic acid detected by a probe for targeting a polynucleotide having a nucleotide sequence of SEQ ID NO: 2,
the gene of the (A3) comprises a nucleic acid detected by a probe for targeting a polynucleotide having a nucleotide sequence of SEQ ID NO: 3,
the gene of the (A4) comprises a nucleic acid detected by a probe for targeting a polynucleotide having a nucleotide sequence of SEQ ID NO: 4,
the gene of the (A5) comprises a nucleic acid detected by a probe for targeting a polynucleotide having a nucleotide sequence of SEQ ID NO: 5 or SEQ ID NO: 23,
the gene of the (AG) comprises a nucleic acid detected by a probe for targeting a polynucleotide having a nucleotide sequence of SEQ ID NO: 6,
the gene of the (A7) comprises a nucleic acid detected by a probe for targeting a polynucleotide having a nucleotide sequence of SEQ ID NO: 7,
the gene of the (A8) comprises a nucleic acid detected by a probe for targeting a polynucleotide having a nucleotide sequence of SEQ ID NO: 8, SEQ ID NO: 14 or SEQ ID NO: 19,
the gene of the (A9) comprises a nucleic acid detected by a probe for targeting a polynucleotide having a nucleotide sequence of SEQ ID NO: 9,
the gene of the (A10) comprises a nucleic acid detected by a probe for targeting a polynucleotide having a nucleotide sequence of SEQ ID NO: 10,
the gene of the (A11) comprises a nucleic acid detected by a probe for targeting a polynucleotide having a nucleotide sequence of SEQ ID NO: 11,
the gene of the (A12) comprises a nucleic acid detected by a probe for targeting a polynucleotide having a nucleotide sequence of SEQ ID NO: 12,
the gene of the (A13) comprises a nucleic acid detected by a probe for targeting a polynucleotide having a nucleotide sequence of SEQ ID NO: 13,
the gene of the (A14) comprises a nucleic acid detected by a probe for targeting a polynucleotide having a nucleotide sequence of SEQ ID NO: 15 or SEQ ID NO: 22,
the gene of the (A15) comprises a nucleic acid detected by a probe for targeting a polynucleotide having a nucleotide sequence of SEQ ID NO: 16,
the gene of the (A16) comprises a nucleic acid detected by a probe for targeting a polynucleotide having a nucleotide sequence of SEQ ID NO: 17,
the gene of the (A17) comprises a nucleic acid detected by a probe for targeting a polynucleotide having a nucleotide sequence of SEQ ID NO: 18,
the gene of the (A18) comprises a nucleic acid detected by a probe for targeting a polynucleotide having a nucleotide sequence of SEQ ID NO: 20, and
the gene of the (A19) comprises a nucleic acid detected by a probe for targeting a polynucleotide having a nucleotide sequence of SEQ ID NO: 21.

11. The apparatus according to claim 9, further comprising a storage section for storing a discriminant and a determination criterion,
the discriminant being a discriminant represented by formula (I):
D=Σᵢ(wᵢ×yᵢ)−3.327217 (I)
(wherein, i represents a number assigned to each nucleic acid shown in Table A so as to correspond to SEQ ID NO of the targeted polynucleotide, wᵢ represents a weighting factor of nucleic acid of number i shown in Table A, yᵢ represents a standardized expression level of nucleic acid, the standardized expression level being obtained by standardizing an expression level of nucleic acid according to the formula represented by formula (II):
yᵢ=xᵢ−mᵢ (II)
(wherein, xᵢ represents an expression level of nucleic acid of number i shown in Table A, and mᵢ represents a mean value of expression level of nucleic acid of number i shown in Table A over the specimens), and Σᵢ represents a sum total over the respective nucleic acids),
the determination criterion being a criterion for determining the presence or absence of sensitivity to breast cancer neoadjuvant chemotherapy according to whether solution D of the discriminant is a positive value or the solution D is 0 or a negative value;
wherein the calculation section calculates solution D of the discriminant, and
wherein the determination section determines the presence or absence of sensitivity to breast cancer neoadjuvant chemotherapy on the basis of solution D of the discriminant calculated by the calculation section, and the determination criterion stored in the storage section.
TABLE A

| Number i of | SEQ ID NO of targeted | Weighting |
|---|---|---|
| nucleic acid | polynucleotide | factor |
| 1 | 1 | 2.361579818 |
| 2 | 2 | 0.527535817 |
| 3 | 3 | 0.53572137 |
| 4 | 4 | 1.296736029 |
| 5 | 5 | 0.437766376 |
| 6 | 6 | 1.09614395 |
| 7 | 7 | 1.154132786 |
| 8 | 8 | −0.997955474 |
| 9 | 9 | −0.84645569 |
| 10 | 10 | 0.703499669 |
| 11 | 11 | 1.262066324 |
| 12 | 12 | 0.481709248 |
| 13 | 13 | 0.784677171 |
| 14 | 14 | −1.056130291 |
| 15 | 15 | −0.90152985 |
| 16 | 16 | 0.941011796 |
| 17 | 17 | −0.580145259 |
| 18 | 18 | 0.797198448 |
| 19 | 19 | −0.963860205 |
| 20 | 20 | −1.352304026 |
| 21 | 21 | −1.231365097 |
| 22 | 22 | −0.637818166 |
| 23 | 23 | 0.449217729 |

12. The apparatus according to claim 11, wherein
the determination criterion is a criterion for making a determination of being sensitive to breast cancer neoadjuvant chemotherapy when solution D of the discriminant is a positive value, and making a determination of being insensitive to breast cancer neoadjuvant chemotherapy when solution D is zero or a negative value, and
the determination section makes a determination of being sensitive to breast cancer neoadjuvant chemotherapy when solution D of the discriminant calculated in the calculation section is a positive value, and makes a determination of being insensitive to breast cancer neoadjuvant chemotherapy when solution D is zero or a negative value, on the basis of solution D of the discriminant calculated by the calculation section, and the determination criterion stored in the storage section.

13. An apparatus for determining sensitivity to breast cancer neoadjuvant chemotherapy, comprising:
an acquiring section for acquiring information of an expression level of each nucleic acid detected by probes of (B1) to (B23) below in a measurement sample comprising RNA prepared from a specimen collected from a subject;
a determination section for determining sensitivity to breast cancer neoadjuvant chemotherapy on the basis of information of an expression level of each nucleic acid acquired by the acquiring section; and
an output section for outputting a determination result generated by the determination section:
(B1) a probe for targeting a polynucleotide having a nucleotide sequence of SEQ ID NO: 1,
(B2) a probe for targeting a polynucleotide having a nucleotide sequence of SEQ ID NO: 2,
(B3) a probe for targeting a polynucleotide having a nucleotide sequence of SEQ ID NO: 3,
(B4) a probe for targeting a polynucleotide having a nucleotide sequence of SEQ ID NO: 4,
(B5) a probe for targeting a polynucleotide having a nucleotide sequence of SEQ ID NO: 5,
(B6) a probe for targeting a polynucleotide having a nucleotide sequence of SEQ ID NO: 6,
(B7) a probe for targeting a polynucleotide having a nucleotide sequence of SEQ ID NO: 7,
(B8) a probe for targeting a polynucleotide having a nucleotide sequence of SEQ ID NO: 8,
(B9) a probe for targeting a polynucleotide having a nucleotide sequence of SEQ ID NO: 9,
(B10) a probe for targeting a polynucleotide having a nucleotide sequence of SEQ ID NO: 10,
(B11) a probe for targeting a polynucleotide having a nucleotide sequence of SEQ ID NO: 11,
(B12) a probe for targeting a polynucleotide having a nucleotide sequence of SEQ ID NO: 12,
(B13) a probe for targeting a polynucleotide having a nucleotide sequence of SEQ ID NO: 13,
(B14) a probe for targeting a polynucleotide having a nucleotide sequence of SEQ ID NO: 14,
(B15) a probe for targeting a polynucleotide having a nucleotide sequence of SEQ ID NO: 15,
(B16) a probe for targeting a polynucleotide having a nucleotide sequence of SEQ ID NO: 16,
(B17) a probe for targeting a polynucleotide having a nucleotide sequence of SEQ ID NO: 17,
(B18) a probe for targeting a polynucleotide having a nucleotide sequence of SEQ ID NO: 18,
(B19) a probe for targeting a polynucleotide having a nucleotide sequence of SEQ ID NO: 19,
(B20) a probe for targeting a polynucleotide having a nucleotide sequence of SEQ ID NO: 20,
(B21) a probe for targeting a polynucleotide having a nucleotide sequence of SEQ ID NO: 21,
(B22) a probe for targeting a polynucleotide having a nucleotide sequence of SEQ ID NO: 22, and
(B23) a probe for targeting a polynucleotide having a nucleotide sequence of SEQ ID NO: 23.

14. The apparatus according to claim 13, further comprising:
a measurement part for measuring an expression level of the each gene in a measurement sample comprising RNA prepared from a specimen collected from a subject, thereby giving information of the expression level,
wherein the acquiring section acquires the information of the expression level obtained in the measurement part.

15. The apparatus according to claim 14, wherein the measurement part is a device for measuring an expression level of the each nucleic acid using a probe set shown in Table B.
TABLE B

| SEQ ID NO of targeted | SEQ ID NO of |
|---|---|
| polynucleotide | probe |
| 1 | 24~34 |
| 2 | 35~45 |
| 3 | 46~56 |
| 4 | 57~67 |
| 5 | 68~78 |
| 6 | 79~89 |
| 7 | 90~100 |
| 8 | 101~111 |
| 9 | 112~122 |
| 10 | 123~133 |
| 11 | 134~144 |
| 12 | 145~155 |
| 13 | 156~166 |
| 14 | 167~177 |
| 15 | 178~188 |
| 16 | 189~199 |
| 17 | 200~210 |
| 18 | 211~221 |
| 19 | 222~232 |
| 20 | 233~243 |
| 21 | 244~254 |
| 22 | 255~265 |
| 23 | 266~276 |

16. The apparatus according to claim 15, wherein the measurement part includes a microarray scanner.

17. The apparatus according to claim 15, wherein the measurement part includes a nucleic acid amplification detecting part.

18. The apparatus according to claim 15, further comprising:
a calculation section for analyzing information of the expression level obtained in the acquiring section with a use of a classification technique,
wherein the determination section determines the sensitivity on the basis of a calculation result obtained in the calculation section.

19. The apparatus according to claim 18, further comprising a storage section for storing a discriminant and a determination criterion,
the discriminant being a discriminant represented by formula (I):
D=Σᵢ(wᵢ×yᵢ)−3.327217 (I)
(wherein, i represents a number assigned to each nucleic acid shown in Table A so as to correspond to SEQ ID NO of the targeted polynucleotide, wᵢ represents a weighting factor of nucleic acid of number i shown in Table A, yᵢ represents a standardized expression level of nucleic acid, the standardized expression level being obtained by standardizing an expression level of nucleic acid according to the formula represented by formula (II):
yᵢ=xᵢ−mᵢ (II)
(wherein, xᵢ represents an expression level of nucleic acid of number i shown in Table A, and mᵢ represents a mean value of expression level of nucleic acid of number i shown in Table A over the specimens), and Σᵢ represents a sum total over the respective nucleic acids),
the determination criterion being a criterion for determining the presence or absence of sensitivity to breast cancer neoadjuvant chemotherapy according to whether solution D of the discriminant is a positive value or the solution D is 0 or a negative value;
wherein the calculation section calculates solution D of the discriminant, and
wherein the determination section determines the presence or absence of sensitivity to breast cancer neoadjuvant chemotherapy on the basis of solution D of the discriminant calculated by the calculation section, and the determination criterion stored in the storage section.
TABLE A

| Number i of | SEQ ID NO of targeted | Weighting |
|---|---|---|
| nucleic acid | polynucleotide | factor |
| 1 | 1 | 2.361579818 |
| 2 | 2 | 0.527535817 |
| 3 | 3 | 0.53572137 |
| 4 | 4 | 1.296736029 |
| 5 | 5 | 0.437766376 |
| 6 | 6 | 1.09614395 |
| 7 | 7 | 1.154132786 |
| 8 | 8 | −0.997955474 |
| 9 | 9 | −0.84645569 |
| 10 | 10 | 0.703499669 |
| 11 | 11 | 1.262066324 |
| 12 | 12 | 0.481709248 |
| 13 | 13 | 0.784677171 |
| 14 | 14 | −1.056130291 |
| 15 | 15 | −0.90152985 |
| 16 | 16 | 0.941011796 |
| 17 | 17 | −0.580145259 |
| 18 | 18 | 0.797198448 |
| 19 | 19 | −0.963860205 |
| 20 | 20 | −1.352304026 |
| 21 | 21 | −1.231365097 |
| 22 | 22 | −0.637818166 |
| 23 | 23 | 0.449217729 |

20. The apparatus according to claim 19, wherein
the determination criterion is a criterion for making a determination of being sensitive to breast cancer neoadjuvant chemotherapy when solution D of the discriminant is a positive value, and a determination of being insensitive to breast cancer neoadjuvant chemotherapy when solution D is zero or a negative value, and
the determination section makes a determination of being sensitive to breast cancer neoadjuvant chemotherapy when solution D of the discriminant calculated in the calculation section is a positive value, and makes a determination of being insensitive to breast cancer neoadjuvant chemotherapy when the solution D is zero or a negative value, on the basis of solution D of the discriminant calculated by the calculation section, and the determination criterion stored in the storage section.


SEQUENCE LISTING (276 sequences)

SEQ ID NO: 1 - DNA, 473 bp, Homo sapiens
agctctcagacaaaggctgccttgccggcggggggagcccgaaacagccctttgcagctctgcaccaggagcaggttttgcggaacccccatgacgcaggcctgagcagcggggagccgcccgagaaggagcggcggcgcctcaaagagagttttgagaactaccgcaggaagcgcgccctcaggaagatgcagaaaggatggcggcagggggaggaggaccgggagaacaccacgggcagcgacaacaccgacactgagggctcctagccgcagcagacttccccgagccgtcgctgacttggcctggaacgaggaatctggtgccctgaaaggcccagccggactgccgggcattggggccgtttgttaagcggcactcattttgcggaggccatgcgggtgctcaccacccccatgcacacgccatctgtgtaacttcaggatctgttctgtttcaccatgtaacacaca

SEQ ID NO: 2 - DNA, 398 bp, Homo sapiens
acccccagctatcagacggtctggtgtatgaagggttctgggaagacccaaaggagtttgcagggggcagtgcaggccaaagcagcgtctttcagtgctttgacgtcctgctgggcatccagcagactgctggtggaggacatgctgctcagttcctccaggacatgagaagatatatgccaccagctcacaggaacttcctgtgctcattagagtcaaatccctcagtccgtgagtttgtcctttcaaaaggtgatgctggcctgcgggaagcttatgacgcctgtgtgaaagctctggtctccctgaggagctaccatctgcaaatcgtgactaagtacatcctgattcctgcaagccagcagccaaaggagaataagacctctgaagacccttca

SEQ ID NO: 3 - DNA, 367 bp, Homo sapiens
gattatcaattaccacaccatctcccatgaagaaagggaacggtgaagtactaagcgctagaggaagcagccaagtcggttagtggaagcatgattggtgcccagttagcctctgcaggatgtggaaacctccttccaggggaggttcagtgaattgtgtaggagaggttgtctgtggccagaatttaaacctatactcactttcccaaattgaatcactgctcacactgctgatgatttagagtgctgtccggtggagatcccacccgaacgtcttatctaatcatgaaactccctagttccttcatgtaacttccctgaaaaatctaagtgtttcataaatttgagagtctgtgacccacttacc

SEQ ID NO: 4 - DNA, 548 bp, Homo sapiens
gcttctcactcatcactaacaaggtcatcatggattatgaaagcctggagaaggccaaccatgaagaagtcttagcagctggcaaacaagctgcacagaaattggaacagtttgtctccattcttatggccagcattccactccctgacaaagccagttgacctgccttggagtcgtctggcatctcccacacaagacccaagtagctgctaccttctttggccccttgctggagtcatgtgcctctgtccttaggttgtagcagaaaggaaaagattcctgtccttcacctttcccactttcttctaccagacccttctggtgccagatcctcttctcaaagctgggattacaggtgtgagcatagtgagaccttggcgctacaaaataaagctgttctcattcctgttctttcttacacaagagctggagcccgtgccctaccacacatctgtggagatgcccaggatttgactcgggccttagaactttgcatagcagctgctactagctctttgagataatacattccgaggggctcagttctg

SEQ ID NO: 5 - DNA, 416 bp, Homo sapiens
gagacttttctatggttttgtgactttcaacttttgtacagttatgtgaaggatgaaaggtgggtgaaaggaccaaaaacagaaatacagtcttcctgaatgaatgacaatcagaattccactgcccaaaggagtccaacaattaaatggatttctaggaaaagctaccttaagaaaggctggttaccatcggagtttacaaagtgctttcacgttcttacttgttgtattatacattcatgcatttctaggctagagaaccttctagatttgatgcttacaactattctgttgtgactatgagaacatttctgtctctagaagttatctgtctgtattgatctttatgctatattactatctgtggttacagtggagacattgacattattactggagtcaagcccttataagtc

SEQ ID NO: 6 - DNA, 369 bp, Homo sapiens
cgccggcaaaactttggcactggggcacttggcagcgcggggagcccgtcggtaattttaatattttattatatatatatatctatatttttgtccaaaccaaccgcacatgcagatggggctcccgcccgtggtgttatttaaagaagaaacgtctatgtgtacagatgaatgataaactctctgcttctccctctgcccctctccaggcgccggcgggcgggccggtttcgaagttgatgcaatcggtttaaacatggctgaacgcgtgtgtacacgggactgacgcaacccacgtgtaactgtcagccgggccctgagtaatcgcttaaagatgttcctacgggcttgttgctgttgatgttttgt

SEQ ID NO: 7 - DNA, 547 bp, Homo sapiens
tccatttctcatgttttccattgtttgaaacaaagaaggttaccaagaagcctttcctgtagccttctgtaggaattcttttggggaagtgaggaagccaggtccacggtctgttcttgaagcagtagcctaacacactccaagatatggacacacgggagccgctggcagaagggacttcacgaagtgttgcatggatgttttagccattgttggctttcccttatcaaacttgggcccttcccttcttggtttccaaaggcatttattgctgagttatatgttcactgtccccctaatattagggagtaaaacggataccaagttgatttagtgtttttacctctgtcttggctttcatgttattaaacgtatgcatgtgaagaagggtgtttttctgttttatattcaactcataagactttgggataggaaaaatgagtaatggttactaggcttaatacctgggtgattacataatctgtacaacgaacccccatgatgtaagtttacctatgtaacaaacctgcacttatacccatgaact

SEQ ID NO: 8 - DNA, 534 bp, Homo sapiens
aacacttcgagcactgtccagtattctaccgtggtacacagtggctacagacaccaagttccgtcagtccaagtcttctcaagatccgagtctacccagcccttgttagattcagaggagcggccagaagatctacaattagtagatcatgtagatggcggtgatggtattttgcccaggcaacagtacttcaaacagaactgcagtcagcatgaatccagtccagatatttcacattttgaaaggtcaaagcaagtttcatcagtcaatgaggaagattttgttagacttaaacagcagatttcagatcatatttcacaatcctgtggatctgggcaaatgaaaatgtttcaggaagtttctgcagcagatgcttttggtccaggtactgagggacaagtagaaagatttgaaacagttggcatggaggctgcgactgatgaaggcatgcctaaaagttacttaccacagactgtacggcaaggcggctacatgcctcagtgaaggactagtagttcctgctacaacttcagc

SEQ ID NO: 9 - DNA, 503 bp, Homo sapiens
agcccctgcccatctgggaaaataccccatcattcatgctactgccaacctggggagccagggctatgggagcagcttttttttcccccctagaaacgtttggaacaatgtaaaactttaaagctcgaaaacaattgtaataatgctaaagaaaaagtcatccaatctaaccacatcaatattgtcattcctgtattcacccgtccagaccttgttcacactctcacatgtttagagttgcaatcgtaatgtacagatggttttataatctgatttgttttcctcttaacgttagaccacaaatagtgctcgctttctatgtagtttggtaattatcattttagaagactctaccagactgtgtattcattgaagtcagatgtggtaactgttaaattgctgtgtatctgatagctctttggcagtctatatgtttgtataatgaatgagagaataagtcatgttccttcaagatcatgtaccccaatttacttgccattact

SEQ ID NO: 10 - DNA, 462 bp, Homo sapiens
gtcatgaggcagctttcatcacacccttttaacatttatctaaaagaatttaaattctttttcaaaaattacactacaagtttataagcccaaatggctctgtgaaatcagaagtgcaaaggtgtgcaaacttgtatctgaagacctaccagggacaagcaggtaagagctgatgtgagtgtgtgtgatgggatctgtaaggaactggaacacacatgtcctatccaaaggaatcagctgcagctgcttgttgtcaagtataaagtcaggacctggcttggctttaaccgtttttcaagaaaactggaaatctggattttcagcgaacatgcctgattttaaaaggttgactcaagtttttacaaaatactatgtgggacacctcaaatacatacctactgactgatgacaaacccaggagtttgtgtgtcttttataaaaagtttgccctggatgtcatat

SEQ ID NO: 11 - DNA, 334 bp, Homo sapiens
gactcagcctctgggatggattactggattgttaaaaacagctggggcaccggctggggtgagaatggctacttccggatccgcagaggaactgatgagtgtgcaattgagagcatagcagtggcagccacaccaattcctaaattgtagggtatgccttccagtatttcataatgatctgcatcagttgtaaaggggaattggtatattcacagactgtagactttcagcagcaatctcagaagcttacaaatagatttccatgaagatatttgtcttcagaattaaaactgcccttaattttaatatacctttcaatcggccactggccatt

SEQ ID NO: 12 - DNA, 544 bp, Homo sapiens
taactctaccctggcactataatgtaagctctactgaggtgctatgttcttagtggatgttctgaccctgcttcaaatatttccctcacctttcccatcttccaagggtactaaggaatctttctgctttggggtttatcagaattctcagaatctcaaataactaaaaggtatgcaatcaaatctgctttttaaagaatgctctttacttcatggacttccactgccatcctcccaaggggcccaaattctttcagtggctacctacatacaattccaaacacatacaggaaggtagaaatatctgaaaatgtatgtgtaagtattcttatttaatgaaagactgtacaaagtataagtcttagatgtatatatttcctatattgttttcagtgtacatggaataacatgtaattaagtactatgtatcaatgagtaacaggaaaattttaaaaatacagatagatatatgctctgcatgttacataagataaatgtgctgaatggttttcaaataaaaatgaggtactctcctggaaatatt

SEQ ID NO: 13 - DNA, 212 bp, Homo sapiens
gcttctggaggcaccttcagaaattatagtctcaactgcgtgcgacaggcccctggacaagggcttgagtggatgggagggatcgtccctatctttggtacatcaaactacacacaaaagttccaggggagagtcacgattaccgcggacttatccaccagcacagcctacatggagctgaacagcctgagatctgaggacacggccatgca

SEQ ID NO: 14 - DNA, 404 bp, Homo sapiens
aagcaccctgtatcacagactggcaacaagaagatggtaccgtgcatcgcacctatttaagagggaacttagcagagagcaaatgctatttgataacagttactccagtatatgctgatggaccaggaagccctgaatccataaaggcataccttaaacaagctccaccttccaaaggacctactgttcggacaaaaaaagtagggaaaaacgaagctgtcttagagtgggaccaacttcctgttgatgttcagaatggatttatcagaaattatactatattttatagaaccatcattggaaatgaaactgctgtgaatgtggattcttcccacacagaatatacattgtcctctttgactagtgacacattgtacatggtacgaatggcagcatacacagat

SEQ ID NO: 15 - DNA, 539 bp, Homo sapiens
aggactcaagacatctcagtgttcttcaccgtctctttcagcatcaccaggcagtcccacacgaccacagatacggcaaaagatagagaataaaccccttcaagaacaactttctgttaaccaaattaaaactgaacctgtggattatgaattcaaacccatagtggttgcttcaggaatcaactgttcaacccctttacaaaatggggttttcactggtggtggcccattacaggcaaccagttctcctcagggcatggtgcaagctgttgttctgccaacagttggtttggtgtctcccataagtatcaatttaagtgatattcagaatgtacttaaagtggcggtagatggtaatgtaataaggcaagtgttggagaataatcaagccaatcttgcatccaaagaacaagaaacaatcaatgcttcacccatacaacaaggtggccattctgttatttcagccatcagtcttcctttggttgatcaagatggaacaaccaaaattatcatcaactacagtcttgagcagcctagcc

SEQ ID NO: 16 - DNA, 511 bp, Homo sapiens
atgagatgtatcttttgctctctcttgctctcttatttgtaccggtttttgtatataaaattcatgtttccaatctctctctccctgatcggtgacagtcactagcttatcttgaacagatatttaattttgctaacactcagctctgccctccccgatcccctggctccccagcacacattcctttgaaagagggtttcaatatacatctacatactatatatatattgggcaacttgtatttgtgtgtatatatatatatatatgtttatgtatatatgtgatcctgaaaaaataaacatcgctattctgttttttatatgttcaaaccaaacaagaaaaaatagagaattctacatactaaatctctctccttttttaattttaatatttgttatcatttatttattggtgctactgtttatccgtaataattgtggggaaaagatattaacatcacgtctttgtctctagtgcagtttttcgagatattccgtagtacatatttatt

SEQ ID NO: 17 - DNA, 552 bp, Homo sapiens
aaagacactcggcagcaacatcagcagggagatgaatcacagaaaatgagaggggactatggcaagttaaaggccctcatcaatagtcggaaaagtagaaacaggaggaatcagttgccagagtcataatattttcttatgtgggtcttatgcttccattaacaaatgctctgtcttcaatgatcaaattttgagcaaagaaacttgtgctttaccaaggggaattactgaaaaaggtgattactcctgaagtgagttttacacgaactgaaatgagcatgcattttcttgtatgatagtgactagcactagacatgtcatggtcctcatggtgcatataaatatatttaacttaacccagattttatttatatctttattcaccttttcttcaaaatcgatatggtggctgcaaaactagaattgttgcatccctcaattgaatgagggccatatccctgtggtattcctttcctgctttggggctttagaattctaattgtcagtgattttgtatatgaaaacaagttccaaatccacagcttttacgta

SEQ ID NO: 18 - DNA, 505 bp, Homo sapiens
agcccagtttcactgccatatactcttcaaggactttctgaagcctcacttatgagatgcctgaagccaggccatggctataaacaattacatggctctaaaaagttttgccctttttaaggaaggcactaaaaagagctgtcctggtatctagacccatcttctttttgaaatcagcatactcaatgttactatctgcttttggttataatgtgtttttaattatctaaagtatgaagcattttctggggttatgatggccttacctttattaggaagtatggttttattttgatagtagcttcctcctctggtggtgttaatcatttcatttttacccttactgtttgagtttctctcacattactgtatatactttgcctttccataatcactcagtgattgcaatttgcacaagtttttttaaattatgggaatcaagatttaatcctagagatttggtgtacaattcaggctttggatgtttctttagcagttttgtgat

SEQ ID NO: 19 - DNA, 285 bp, Homo sapiens
aagccatagtcgtgcctgtttgcttagcattcctattgacaactcttctgggagtgctgttctgctttaataagcgagacctaattaaaaaacacatctggcctaatgttccagatccttcaaagagtcatattgcccagtggtcacctcacactcctccaaggcacaattttaattcaaaagatcaaatgtattcagatggcaatttcactgatgtaagtgttgtggaaatagaagcaaatgacaaaaagccttttccagaagatctgaaatcattggacctgt

SEQ ID NO: 20 - DNA, 519 bp, Homo sapiens
ggcatctcctgagcctaggcaatacctgtagggtgacttctggagccatccccgtttccccgccccccaaaagaagcggagatttaacggggacgtgcggccagagctggggaaatgggcccgcgagccaggccggcgcttctcctcctgatgcttttgcagaccgcggtcctgcaggggcgcttgctgcgttcacactctctgcactacctcttcatgggtgcctcagagcaggaccttggtctttccttgtttgaagctttgggctacgtggatgaccagctgttcgtgttctatgatcatgagagtcaccgtgtggagccccgaactccatgggtttccagtagaatttcaagccagatgtggctgcagctgagtcagagtctgcccagccgtcaaaagagtcttcctatatatatccagatggcatgtgtttactttatgttactacatgcacttggctgcataaatgtggtacaagcattctgtcttgaagggcaggtgcttcaggataccata

SEQ ID NO: 21 - DNA, 491 bp, Homo sapiens
tccaggctggaagtacttggcccccttcaggagcctggccaggcagggagagagtagctgcagccttcatcagaactcttcctcctcccaaggcattctcccagctctagcctctggactggaaagcacaagactggcccagtgccagcaagtccttaggctactgtaatgctgcctcaggacccatccctgcctggaggctcctctaggccctgtgagcacaaagaagaaagctgatttttgtcttttaatccatttcaggactctctccaggagggctcggggtgtgtcatttctatattcctccagctgggattggggggtgggctttgttgtgagaatggcctggagcaggcccaatgctgcttttgggggtcagcatccagtgtgagatactgtgtatataaactatatataatgtatataaactgggatgtaagtttgtgtaaattaatgttttattctttgcaaataaaacgctttccccgtca

SEQ ID NO: 22 - DNA, 267 bp, Homo sapiens
gcctgaacctcagacctagtaatttttcatgcagttttcaaagttaggaacaagtttgtaacatgcagcagattagaaaaccttaatgactcagagagcaacaatacaagaggttaaaggaagctgattaattagatatgcatctggcattgttttatcttatcagtattatcactcttatgttggtttattcttaagctgtacaattgggagaaattttataattttttattggtaaacatatgctaaatccgcttcagtatttta

SEQ ID NO: 23 - DNA, 399 bp, Homo sapiens
ttctttccccaaatatcatgtagcacatcaatatgtagggaaacattcttatgcatcatttggtttgttttataaccaattcattaaatgtaattcataaaatgtactatgaaaaaaattatacgctatgggatactggcaacagtgcacatatttcataaccaaattagcagcaccggtcttaatttgatgtttttcaacttttattcattgagatgttttgaagcaattaggatatgtgtgtttactgtactttttgttttgatccgtttgtataaatgatagcaatatcttggacacatttgaaatacaaaatgtttttgtctaccaaagaaaaatgttgaaaaataagcaaatgtatacctagcaatcacttttactttttgtaattctgtctct

SEQ ID NO: 24 - DNA, 25 bp, Artificial Sequence
  Synthetic probe sequence contained in probe set
agctctcagacaaaggctgccttgc

SEQ ID NO: 25 - DNA, 25 bp, Artificial Sequence
  Synthetic probe sequence contained in probe set
gggagccgcccgagaaggagcggcg

SEQ ID NO: 26 - DNA, 25 bp, Artificial Sequence
  Synthetic probe sequence contained in probe set
aagagagttttgagaactaccgcag

SEQ ID NO: 27 - DNA, 25 bp, Artificial Sequence
  Synthetic probe sequence contained in probe set
gcagaaaggatggcggcagggggag

SEQ ID NO: 28 - DNA, 25 bp, Artificial Sequence
  Synthetic probe sequence contained in probe set
tcgctgacttggcctggaacgagga

SEQ ID NO: 29 - DNA, 25 bp, Artificial Sequence
  Synthetic probe sequence contained in probe set
gggcattggggccgtttgttaagcg

SEQ ID NO: 30 - DNA, 25 bp, Artificial Sequence
  Synthetic probe sequence contained in probe set
ggggccgtttgttaagcggcactca

SEQ ID NO: 31 - DNA, 25 bp, Artificial Sequence
  Synthetic probe sequence contained in probe set
taagcggcactcattttgcggaggc

SEQ ID NO: 32 - DNA, 25 bp, Artificial Sequence
  Synthetic probe sequence contained in probe set
acgccatctgtgtaacttcaggatc

SEQ ID NO: 33 - DNA, 25 bp, Artificial Sequence
  Synthetic probe sequence contained in probe set
cttcaggatctgttctgtttcacca

SEQ ID NO: 34 - DNA, 25 bp, Artificial Sequence
  Synthetic probe sequence contained in probe set
gttctgtttcaccatgtaacacaca

SEQ ID NO: 35 - DNA, 25 bp, Artificial Sequence
  Synthetic probe sequence contained in probe set
acccccagctatcagacggtctggt

SEQ ID NO: 36 - DNA, 25 bp, Artificial Sequence
  Synthetic probe sequence contained in probe set
aggccaaagcagcgtctttcagtgc

SEQ ID NO: 37 - DNA, 25 bp, Artificial Sequence
  Synthetic probe sequence contained in probe set
gctggtggaggacatgctgctcagt

SEQ ID NO: 38 - DNA, 25 bp, Artificial Sequence
  Synthetic probe sequence contained in probe set
tgctcagttcctccaggacatgaga

SEQ ID NO: 39 - DNA, 25 bp, Artificial Sequence
  Synthetic probe sequence contained in probe set
ggaacttcctgtgctcattagagtc

SEQ ID NO: 40 - DNA, 25 bp, Artificial Sequence
  Synthetic probe sequence contained in probe set
attagagtcaaatccctcagtccgt

SEQ ID NO: 41 - DNA, 25 bp, Artificial Sequence
  Synthetic probe sequence contained in probe set
atgacgcctgtgtgaaagctctggt

SEQ ID NO: 42 - DNA, 25 bp, Artificial Sequence
  Synthetic probe sequence contained in probe set
tggtctccctgaggagctaccatct

SEQ ID NO: 43 - DNA, 25 bp, Artificial Sequence
  Synthetic probe sequence contained in probe set
gagctaccatctgcaaatcgtgact

SEQ ID NO: 44 - DNA, 25 bp, Artificial Sequence
  Synthetic probe sequence contained in probe set
catcctgattcctgcaagccagcag

SEQ ID NO: 45 - DNA, 25 bp, Artificial Sequence
  Synthetic probe sequence contained in probe set
gaataagacctctgaagacccttca

SEQ ID NO: 46 - DNA, 25 bp, Artificial Sequence
  Synthetic probe sequence contained in probe set
gattatcaattaccacaccatctcc

SEQ ID NO: 47 - DNA, 25 bp, Artificial Sequence
  Synthetic probe sequence contained in probe set
gaagcatgattggtgcccagttagc

SEQ ID NO: 48 - DNA, 25 bp, Artificial Sequence
  Synthetic probe sequence contained in probe set
cccagttagcctctgcaggatgtgg

SEQ ID NO: 49 - DNA, 25 bp, Artificial Sequence
  Synthetic probe sequence contained in probe set
gtaggagaggttgtctgtggccaga

SEQ ID NO: 50 - DNA, 25 bp, Artificial Sequence
  Synthetic probe sequence contained in probe set
acctatactcactttcccaaattga

SEQ ID NO: 51 - DNA, 25 bp, Artificial Sequence
  Synthetic probe sequence contained in probe set
ttgaatcactgctcacactgctgat

SEQ ID NO: 52 - DNA, 25 bp, Artificial Sequence
  Synthetic probe sequence contained in probe set
tagagtgctgtccggtggagatccc

SEQ ID NO: 53 - DNA, 25 bp, Artificial Sequence
  Synthetic probe sequence contained in probe set
ccacccgaacgtcttatctaatcat

SEQ ID NO: 54 - DNA, 25 bp, Artificial Sequence
  Synthetic probe sequence contained in probe set
atcatgaaactccctagttccttca

SEQ ID NO: 55 - DNA, 25 bp, Artificial Sequence
  Synthetic probe sequence contained in probe set
gttccttcatgtaacttccctgaaa

SEQ ID NO: 56 - DNA, 25 bp, Artificial Sequence
  Synthetic probe sequence contained in probe set
tttgagagtctgtgacccacttacc

SEQ ID NO: 57 - DNA, 25 bp, Artificial Sequence
  Synthetic probe sequence contained in probe set
gcttctcactcatcactaacaaggt

SEQ ID NO: 58 - DNA, 25 bp, Artificial Sequence
  Synthetic probe sequence contained in probe set
gaacagtttgtctccattcttatgg

SEQ ID NO: 59 - DNA, 25 bp, Artificial Sequence
  Synthetic probe sequence contained in probe set
tccattcttatggccagcattccac

SEQ ID NO: 60 - DNA, 25 bp, Artificial Sequence
  Synthetic probe sequence contained in probe set
actccctgacaaagccagttgacct

SEQ ID NO: 61 - DNA, 25 bp, Artificial Sequence
  Synthetic probe sequence contained in probe set
tcccacacaagacccaagtagctgc

SEQ ID NO: 62 - DNA, 25 bp, Artificial Sequence
  Synthetic probe sequence contained in probe set
ccaagtagctgctaccttctttggc

SEQ ID NO: 63 - DNA, 25 bp, Artificial Sequence
  Synthetic probe sequence contained in probe set
tctaccagacccttctggtgccaga

SEQ ID NO: 64 - DNA, 25 bp, Artificial Sequence
  Synthetic probe sequence contained in probe set
tcattcctgttctttcttacacaag

SEQ ID NO: 65 - DNA, 25 bp, Artificial Sequence
  Synthetic probe sequence contained in probe set
gactcgggccttagaactttgcata

SEQ ID NO: 66 - DNA, 25 bp, Artificial Sequence
  Synthetic probe sequence contained in probe set
atagcagctgctactagctctttga

SEQ ID NO: 67 - DNA, 25 bp, Artificial Sequence
  Synthetic probe sequence contained in probe set
atacattccgaggggctcagttctg

SEQ ID NO: 68 - DNA, 25 bp, Artificial Sequence
  Synthetic probe sequence contained in probe set
gagacttttctatggttttgtgact

SEQ ID NO: 69 - DNA, 25 bp, Artificial Sequence
  Synthetic probe sequence contained in probe set
gtgactttcaacttttgtacagtta

SEQ ID NO: 70 - DNA, 25 bp, Artificial Sequence
  Synthetic probe sequence contained in probe set
gacaatcagaattccactgcccaaa

SEQ ID NO: 71 - DNA, 25 bp, Artificial Sequence
  Synthetic probe sequence contained in probe set
ggctggttaccatcggagtttacaa

SEQ ID NO: 72 - DNA, 25 bp, Artificial Sequence
  Synthetic probe sequence contained in probe set
tgctttcacgttcttacttgttgta

SEQ ID NO: 73 - DNA, 25 bp, Artificial Sequence
  Synthetic probe sequence contained in probe set
tacattcatgcatttctaggctaga

SEQ ID NO: 74 - DNA, 25 bp, Artificial Sequence
  Synthetic probe sequence contained in probe set
agagaaccttctagatttgatgctt

SEQ ID NO: 75 - DNA, 25 bp, Artificial Sequence
  Synthetic probe sequence contained in probe set
gtctctagaagttatctgtctgtat

SEQ ID NO: 76 - DNA, 25 bp, Artificial Sequence
  Synthetic probe sequence contained in probe set
ctgtctgtattgatctttatgctat

SEQ ID NO: 77 - DNA, 25 bp, Artificial Sequence
  Synthetic probe sequence contained in probe set
gctatattactatctgtggttacag

SEQ ID NO: 78 - DNA, 25 bp, Artificial Sequence
  Synthetic probe sequence contained in probe set
tactggagtcaagcccttataagtc

SEQ ID NO: 79 - DNA, 25 bp, Artificial Sequence
  Synthetic probe sequence contained in probe set
cgccggcaaaactttggcactgggg

SEQ ID NO: 80 - DNA, 25 bp, Artificial Sequence
  Synthetic probe sequence contained in probe set
caaaccaaccgcacatgcagatggg

SEQ ID NO: 81 - DNA, 25 bp, Artificial Sequence
  Synthetic probe sequence contained in probe set
gaagaaacgtctatgtgtacagatg

SEQ ID NO: 82 - DNA, 25 bp, Artificial Sequence
  Synthetic probe sequence contained in probe set
gcgggccggtttcgaagttgatgca

SEQ ID NO: 83 - DNA, 25 bp, Artificial Sequence
  Synthetic probe sequence contained in probe set
gatgcaatcggtttaaacatggctg

SEQ ID NO: 84 - DNA, 25 bp, Artificial Sequence
  Synthetic probe sequence contained in probe set
aacatggctgaacgcgtgtgtacac

SEQ ID NO: 85 - DNA, 25 bp, Artificial Sequence
  Synthetic probe sequence contained in probe set
gtgtgtacacgggactgacgcaacc

SEQ ID NO: 86 - DNA, 25 bp, Artificial Sequence
  Synthetic probe sequence contained in probe set
tgacgcaacccacgtgtaactgtca

SEQ ID NO: 87 - DNA, 25 bp, Artificial Sequence
  Synthetic probe sequence contained in probe set
gggccctgagtaatcgcttaaagat

SEQ ID NO: 88 - DNA, 25 bp, Artificial Sequence
  Synthetic probe sequence contained in probe set
aaagatgttcctacgggcttgttgc

SEQ ID NO: 89 - DNA, 25 bp, Artificial Sequence
  Synthetic probe sequence contained in probe set
gggcttgttgctgttgatgttttgt

SEQ ID NO: 90 - DNA, 25 bp, Artificial Sequence
  Synthetic probe sequence contained in probe set
tccatttctcatgttttccattgtt

SEQ ID NO: 91 - DNA, 25 bp, Artificial Sequence
  Synthetic probe sequence contained in probe set
caagaagcctttcctgtagccttct

SEQ ID NO: 92 - DNA, 25 bp, Artificial Sequence
  Synthetic probe sequence contained in probe set
gtccacggtctgttcttgaagcagt

SEQ ID NO: 93 - DNA, 25 bp, Artificial Sequence
  Synthetic probe sequence contained in probe set
tgaagcagtagcctaacacactcca

SEQ ID NO: 94 - DNA, 25 bp, Artificial Sequence
  Synthetic probe sequence contained in probe set
aagatatggacacacgggagccgct

SEQ ID NO: 95 - DNA, 25 bp, Artificial Sequence
  Synthetic probe sequence contained in probe set
gttttagccattgttggctttccct

SEQ ID NO: 96 - DNA, 25 bp, Artificial Sequence
  Synthetic probe sequence contained in probe set
tggctttcccttatcaaacttgggc

SEQ ID NO: 97 - DNA, 25 bp, Artificial Sequence
  Synthetic probe sequence contained in probe set
ctgagttatatgttcactgtccccc

SEQ ID NO: 98 - DNA, 25 bp, Artificial Sequence
  Synthetic probe sequence contained in probe set
gttcactgtccccctaatattaggg

SEQ ID NO: 99 - DNA, 25 bp, Artificial Sequence
  Synthetic probe sequence contained in probe set
gaacccccatgatgtaagtttacct

SEQ ID NO: 100 - DNA, 25 bp, Artificial Sequence
  Synthetic probe sequence contained in probe set
aaacctgcacttatacccatgaact

SEQ ID NO: 101 - DNA, 25 bp, Artificial Sequence
  Synthetic probe sequence contained in probe set
aacacttcgagcactgtccagtatt

SEQ ID NO: 102 - DNA, 25 bp, Artificial Sequence
  Synthetic probe sequence contained in probe set
tgtccagtattctaccgtggtacac

SEQ ID NO: 103 - DNA, 25 bp, Artificial Sequence
  Synthetic probe sequence contained in probe set
tacagacaccaagttccgtcagtcc

SEQ ID NO: 104 - DNA, 25 bp, Artificial Sequence
  Synthetic probe sequence contained in probe set
gtcttctcaagatccgagtctaccc

SEQ ID NO: 105 - DNA, 25 bp, Artificial Sequence
  Synthetic probe sequence contained in probe set
ctacccagcccttgttagattcaga

SEQ ID NO: 106 - DNA, 25 bp, Artificial Sequence
  Synthetic probe sequence contained in probe set
gcggtgatggtattttgcccaggca

SEQ ID NO: 107 - DNA, 25 bp, Artificial Sequence
  Synthetic probe sequence contained in probe set
gcagatgcttttggtccaggtactg

SEQ ID NO: 108 - DNA, 25 bp, Artificial Sequence
  Synthetic probe sequence contained in probe set
ggctgcgactgatgaaggcatgcct

SEQ ID NO: 109 - DNA, 25 bp, Artificial Sequence
  Synthetic probe sequence contained in probe set
accacagactgtacggcaaggcggc

SEQ ID NO: 110 - DNA, 25 bp, Artificial Sequence
  Synthetic probe sequence contained in probe set
ggcggctacatgcctcagtgaagga

SEQ ID NO: 111 - DNA, 25 bp, Artificial Sequence
  Synthetic probe sequence contained in probe set
tagtagttcctgctacaacttcagc

SEQ ID NO: 112 - DNA, 25 bp, Artificial Sequence
  Synthetic probe sequence contained in probe set
agcccctgcccatctgggaaaatac

SEQ ID NO: 113 - DNA, 25 bp, Artificial Sequence
  Synthetic probe sequence contained in probe set
gaaaataccccatcattcatgctac

SEQ ID NO: 114 - DNA, 25 bp, Artificial Sequence
  Synthetic probe sequence contained in probe set
ggctatgggagcagcttttttttcc

SEQ ID NO: 115 - DNA, 25 bp, Artificial Sequence
  Synthetic probe sequence contained in probe set
gtcatccaatctaaccacatcaata

SEQ ID NO: 116 - DNA, 25 bp, Artificial Sequence
  Synthetic probe sequence contained in probe set
cttgttcacactctcacatgtttag

SEQ ID NO: 117 - DNA, 25 bp, Artificial Sequence
  Synthetic probe sequence contained in probe set
ttataatctgatttgttttcctctt

SEQ ID NO: 118 - DNA, 25 bp, Artificial Sequence
  Synthetic probe sequence contained in probe set
gaccacaaatagtgctcgctttcta

SEQ ID NO: 119 - DNA, 25 bp, Artificial Sequence
  Synthetic probe sequence contained in probe set
gtgctcgctttctatgtagtttggt

SEQ ID NO: 120 - DNA, 25 bp, Artificial Sequence
  Synthetic probe sequence contained in probe set
gaagactctaccagactgtgtattc

SEQ ID NO: 121 - DNA, 25 bp, Artificial Sequence
  Synthetic probe sequence contained in probe set
tgttccttcaagatcatgtacccca

SEQ ID NO: 122 - DNA, 25 bp, Artificial Sequence
  Synthetic probe sequence contained in probe set
gtaccccaatttacttgccattact

SEQ ID NO: 123 - DNA, 25 bp, Artificial Sequence
  Synthetic probe sequence contained in probe set
gtcatgaggcagctttcatcacacc

SEQ ID NO: 124 - DNA, 25 bp, Artificial Sequence
  Synthetic probe sequence contained in probe set
tcatcacacccttttaacatttatc

SEQ ID NO: 125 - DNA, 25 bp, Artificial Sequence
  Synthetic probe sequence contained in probe set
aaaggtgtgcaaacttgtatctgaa

SEQ ID NO: 126 - DNA, 25 bp, Artificial Sequence
  Synthetic probe sequence contained in probe set
gtatctgaagacctaccagggacaa

SEQ ID NO: 127 - DNA, 25 bp, Artificial Sequence
  Synthetic probe sequence contained in probe set
ggaacacacatgtcctatccaaagg

SEQ ID NO: 128 - DNA, 25 bp, Artificial Sequence
  Synthetic probe sequence contained in probe set
ctatccaaaggaatcagctgcagct

SEQ ID NO: 129 - DNA, 25 bp, Artificial Sequence
  Synthetic probe sequence contained in probe set
taaagtcaggacctggcttggcttt

SEQ ID NO: 130 - DNA, 25 bp, Artificial Sequence
  Synthetic probe sequence contained in probe set
tctggattttcagcgaacatgcctg

SEQ ID NO: 131 - DNA, 25 bp, Artificial Sequence
  Synthetic probe sequence contained in probe set
ggacacctcaaatacatacctactg

SEQ ID NO: 132 - DNA, 25 bp, Artificial Sequence
  Synthetic probe sequence contained in probe set
actgactgatgacaaacccaggagt

SEQ ID NO: 133 - DNA, 25 bp, Artificial Sequence
  Synthetic probe sequence contained in probe set
aaaaagtttgccctggatgtcatat

SEQ ID NO: 134 - DNA, 25 bp, Artificial Sequence
  Synthetic probe sequence contained in probe set
gactcagcctctgggatggattact

SEQ ID NO: 135 - DNA, 25 bp, Artificial Sequence
  Synthetic probe sequence contained in probe set
ggtgagaatggctacttccggatcc

SEQ ID NO: 136 - DNA, 25 bp, Artificial Sequence
  Synthetic probe sequence contained in probe set
acttccggatccgcagaggaactga

SEQ ID NO: 137 - DNA, 25 bp, Artificial Sequence
  Synthetic probe sequence contained in probe set
gagagcatagcagtggcagccacac

SEQ ID NO: 138 - DNA, 25 bp, Artificial Sequence
  Synthetic probe sequence contained in probe set
gcagccacaccaattcctaaattgt

SEQ ID NO: 139 - DNA, 25 bp, Artificial Sequence
  Synthetic probe sequence contained in probe set
gtagggtatgccttccagtatttca

SEQ ID NO: 140 - DNA, 25 bp, Artificial Sequence
  Synthetic probe sequence contained in probe set
gccttccagtatttcataatgatct

SEQ ID NO: 141 - DNA, 25 bp, Artificial Sequence
  Synthetic probe sequence contained in probe set
gatctgcatcagttgtaaaggggaa

SEQ ID NO: 142 - DNA, 25 bp, Artificial Sequence
  Synthetic probe sequence contained in probe set
aattggtatattcacagactgtaga

SEQ ID NO: 143 - DNA, 25 bp, Artificial Sequence
  Synthetic probe sequence contained in probe set
gactgtagactttcagcagcaatct

SEQ ID NO: 144 - DNA, 25 bp, Artificial Sequence
  Synthetic probe sequence contained in probe set
acctttcaatcggccactggccatt

SEQ ID NO: 145 - DNA, 25 bp, Artificial Sequence
  Synthetic probe sequence contained in probe set
taactctaccctggcactataatgt

SEQ ID NO: 146 - DNA, 25 bp, Artificial Sequence
  Synthetic probe sequence contained in probe set
gctctactgaggtgctatgttctta

SEQ ID NO: 147 - DNA, 25 bp, Artificial Sequence
  Synthetic probe sequence contained in probe set
tcttagtggatgttctgaccctgct

SEQ ID NO: 148 - DNA, 25 bp, Artificial Sequence
  Synthetic probe sequence contained in probe set
tctgaccctgcttcaaatatttccc

SEQ ID NO: 149 - DNA, 25 bp, Artificial Sequence
  Synthetic probe sequence contained in probe set
ggtactaaggaatctttctgctttg

SEQ ID NO: 150 - DNA, 25 bp, Artificial Sequence
  Synthetic probe sequence contained in probe set
gctttggggtttatcagaattctca

SEQ ID NO: 151 - DNA, 25 bp, Artificial Sequence
  Synthetic probe sequence contained in probe set
aatgctctttacttcatggacttcc

SEQ ID NO: 152 - DNA, 25 bp, Artificial Sequence
  Synthetic probe sequence contained in probe set
ttacttcatggacttccactgccat

SEQ ID NO: 153 - DNA, 25 bp, Artificial Sequence
  Synthetic probe sequence contained in probe set
attctttcagtggctacctacatac

SEQ ID NO: 154 - DNA, 25 bp, Artificial Sequence
  Synthetic probe sequence contained in probe set
gctacctacatacaattccaaacac

SEQ ID NO: 155 - DNA, 25 bp, Artificial Sequence
  Synthetic probe sequence contained in probe set
aatgaggtactctcctggaaatatt

SEQ ID NO: 156 - DNA, 25 bp, Artificial Sequence
  Synthetic probe sequence contained in probe set
gcttctggaggcaccttcagaaatt

SEQ ID NO: 157 - DNA, 25 bp, Artificial Sequence
  Synthetic probe sequence contained in probe set
atagtctcaactgcgtgcgacaggc

SEQ ID NO: 158 - DNA, 25 bp, Artificial Sequence
  Synthetic probe sequence contained in probe set
gacaggcccctggacaagggcttga

SEQ ID NO: 159 - DNA, 25 bp, Artificial Sequence
  Synthetic probe sequence contained in probe set
gagtggatgggagggatcgtcccta

SEQ ID NO: 160 - DNA, 25 bp, Artificial Sequence
  Synthetic probe sequence contained in probe set
atcgtccctatctttggtacatcaa

SEQ ID NO: 161 - DNA, 25 bp, Artificial Sequence
  Synthetic probe sequence contained in probe set
ttggtacatcaaactacacacaaaa

SEQ ID NO: 162 - DNA, 25 bp, Artificial Sequence
  Synthetic probe sequence contained in probe set
tacacacaaaagttccaggggagag

SEQ ID NO: 163 - DNA, 25 bp, Artificial Sequence
  Synthetic probe sequence contained in probe set
ggagagtcacgattaccgcggactt

SEQ ID NO: 164 - DNA, 25 bp, Artificial Sequence
  Synthetic probe sequence contained in probe set
caccagcacagcctacatggagctg

SEQ ID NO: 165 - DNA, 25 bp, Artificial Sequence
  Synthetic probe sequence contained in probe set
ggagctgaacagcctgagatctgag

SEQ ID NO: 166 - DNA, 25 bp, Artificial Sequence
  Synthetic probe sequence contained in probe set
tgagatctgaggacacggccatgca

SEQ ID NO: 167 - DNA, 25 bp, Artificial Sequence
  Synthetic probe sequence contained in probe set
aagcaccctgtatcacagactggca

SEQ ID NO: 168 - DNA, 25 bp, Artificial Sequence
  Synthetic probe sequence contained in probe set
aacagttactccagtatatgctgat

SEQ ID NO: 169 - DNA, 25 bp, Artificial Sequence
  Synthetic probe sequence contained in probe set
gatggaccaggaagccctgaatcca

SEQ ID NO: 170 - DNA, 25 bp, Artificial Sequence
  Synthetic probe sequence contained in probe set
ggcataccttaaacaagctccacct

SEQ ID NO: 171 - DNA, 25 bp, Artificial Sequence
  Synthetic probe sequence contained in probe set
taaacaagctccaccttccaaagga

SEQ ID NO: 172 - DNA, 25 bp, Artificial Sequence
  Synthetic probe sequence contained in probe set
ttccaaaggacctactgttcggaca

SEQ ID NO: 173 - DNA, 25 bp, Artificial Sequence
  Synthetic probe sequence contained in probe set
acgaagctgtcttagagtgggacca

SEQ ID NO: 174 - DNA, 25 bp, Artificial Sequence
  Synthetic probe sequence contained in probe set
gtgggaccaacttcctgttgatgtt

SEQ ID NO: 175 - DNA, 25 bp, Artificial Sequence
  Synthetic probe sequence contained in probe set
gtgaatgtggattcttcccacacag

SEQ ID NO: 176 - DNA, 25 bp, Artificial Sequence
  Synthetic probe sequence contained in probe set
tacattgtcctctttgactagtgac

SEQ ID NO: 177 - DNA, 25 bp, Artificial Sequence
  Synthetic probe sequence contained in probe set
ggtacgaatggcagcatacacagat

SEQ ID NO: 178 - DNA, 25 bp, Artificial Sequence
  Synthetic probe sequence contained in probe set
aggactcaagacatctcagtgttct

SEQ ID NO: 179 - DNA, 25 bp, Artificial Sequence
  Synthetic probe sequence contained in probe set
cccacacgaccacagatacggcaaa

SEQ ID NO: 180 - DNA, 25 bp, Artificial Sequence
  Synthetic probe sequence contained in probe set
acccatagtggttgcttcaggaatc

SEQ ID NO: 181 - DNA, 25 bp, Artificial Sequence
  Synthetic probe sequence contained in probe set
ttttcactggtggtggcccattaca

SEQ ID NO: 182 - DNA, 25 bp, Artificial Sequence
  Synthetic probe sequence contained in probe set
ggcccattacaggcaaccagttctc

SEQ ID NO: 183 - DNA, 25 bp, Artificial Sequence
  Synthetic probe sequence contained in probe set
gttctcctcagggcatggtgcaagc

SEQ ID NO: 184 - DNA, 25 bp, Artificial Sequence
  Synthetic probe sequence contained in probe set
ggtgcaagctgttgttctgccaaca

SEQ ID NO: 185 - DNA, 25 bp, Artificial Sequence
  Synthetic probe sequence contained in probe set
aacagttggtttggtgtctcccata

SEQ ID NO: 186 - DNA, 25 bp, Artificial Sequence
  Synthetic probe sequence contained in probe set
gaaacaatcaatgcttcacccatac

SEQ ID NO: 187 - DNA, 25 bp, Artificial Sequence
  Synthetic probe sequence contained in probe set
caaggtggccattctgttatttcag

SEQ ID NO: 188 - DNA, 25 bp, Artificial Sequence
  Synthetic probe sequence contained in probe set
aactacagtcttgagcagcctagcc

SEQ ID NO: 189 - DNA, 25 bp, Artificial Sequence
  Synthetic probe sequence contained in probe set
atgagatgtatcttttgctctctct

SEQ ID NO: 190 - DNA, 25 bp, Artificial Sequence
  Synthetic probe sequence contained in probe set
ccctgatcggtgacagtcactagct

SEQ ID NO: 191 - DNA, 25 bp, Artificial Sequence
  Synthetic probe sequence contained in probe set
tgacagtcactagcttatcttgaac

SEQ ID NO: 192 - DNA, 25 bp, Artificial Sequence
  Synthetic probe sequence contained in probe set
acagatatttaattttgctaacact

SEQ ID NO: 193 - DNA, 25 bp, Artificial Sequence
  Synthetic probe sequence contained in probe set
gaattctacatactaaatctctctc

SEQ ID NO: 194 - DNA, 25 bp, Artificial Sequence
  Synthetic probe sequence contained in probe set
tctacatactaaatctctctccttt

SEQ ID NO: 195 - DNA, 25 bp, Artificial Sequence
  Synthetic probe sequence contained in probe set
ggtgctactgtttatccgtaataat

SEQ ID NO: 196 - DNA, 25 bp, Artificial Sequence
  Synthetic probe sequence contained in probe set
cgtctttgtctctagtgcagttttt

SEQ ID NO: 197 - DNA, 25 bp, Artificial Sequence
  Synthetic probe sequence contained in probe set
agtgcagtttttcgagatattccgt

SEQ ID NO: 198 - DNA, 25 bp, Artificial Sequence
  Synthetic probe sequence contained in probe set
gtttttcgagatattccgtagtaca

SEQ ID NO: 199 - DNA, 25 bp, Artificial Sequence
  Synthetic probe sequence contained in probe set
agatattccgtagtacatatttatt

SEQ ID NO: 200 - DNA, 25 bp, Artificial Sequence
  Synthetic probe sequence contained in probe set
aaagacactcggcagcaacatcagc

SEQ ID NO: 201 - DNA, 25 bp, Artificial Sequence
  Synthetic probe sequence contained in probe set
aaaggccctcatcaatagtcggaaa

SEQ ID NO: 202 - DNA, 25 bp, Artificial Sequence
  Synthetic probe sequence contained in probe set
atgtgggtcttatgcttccattaac

SEQ ID NO: 203 - DNA, 25 bp, Artificial Sequence
  Synthetic probe sequence contained in probe set
attaacaaatgctctgtcttcaatg

SEQ ID NO: 204 - DNA, 25 bp, Artificial Sequence
  Synthetic probe sequence contained in probe set
atgagcatgcattttcttgtatgat

SEQ ID NO: 205 - DNA, 25 bp, Artificial Sequence
  Synthetic probe sequence contained in probe set
attcaccttttcttcaaaatcgata

SEQ ID NO: 206 - DNA, 25 bp, Artificial Sequence
  Synthetic probe sequence contained in probe set
aaatcgatatggtggctgcaaaact

SEQ ID NO: 207 - DNA, 25 bp, Artificial Sequence
  Synthetic probe sequence contained in probe set
aaactagaattgttgcatccctcaa

SEQ ID NO: 208 - DNA, 25 bp, Artificial Sequence
  Synthetic probe sequence contained in probe set
gagggccatatccctgtggtattcc

SEQ ID NO: 209 - DNA, 25 bp, Artificial Sequence
  Synthetic probe sequence contained in probe set
tcctgctttggggctttagaattct

SEQ ID NO: 210 - DNA, 25 bp, Artificial Sequence
  Synthetic probe sequence contained in probe set
gttccaaatccacagcttttacgta

SEQ ID NO: 211 - DNA, 25 bp, Artificial Sequence
  Synthetic probe sequence contained in probe set
agcccagtttcactgccatatactc

SEQ ID NO: 212 - DNA, 25 bp, Artificial Sequence
  Synthetic probe sequence contained in probe set
aggactttctgaagcctcacttatg

SEQ ID NO: 213 - DNA, 25 bp, Artificial Sequence
  Synthetic probe sequence contained in probe set
gaagcctcacttatgagatgcctga

SEQ ID NO: 214 - DNA, 25 bp, Artificial Sequence
  Synthetic probe sequence contained in probe set
atgcctgaagccaggccatggctat

SEQ ID NO: 215 - DNA, 25 bp, Artificial Sequence
  Synthetic probe sequence contained in probe set
agagctgtcctggtatctagaccca

SEQ ID NO: 216 - DNA, 25 bp, Artificial Sequence
  Synthetic probe sequence contained in probe set
tatctagacccatcttctttttgaa

SEQ ID NO: 217 - DNA, 25 bp, Artificial Sequence
  Synthetic probe sequence contained in probe set
atgttactatctgcttttggttata

SEQ ID NO: 218 - DNA, 25 bp, Artificial Sequence
  Synthetic probe sequence contained in probe set
ttttctggggttatgatggccttac

SEQ ID NO: 219 - DNA, 25 bp, Artificial Sequence
  Synthetic probe sequence contained in probe set
gagtttctctcacattactgtatat

SEQ ID NO: 220 - DNA, 25 bp, Artificial Sequence
  Synthetic probe sequence contained in probe set
aattcaggctttggatgtttcttta

SEQ ID NO: 221 - DNA, 25 bp, Artificial Sequence
  Synthetic probe sequence contained in probe set
gatgtttctttagcagttttgtgat

SEQ ID NO: 222 - DNA, 25 bp, Artificial Sequence
  Synthetic probe sequence contained in probe set
aagccatagtcgtgcctgtttgctt

SEQ ID NO: 223 - DNA, 25 bp, Artificial Sequence
  Synthetic probe sequence contained in probe set
atagtcgtgcctgtttgcttagcat

SEQ ID NO: 224 - DNA, 25 bp, Artificial Sequence
  Synthetic probe sequence contained in probe set
gtttgcttagcattcctattgacaa

SEQ ID NO: 225 - DNA, 25 bp, Artificial Sequence
  Synthetic probe sequence contained in probe set
cattcctattgacaactcttctggg

SEQ ID NO: 226 - DNA, 25 bp, Artificial Sequence
  Synthetic probe sequence contained in probe set
gttctgctttaataagcgagaccta

SEQ ID NO: 227 - DNA, 25 bp, Artificial Sequence
  Synthetic probe sequence contained in probe set
aaaacacatctggcctaatgttcca

SEQ ID NO: 228 - DNA, 25 bp, Artificial Sequence
  Synthetic probe sequence contained in probe set
gcctaatgttccagatccttcaaag

SEQ ID NO: 229 - DNA, 25 bp, Artificial Sequence
  Synthetic probe sequence contained in probe set
agagtcatattgcccagtggtcacc

SEQ ID NO: 230 - DNA, 25 bp, Artificial Sequence
  Synthetic probe sequence contained in probe set
ttcagatggcaatttcactgatgta

SEQ ID NO: 231 - DNA, 25 bp, Artificial Sequence
  Synthetic probe sequence contained in probe set
acaaaaagccttttccagaagatct

SEQ ID NO: 232 - DNA, 25 bp, Artificial Sequence
  Synthetic probe sequence contained in probe set
gaagatctgaaatcattggacctgt

SEQ ID NO: 233 - DNA, 25 bp, Artificial Sequence
  Synthetic probe sequence contained in probe set
ggcatctcctgagcctaggcaatac

SEQ ID NO: 234 - DNA, 25 bp, Artificial Sequence
  Synthetic probe sequence contained in probe set
gtagggtgacttctggagccatccc

SEQ ID NO: 235 - DNA, 25 bp, Artificial Sequence
  Synthetic probe sequence contained in probe set
agagctggggaaatgggcccgcgag

SEQ ID NO: 236 - DNA, 25 bp, Artificial Sequence
  Synthetic probe sequence contained in probe set
tcatgggtgcctcagagcaggacct

SEQ ID NO: 237 - DNA, 25 bp, Artificial Sequence
  Synthetic probe sequence contained in probe set
agcaggaccttggtctttccttgtt

SEQ ID NO: 238 - DNA, 25 bp, Artificial Sequence
  Synthetic probe sequence contained in probe set
gctttgggctacgtggatgaccagc

SEQ ID NO: 239 - DNA, 25 bp, Artificial Sequence
  Synthetic probe sequence contained in probe set
atgaccagctgttcgtgttctatga

SEQ ID NO: 240 - DNA, 25 bp, Artificial Sequence
  Synthetic probe sequence contained in probe set
cccgaactccatgggtttccagtag

SEQ ID NO: 241 - DNA, 25 bp, Artificial Sequence
  Synthetic probe sequence contained in probe set
gcagctgagtcagagtctgcccagc

SEQ ID NO: 242 - DNA, 25 bp, Artificial Sequence
  Synthetic probe sequence contained in probe set
tctgcccagccgtcaaaagagtctt

SEQ ID NO: 243 - DNA, 25 bp, Artificial Sequence
  Synthetic probe sequence contained in probe set
agggcaggtgcttcaggataccata

SEQ ID NO: 244 - DNA, 25 bp, Artificial Sequence
  Synthetic probe sequence contained in probe set
tccaggctggaagtacttggccccc

SEQ ID NO: 245 - DNA, 25 bp, Artificial Sequence
  Synthetic probe sequence contained in probe set
gagagagtagctgcagccttcatca

SEQ ID NO: 246 - DNA, 25 bp, Artificial Sequence
  Synthetic probe sequence contained in probe set
gccagcaagtccttaggctactgta

SEQ ID NO: 247 - DNA, 25 bp, Artificial Sequence
  Synthetic probe sequence contained in probe set
gctactgtaatgctgcctcaggacc

SEQ ID NO: 248 - DNA, 25 bp, Artificial Sequence
  Synthetic probe sequence contained in probe set
tcctctaggccctgtgagcacaaag

SEQ ID NO: 249 - DNA, 25 bp, Artificial Sequence
  Synthetic probe sequence contained in probe set
taatccatttcaggactctctccag

SEQ ID NO: 250 - DNA, 25 bp, Artificial Sequence
  Synthetic probe sequence contained in probe set
gctcggggtgtgtcatttctatatt

SEQ ID NO: 251 - DNA, 25 bp, Artificial Sequence
  Synthetic probe sequence contained in probe set
atattcctccagctgggattggggg

SEQ ID NO: 252 - DNA, 25 bp, Artificial Sequence
  Synthetic probe sequence contained in probe set
gcaggcccaatgctgcttttggggg

SEQ ID NO: 253 - DNA, 25 bp, Artificial Sequence
  Synthetic probe sequence contained in probe set
gggggtcagcatccagtgtgagata

SEQ ID NO: 254 - DNA, 25 bp, Artificial Sequence
  Synthetic probe sequence contained in probe set
tgcaaataaaacgctttccccgtca

SEQ ID NO: 255 - DNA, 25 bp, Artificial Sequence
  Synthetic probe sequence contained in probe set
gcctgaacctcagacctagtaattt

SEQ ID NO: 256 - DNA, 25 bp, Artificial Sequence
  Synthetic probe sequence contained in probe set
cagacctagtaatttttcatgcagt

SEQ ID NO: 257 - DNA, 25 bp, Artificial Sequence
  Synthetic probe sequence contained in probe set
caagtttgtaacatgcagcagatta

SEQ ID NO: 258 - DNA, 25 bp, Artificial Sequence
  Synthetic probe sequence contained in probe set
gaaaaccttaatgactcagagagca

SEQ ID NO: 259 - DNA, 25 bp, Artificial Sequence
  Synthetic probe sequence contained in probe set
ggaagctgattaattagatatgcat

SEQ ID NO: 260 - DNA, 25 bp, Artificial Sequence
  Synthetic probe sequence contained in probe set
gcatctggcattgttttatcttatc

SEQ ID NO: 261 - DNA, 25 bp, Artificial Sequence
  Synthetic probe sequence contained in probe set
atcttatcagtattatcactcttat

SEQ ID NO: 262 - DNA, 25 bp, Artificial Sequence
  Synthetic probe sequence contained in probe set
atcactcttatgttggtttattctt

SEQ ID NO: 263 - DNA, 25 bp, Artificial Sequence
  Synthetic probe sequence contained in probe set
gttggtttattcttaagctgtacaa

SEQ ID NO: 264 - DNA, 25 bp, Artificial Sequence
  Synthetic probe sequence contained in probe set
aaacatatgctaaatccgcttcagt

SEQ ID NO: 265 - DNA, 25 bp, Artificial Sequence
  Synthetic probe sequence contained in probe set
atgctaaatccgcttcagtatttta

SEQ ID NO: 266 - DNA, 25 bp, Artificial Sequence
  Synthetic probe sequence contained in probe set
ttctttccccaaatatcatgtagca

SEQ ID NO: 267 - DNA, 25 bp, Artificial Sequence
  Synthetic probe sequence contained in probe set
gaaacattcttatgcatcatttggt

SEQ ID NO: 268 - DNA, 25 bp, Artificial Sequence
  Synthetic probe sequence contained in probe set
tacgctatgggatactggcaacagt

SEQ ID NO: 269 - DNA, 25 bp, Artificial Sequence
  Synthetic probe sequence contained in probe set
gcaacagtgcacatatttcataacc

SEQ ID NO: 270 - DNA, 25 bp, Artificial Sequence
  Synthetic probe sequence contained in probe set
ttcataaccaaattagcagcaccgg

SEQ ID NO: 271 - DNA, 25 bp, Artificial Sequence
  Synthetic probe sequence contained in probe set
gcagcaccggtcttaatttgatgtt

SEQ ID NO: 272 - DNA, 25 bp, Artificial Sequence
  Synthetic probe sequence contained in probe set
ggatatgtgtgtttactgtactttt

SEQ ID NO: 273 - DNA, 25 bp, Artificial Sequence
  Synthetic probe sequence contained in probe set
tttgttttgatccgtttgtataaat

SEQ ID NO: 274 - DNA, 25 bp, Artificial Sequence
  Synthetic probe sequence contained in probe set
gatagcaatatcttggacacatttg

SEQ ID NO: 275 - DNA, 25 bp, Artificial Sequence
  Synthetic probe sequence contained in probe set
atacctagcaatcacttttactttt

SEQ ID NO: 276 - DNA, 25 bp, Artificial Sequence
  Synthetic probe sequence contained in probe set
ttttactttttgtaattctgtctct